(19) United States
(12) Patent Application Publication
(10) Pub. No.: US 2005/0256863 A1
(43) Pub. Date: Nov. 17, 2005

(54) Context management system

(76) Inventors: Arthur Ray Crivella, Pittsburgh, PA (US); Wayne Jacob West, Henderson, NV (US)

Correspondence Address: COHEN & GRIGSBY, P.C., 11 STANWIX STREET, 15TH FLOOR, PITTSBURGH, PA, 15222, US

(21) Appl. No.: 11/108,486

(22) Filed: Apr. 18, 2005

Related U.S. Application Data
(63) Continuation-in-part of application No. 10/631,077, filed on Jul. 31, 2003.
Application No. 10/631,077 is a continuation-in-part of application No. 10/210,460, filed on Jul. 31, 2002.
Application No. 10/210,460 is a continuation-in-part of application No. 09/919,468, filed on Jul. 31, 2001, now Pat. No. 6,883,008.

(30) Foreign Application Priority Data
Jul. 31, 2003 (WO) PCT/US03/23945
Jul. 31, 2002 (WO) PCT/US02/24184

(51) Int. Cl. G06F 7/00

(52) U.S. Cl. 707/4

(57) ABSTRACT

This invention relates to a system for utilizing audible, visual, textual, and multimedia data in a knowledge management context. An Internet-enabled and customizable apparatus and method for implementing this knowledge management system is disclosed. Information is managed by way of classifying information by a slice, layer, and/or crumb level. Further, metadata may be utilized to build further context with respect to this information. Contextual relationships may be built between and among one or a plurality of customer information. In this vein, the contextual web of information (relationships of information pieces) and “knowledge polygon” (contextual dimensions to information) are built.

### CROSS REFERENCE

This application is a continuation-in-part of U.S. application of nonprovisional application U.S. application Ser. No. 10/631,077, filed on Jul. 31, 2003 which is a continuation-in-part of U.S. application Ser. No. 10/210,460, filed on Jul. 31, 2002, which is a continuation-in-part of U.S. application Ser. No. 09/919,468, filed Jul. 31, 2001.

### COPYRIGHT NOTICE

This disclosure is protected under United States and Internal Copyright Laws. © 2005 ASE EDGE, Inc. All Rights Reserved. The copyright may be assigned by ASE EDGE, INC. to another individual or other entity without advance notice. While the copyright owner has no objection to the facsimile reproduction of the patent document as it appears in the Patent and Trademark Office patent files and records for informational purposes, the copyright owner reserves all other rights and remedies under the United States copyright laws which pertain to this disclosure.

### FIELD OF THE INVENTION

This invention generally relates to an information management system. Specifically, this invention relates to an apparatus and method for providing an implementation framework and resulting medium for context management of information.

### BACKGROUND OF THE INVENTION

The concept of the present invention provides a new solution for solving the problem of “knowledge churn.” In essence, it is markedly inefficient for individuals to convey and exchange information among themselves in a serial fashion. Information must be learned, releamed, organized, reorganized, accessed, modified, and updated. As an example, an individual can become an expert in a certain area. However, when that individual changes focus to yet another area, that prior knowledge can be forgotten and thus needs to be relearned, reaccessed, organized, reorganized, and possibly modified and updated, as needed. Further, when another individual has to share or otherwise access this information, this other individual has a learning curve and must “churn” through information to acquire knowledge. Moreover, when an individual with certain information is no longer available, another individual must undertake the learning curve and must “churn” through the information pile to acquire knowledge which the prior individual possessed.

Within the context of any human undertaking which requires information management, there is a great need in the art for achieving knowledge management. For businesses and other organizations, this can greatly enhance organizational efficiency by lessening the learning curve through accessible, organized information. This need is particularly great with respect to industries and other contexts in which there is a large need to use information repeatedly, process large quantities of information, and organize the information so that the net result is human knowledge (as opposed to a collection of disconnected data points).

Computer-implemented and enabled devices (as used hereinafter, these are collectively referred to as “devices”) which have the potential of flawlessly processing information and information-related tasks, to a much greater degree than humans, can help provide a novel and efficient way of achieving knowledge management. Instructions for processing information via these devices can provide a knowledge management framework of such power and versatility, only limited to the degree of effectiveness of such a method.

However, in order for devices to process the information, it must be present in a form which is capable of being processed. With respect to computer-enabled and implemented devices, this information must be in electronic form. Electronic information can take the forms of text, audible, and multimedia formats. As such, this information is present in intangible form.

But, much information is in written form, such as handwriting, notes, drawings, and the like. This information is tangible information in that it is embodied in a tangible medium of expression (e.g., paper, canvas, cardstock, and the like). At the present time, though, it is feasible and facile to convert tangible information into intangible form. Scanning technology is present such that tangible information may be converted into intangible, electronic form. As such, the information may be processed and otherwise managed by computer-implemented and enabled devices.

Moreover, the Internet provides yet a further dimension to the ability of computer-implemented and enabled devices to provide knowledge management. For example, with a network of devices, there may be one or a plurality of access points to a central repository of information. And, there may be one or a plurality of access points to a plurality of repositories of information. Further, to the extent that the information stored in one or a plurality of locations needs to be modified, the access point(s) may be used as instrumentalities for modifying the information. Thus, there is a great need in the art for a method and apparatus for knowledge management which utilizes the Internet.

Relatedly, when there are a plurality of access points that retrieve at least one singular data item (as used hereinafter, this is referred to as a “Knowledge Element”) by way of the Internet, this network-based infrastructure takes advantage of the fact that a Knowledge Element, as an item of intangible information, may be replicated with great ease in a nanosecond time frame. Contrast this with the time and effort involved in replicating an item of tangible information by way of photocopying or other methods of replicating, which occurs on a much wider time scale, such as minutes or hours. Accordingly, there is a great need in the art for a method and apparatus for knowledge management which utilizes the Internet and/or other networks in such a way as to take advantage of the ease of intangible replication of intangible information.

And, as yet another related dimension, when working within the context of the Internet, one can have a web of information. As such, information need not be replicated per se, but rather it can be “shared.” When information is shared, these individual Knowledge Elements form a web of information and contextual relationships are drawn between and among the plurality of Knowledge Elements. In effect, a new form of information network is formed—i.e., a contextual web. Accordingly, there is a need in the art to achieve knowledge management by way of a contextual web of information through contextual relationships.

Humans can utilize the contextual web by designating, by way of a computer-implemented or enabled device, which Knowledge Elements are interrelated and in what respect. Thus, there is a related need in the art to achieve knowledge management by way of a contextual web of information by creating contextual relationships which are defined by human users of computer-implemented or enabled devices using a method and apparatus for achieving knowledge management.

### SUMMARY OF THE INVENTION

This invention relates to an apparatus and method for information processing that procures knowledge management by way of a plurality of interconnected computer-implemented or enabled devices. Specifically, this invention relates to an apparatus and method for providing an implementation framework and resulting medium for context management of information. Further, this invention provides a new navigational and operational framework for the Knowledge Kiosk® system by way of disclosing newly developed context management technology. The present invention provides advantages to the limitations in the prior art, as referenced in the foregoing section. Disclosed is a method and apparatus (hereinafter referred to as a “system”) for utilizing data to provide knowledge management. In a preferred embodiment, this knowledge management system operates over the Internet. Examples of data formats include, but are not limited to, audible, visual, textual, and other multimedia formats. The forefront of information, linguistic and library technology and science is used so as to provide an optimum information processing schema. Linguistic science concepts are used for defining information acquisition, exchange and workflow so as to enable the categorization of information utilizing library science concepts. Library science concepts are used for categorizing information used in the knowledge management process, using the application of linguistic science principles to determine items such as, but not limited to, how individuals look for information within their designated field and/or industry. In one preferred embodiment, one or a plurality of information is classified by layer, slice, or crumb. Database technology is used for storing one or a plurality of Knowledge Elements according to a database schema which implements the categorization of the data. At minimum, a database has at least one Knowledge Element associated with a uniquely global identifier (GUID), including at least one relationship within said database for identifying at least one Knowledge Element with a globally unique identifier (GUID). The published specification at <http://cvs.gnucash.org/docs/HEAD/group_GUID.html> (last accessed Apr. 14, 2005) for the GUID is incorporated by reference herein. Further, the Knowledge Kiosk® system is embodied in a software implementation which operates on a computer network to permit interactive, multidirectional, multimedia digital data communications originated by a user from at least one first location and made available to at least one second location.

Moreover, one central feature of the present improvement of the Knowledge Kiosk® system is the context management feature. Information is largely organized based on syntax and structure rather than context and semantics. There is therefore inherent limitation in locating needed information, in particular with respect to the correct syntactical assignment of information and defining an accurate structure (e.g., classification) of information. In other words, when one searches through volumes of information, the results may, at times, be unresponsive or otherwise incomplete in view of one's query. This is due to the search results being index driven rather than context driven. One solution to this problem is providing context-based results instead of index-based results. To this end, the resulting information yields more usable and relevant information.

In this vein, it is an object of the present invention to overcome the disadvantages in the prior art as it relates to knowledge management. It is another object of the present invention to provide a method and apparatus for achieving knowledge management.

It is another object of the present invention to provide for a method and apparatus for knowledge management which utilizes the Internet.

It is another object of the present invention to provide for a method and apparatus for knowledge management which utilizes the Internet and/or other networks in such a way as to take advantage of the ease of intangible replication of intangible information.

It is another object of the present invention to provide a method and apparatus for knowledge management by way of a contextual web of information through contextual relationships.

It is another object of the present invention to provide for knowledge management by way of a contextual web of information by creating contextual relationships which are defined by human users of computer-implemented or enabled devices using a method and apparatus for achieving knowledge management.

In one embodiment of the present invention, knowledge can be managed interactively and in real-time by way of creating context relationships among individual Knowledge Elements (i.e., pieces of information) which are stored in the Kiosk system. Examples of Knowledge Element formats include, but are not limited to, textual, audible, visual, or multimedia formats. Correlated data can be “linked” in the contextual sense by the user using the presently disclosed apparatus and method. Different types of information can be linked with one another (e.g., text and audible). Regardless of the form of the information, the individual Knowledge Elements are assigned a Globally Unique Identifier (as used herein, this is referred to as a “GUID” or a unique global identifier) such that each may be accessed and/or modified as required by the system or as requested by the user.

Examples of a context management system (a Policy Review station, a Linguistic Analysis Station, and a Litigation Management System) which operates within the Knowledge Kiosk framework are disclosed. A method and apparatus are provided for creating a customized context management system which operates within the Kiosk framework. The method disclosed provides a user with the ability to create his or her own Knowledge Kiosk system utilizing the presently disclosed context management technology. The apparatus disclosed comprises of at least one general workstation, at least one stepping stone station, and at least one repository station. The general workstation provides the user with tools to access and otherwise manipulate stored data. The stepping stone interconnects the general workstation and repository station. The repository station is a virtual library of one or a plurality of Knowledge Elements. Further, the user defines the Knowledge Elements which are stored and also defines the tools which are utilized with the general workstation such that the information is processed pursuant to his or her needs.

The present invention, both as to its construction and its method of operation, together with the additional objects and advantages thereof, will best be understood from the following description of exemplary embodiments.

These and other advantages of the invention will become apparent from a perusal of the following detailed description of the presently preferred embodiments of the invention taken in connection with the accompanying drawings and exemplary embodiments thereof.

### BRIEF DESCRIPTION OF THE DETAILED DRAWINGS

FIG. (1) shows a “Knowledge Pyramid” used to represent the four basic aspects of the system of the present invention as they are combined together to permit receiving, accessing, processing, storing, transmitting and utilizing audible, visual and textual data for real-time interactive use by multiple users in different remote environments utilizing alternative combinable multimedia forms of presenting the information to simplify and maximize human understanding.

FIG. (2) shows the home page of a preferred embodiment of the system of the present invention as implemented on the Internet Web Site at “www.knowledgekiosk.com”.

FIG. (3) shows the “Passport” page of a preferred embodiment of the system of the present invention as implemented on the Internet Web Site at “www.knowledgekiosk.com”, which serves as the launching point for accessing the various Knowledge Kiosks containing the data being managed by the system.

FIGS. (3A) and (3B) show a calendar page of a preferred embodiment of the system from which the “Passport” page and other areas of the Kiosk are accessible.

FIG. (3C) shows an example of a page revealing predefined categories of information pertaining to a particular element, and shows the library of files and functionalities accessible from the page or related to the element.

FIG. (4) shows the “Fast Tracks” page for the selected Knowledge Kiosk which provides access to the most commonly-used information in that particular Knowledge Kiosk.

FIG. (5) shows an example database schema for implementing the present invention in a litigation support context entitled “Categories of a Litigation Knowledge Kiosk Elements-Overview”.

FIG. (6) shows an example database schema for implementing the present invention in a multi-tier litigation support context entitled “Overall Organization—Multi-Tier Litigation Knowledge Kiosk”.

FIG. (7) shows an example of a submission form completed by the user for storage of an item of information within a selected Knowledge Kiosk.

FIGS. (8A) through (8H) show examples of the various searches that can be conducted for retrieving a Knowledge Element from a particular Knowledge Kiosk

FIGS. (8I) and (8J) show an example of other search tools for retrieving an element from a particular kiosk.

FIG. (9) shows an example of a “Knowledge Element Classification Profile” containing fields providing information describing and classifying the Knowledge Element.

FIGS. (10A) through (10D) show an example of an advanced search designed to retrieve a multimedia rendering of a particular Knowledge Element.

FIGS. (11A) through (11D) show an example of an advanced boolean search conducted to locate a particular data string within any Knowledge Element in the Knowledge Kiosk of interest.

FIGS. (12A) through (12E) show an example of a classification conducted on a document that has already been entered as a Knowledge Element within a selected Knowledge Kiosk.

FIGS. (13A), (13B) and (14) show an example of searches that can be conducted on the classifications created by the user with the options shown for example in FIGS. (12A) through (12E).

FIGS. (15A) through (15E) show an example of a user-defined “Favorites” page.

FIG. (16) shows an example of a user-defined “Presentation Queue” folder.

FIGS. (17A) through (17C) show an example of the “Knowledge Element Viewer”.

FIGS. (18A) through (18D) show examples of the results of various searches conducted on different types of information contained within the “Knowledge Element Profile”.

FIGS. 19(A) through (19C) show examples of the information contained in a “Knowledge Kiosk Journal” which provides different ways of tracking all user activity with respect to a given Knowledge Kiosk.

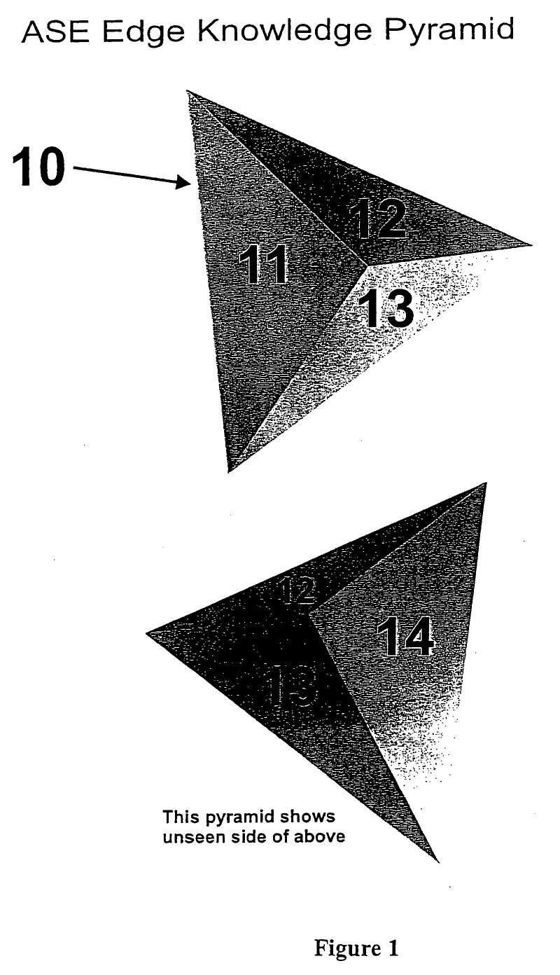

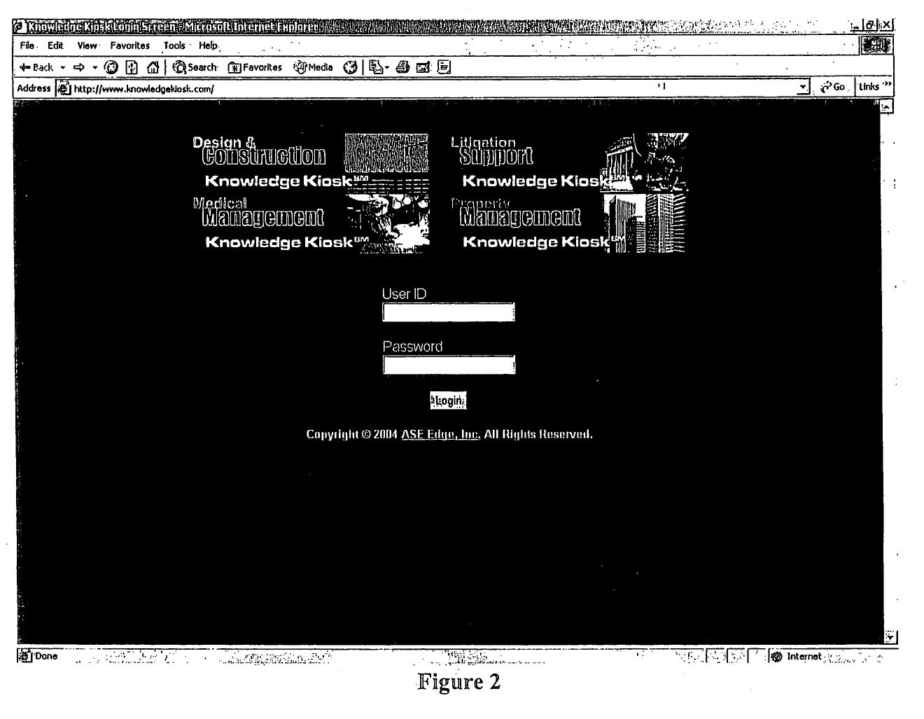

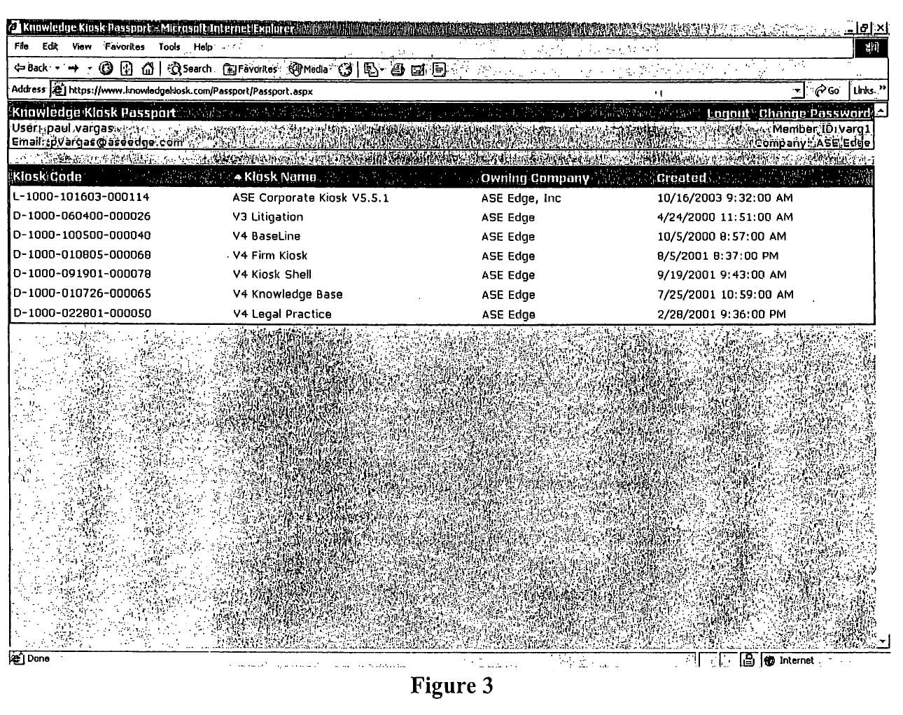

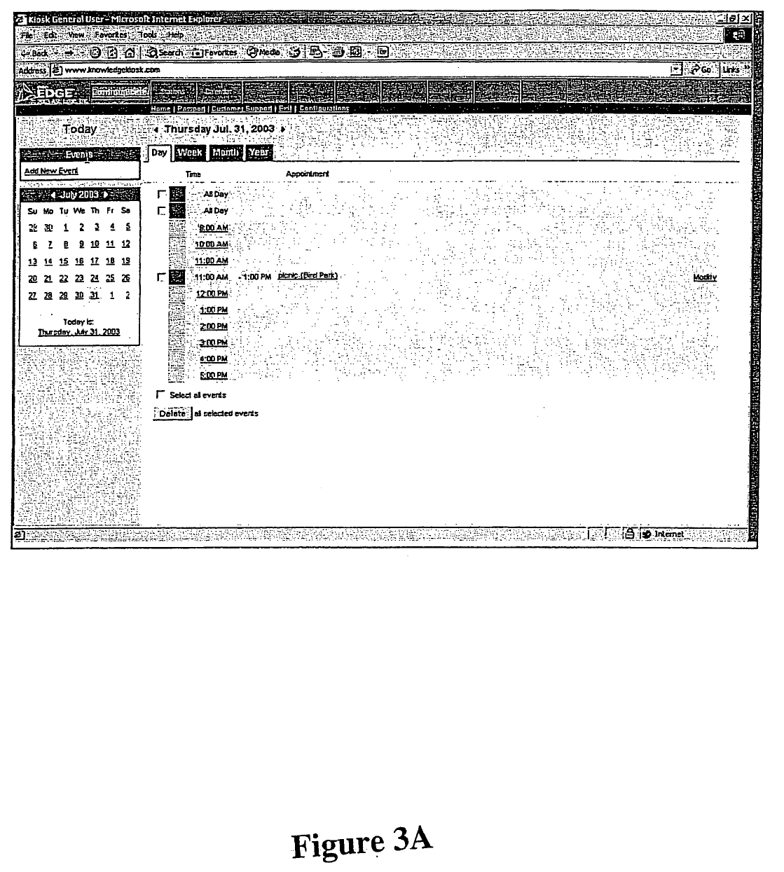

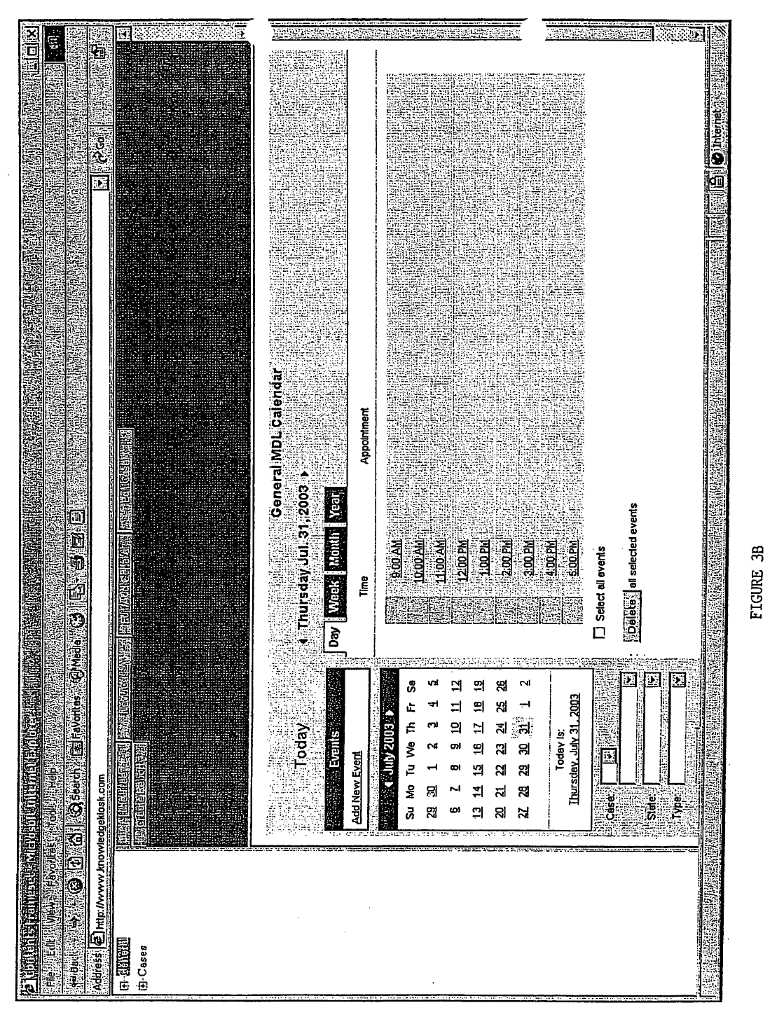

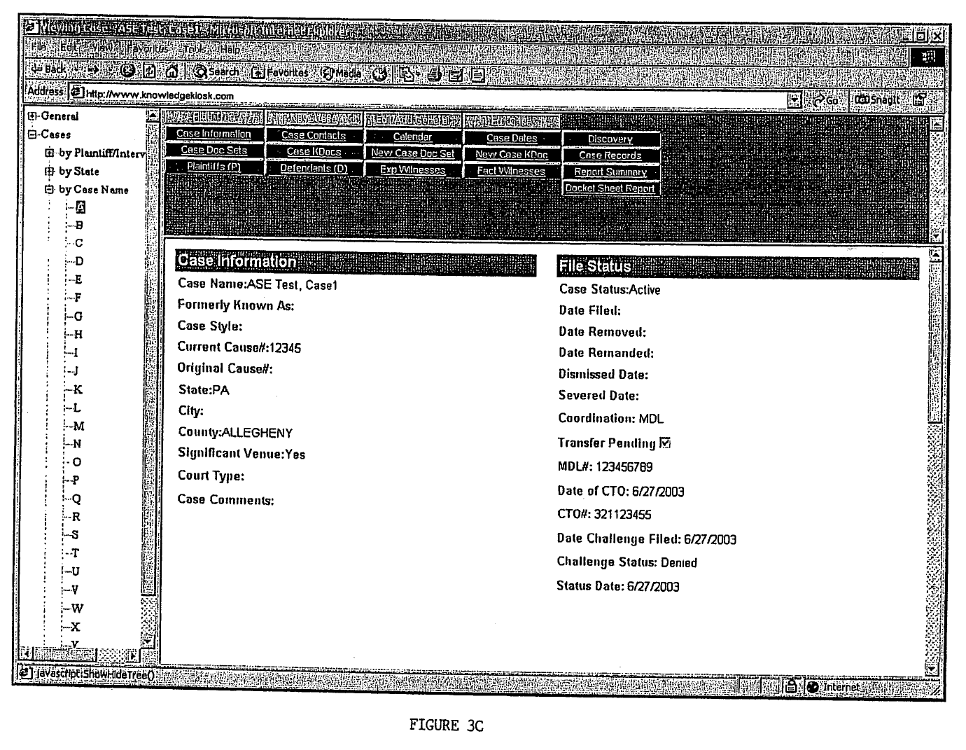

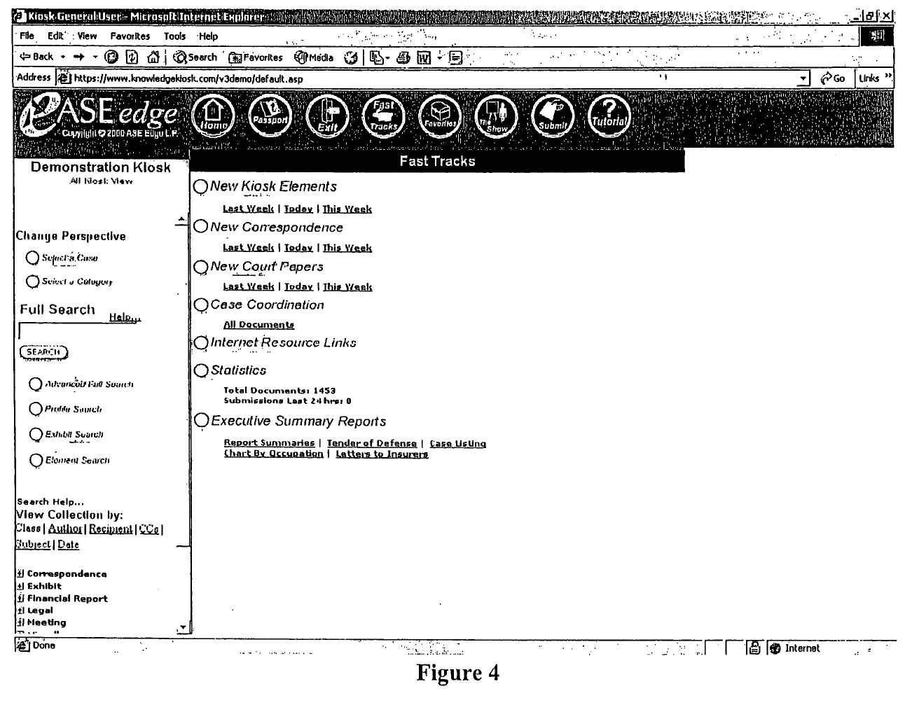

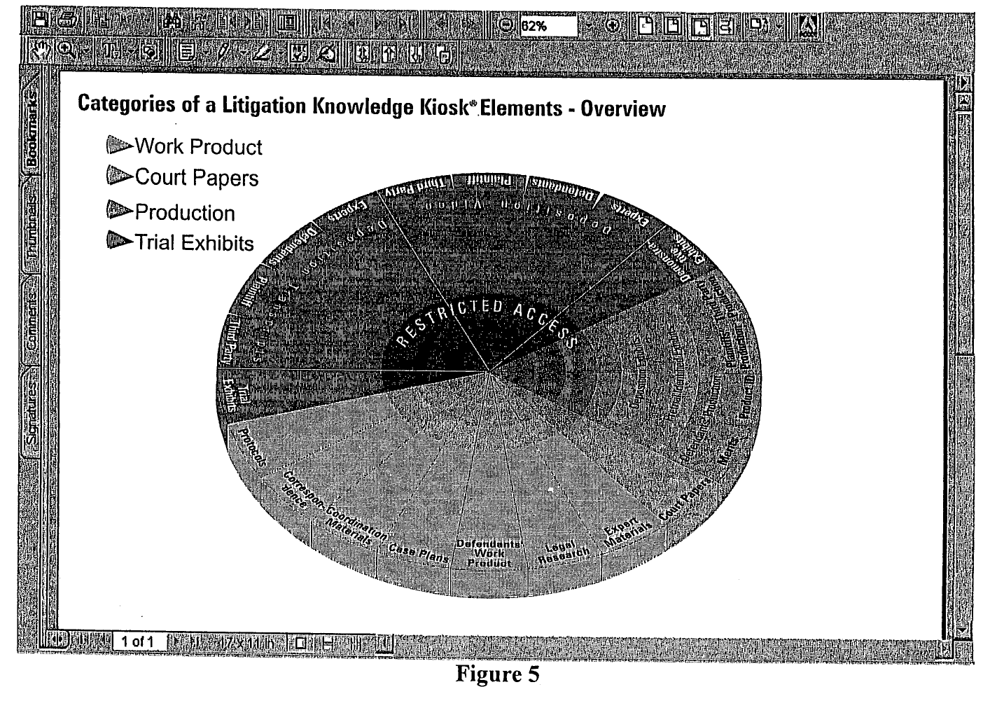

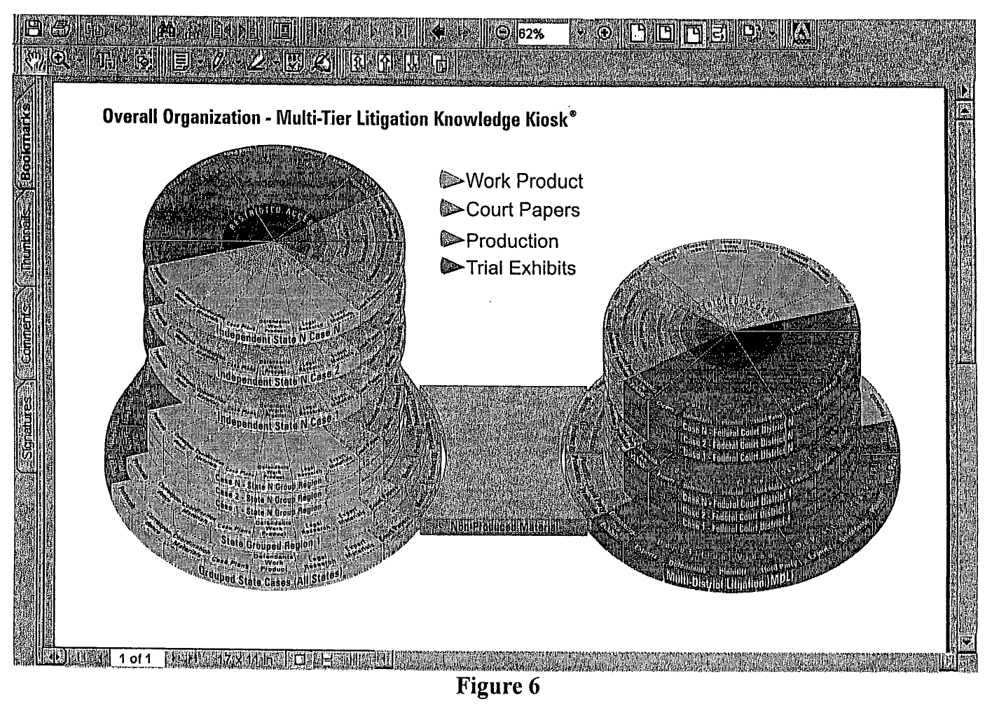

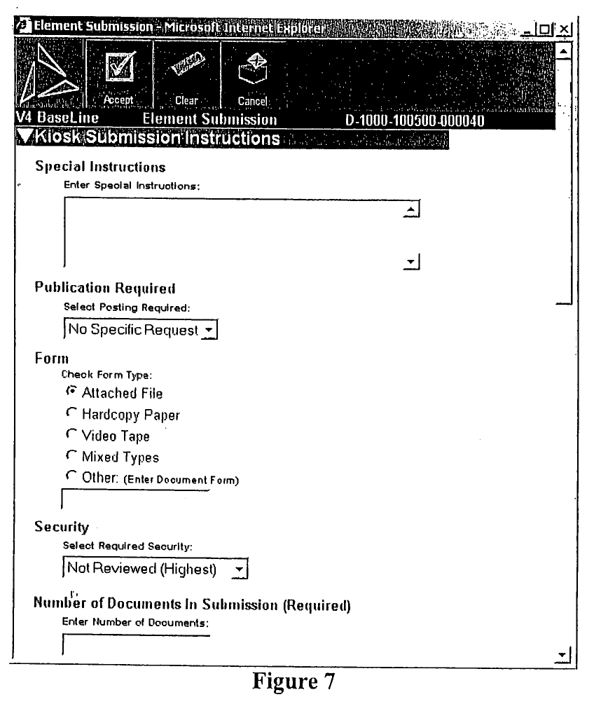

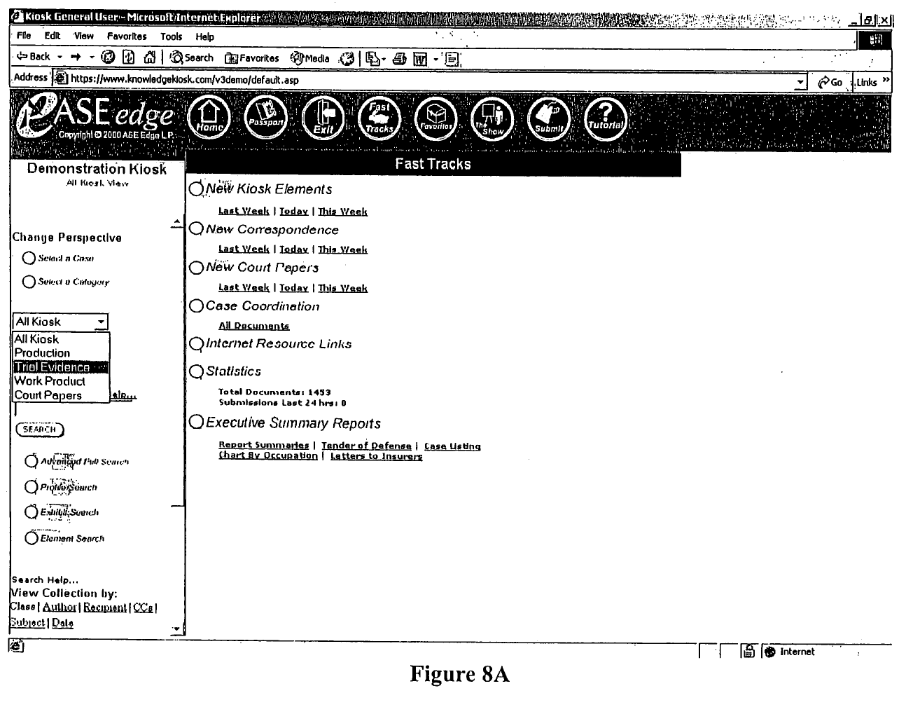

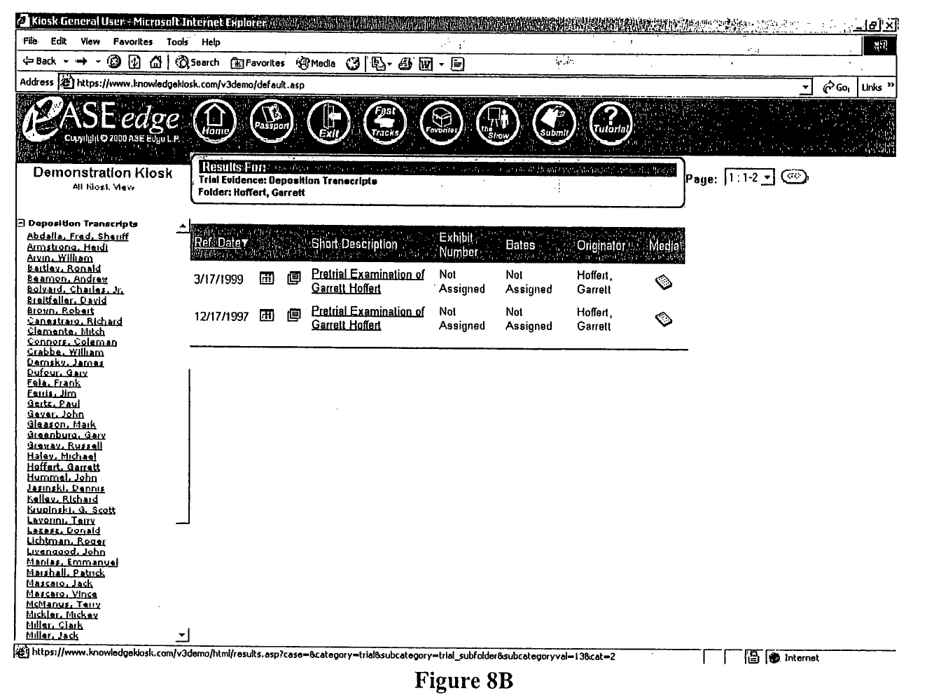

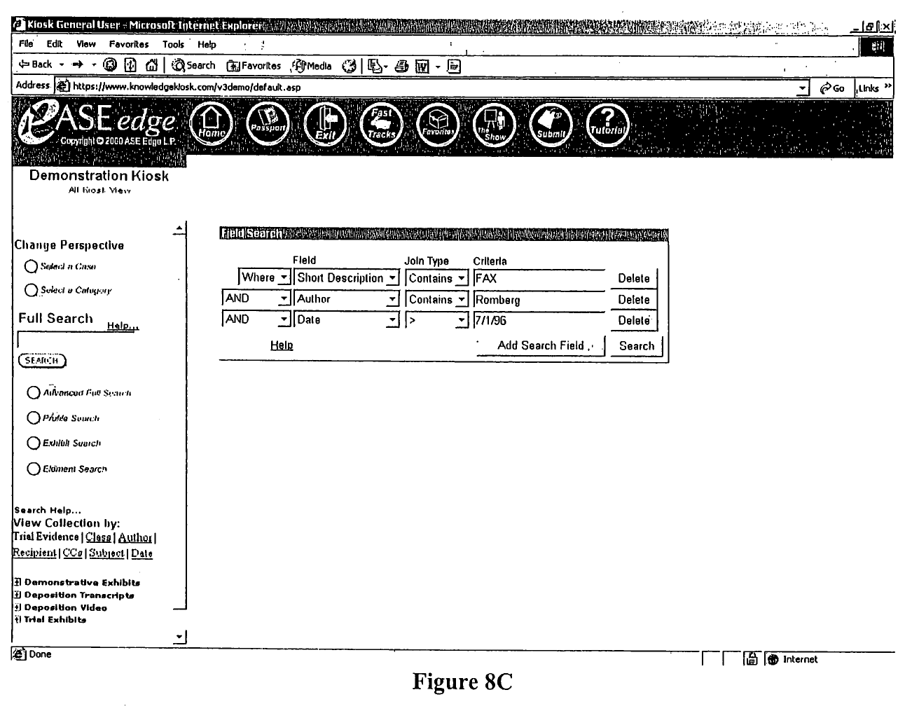

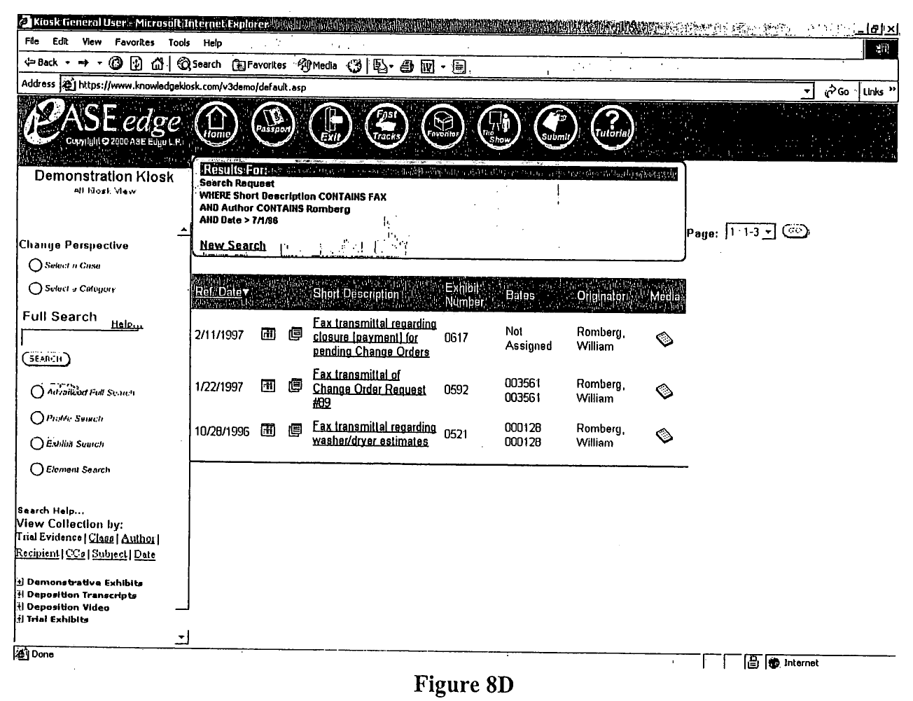

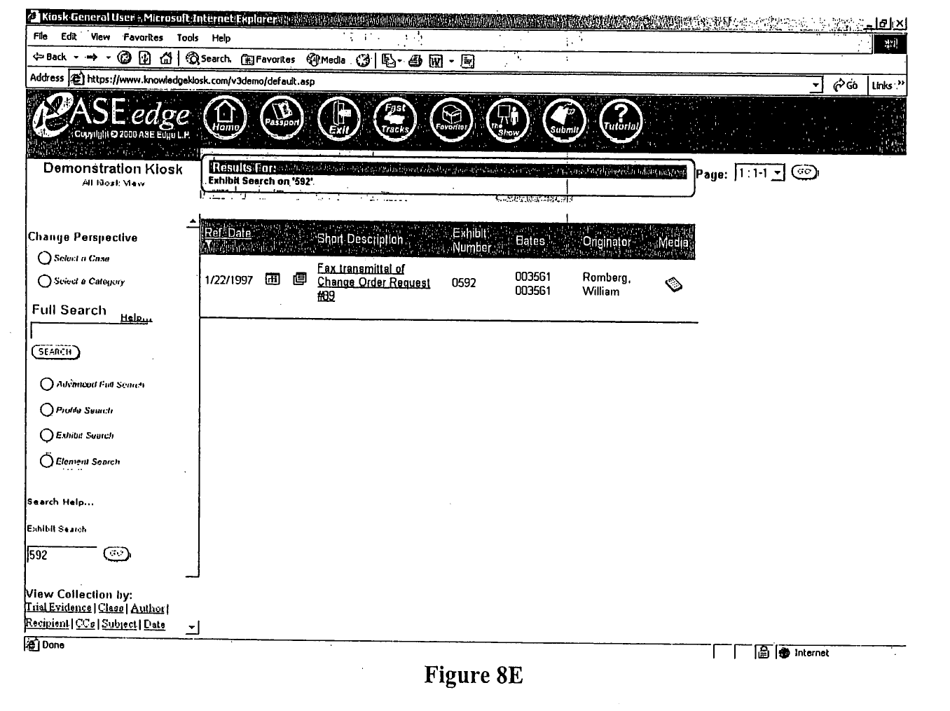

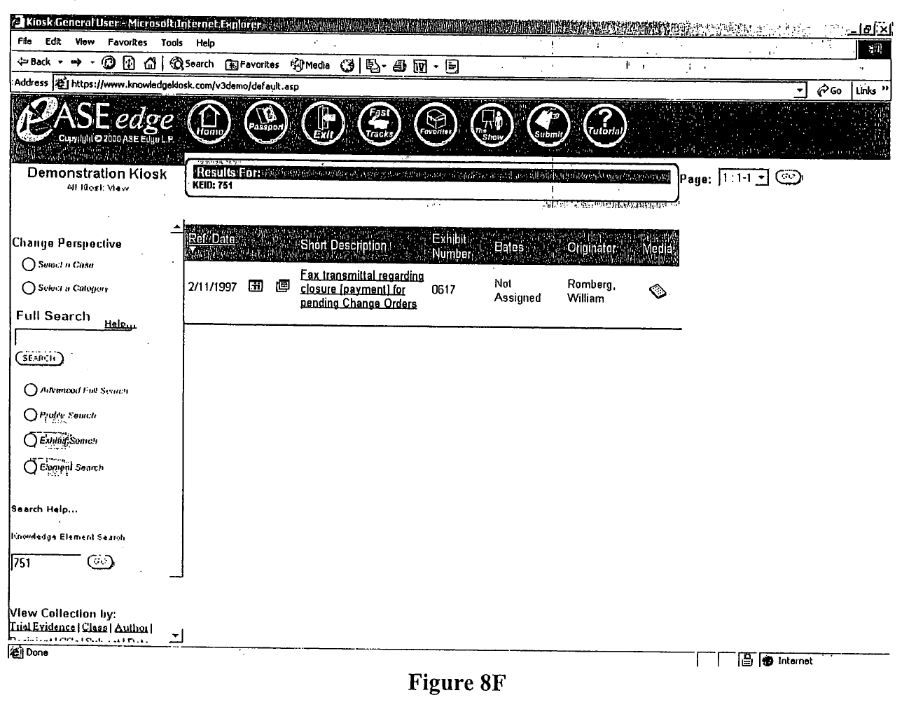

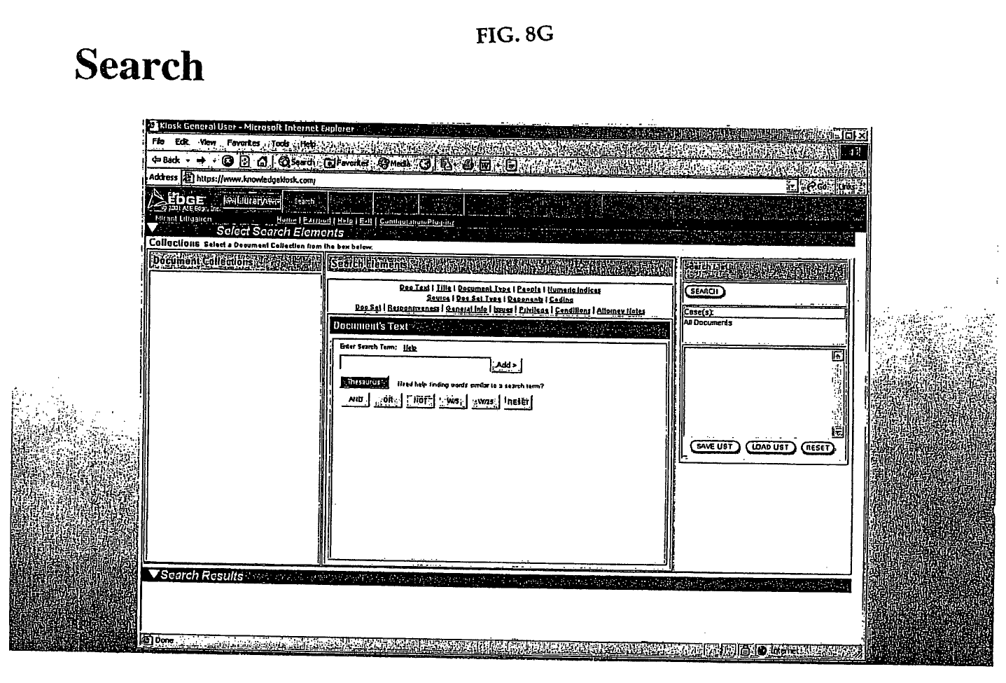

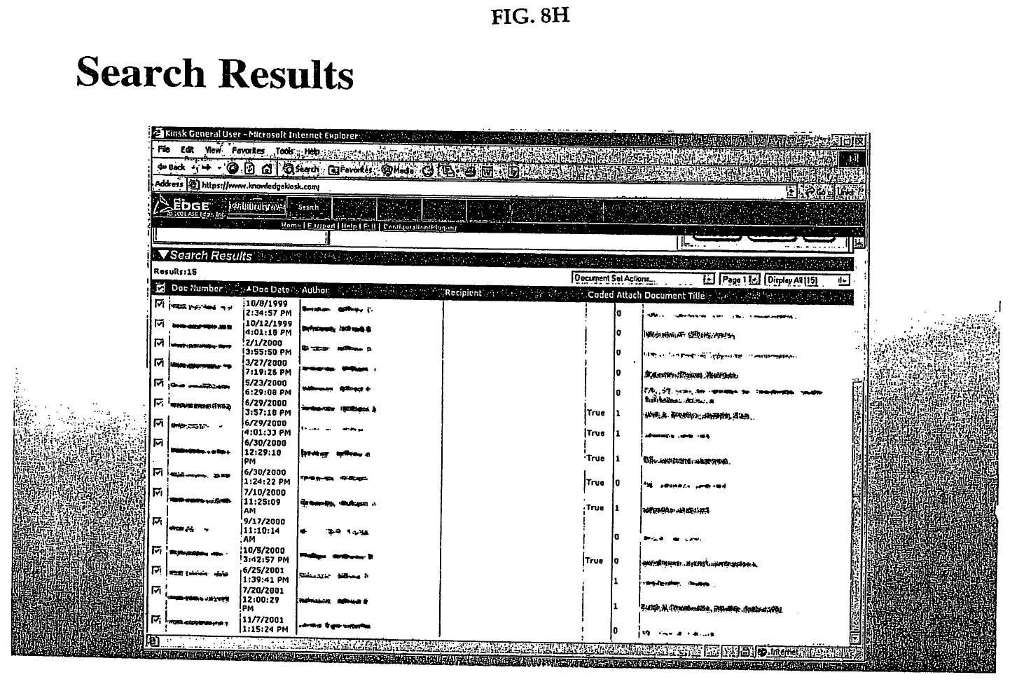

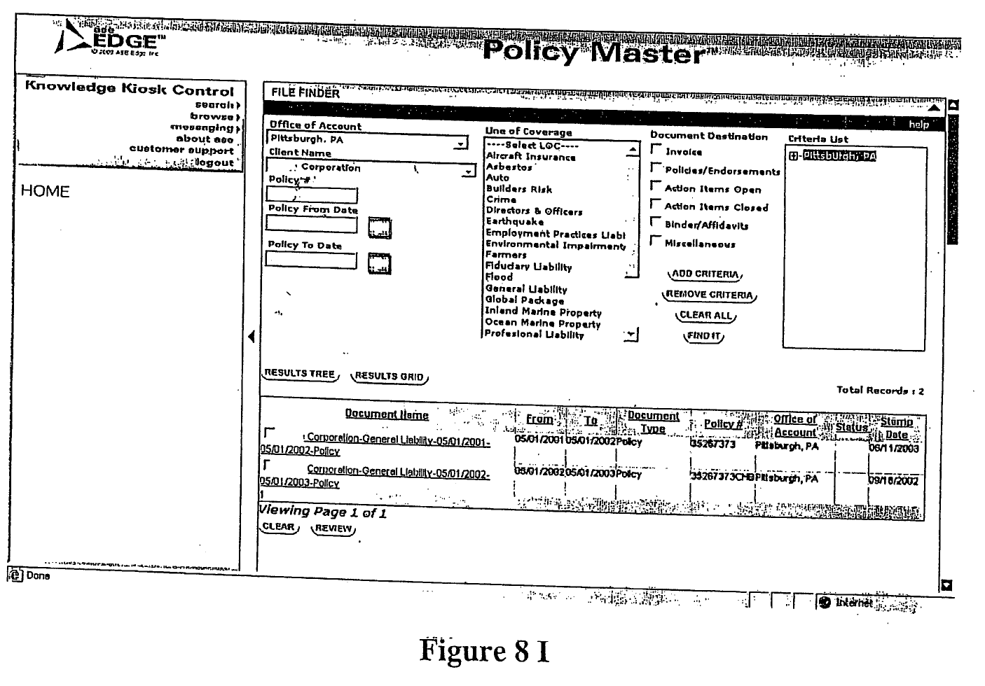

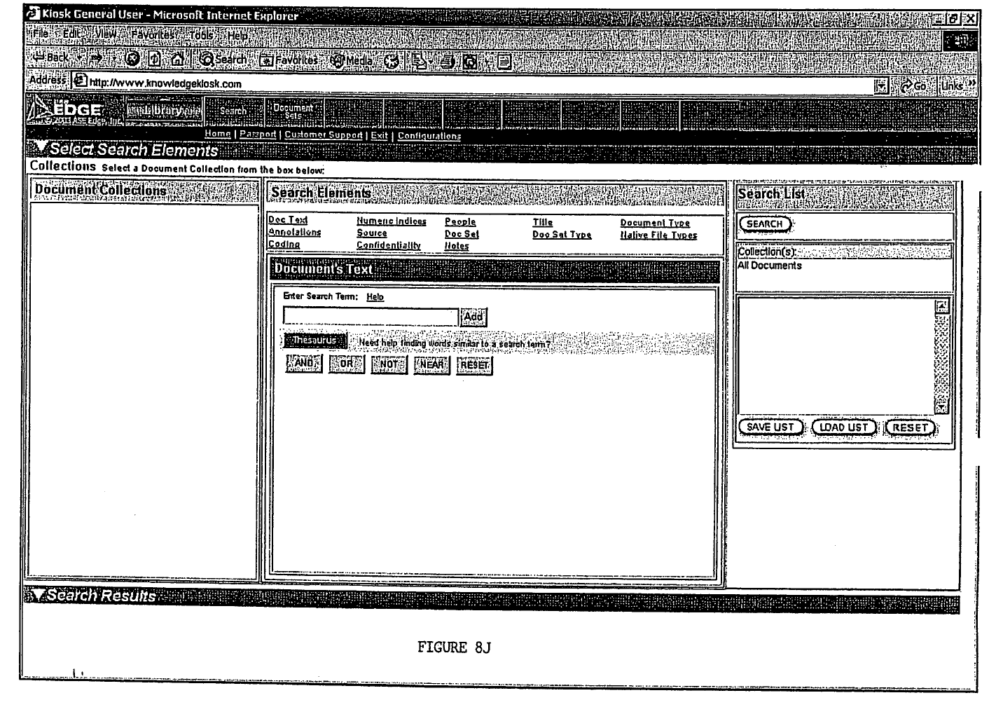

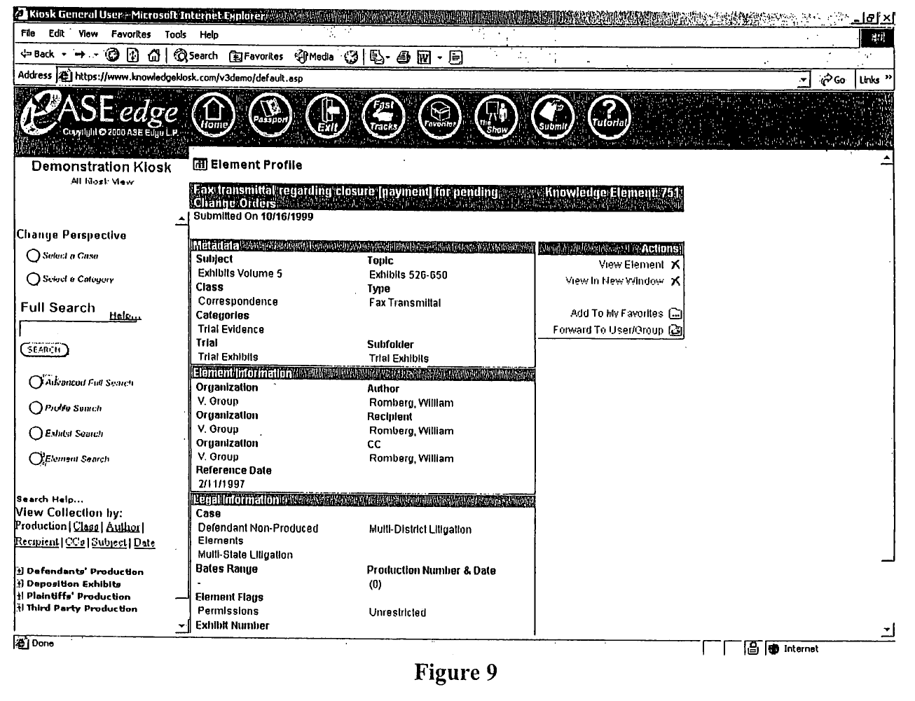

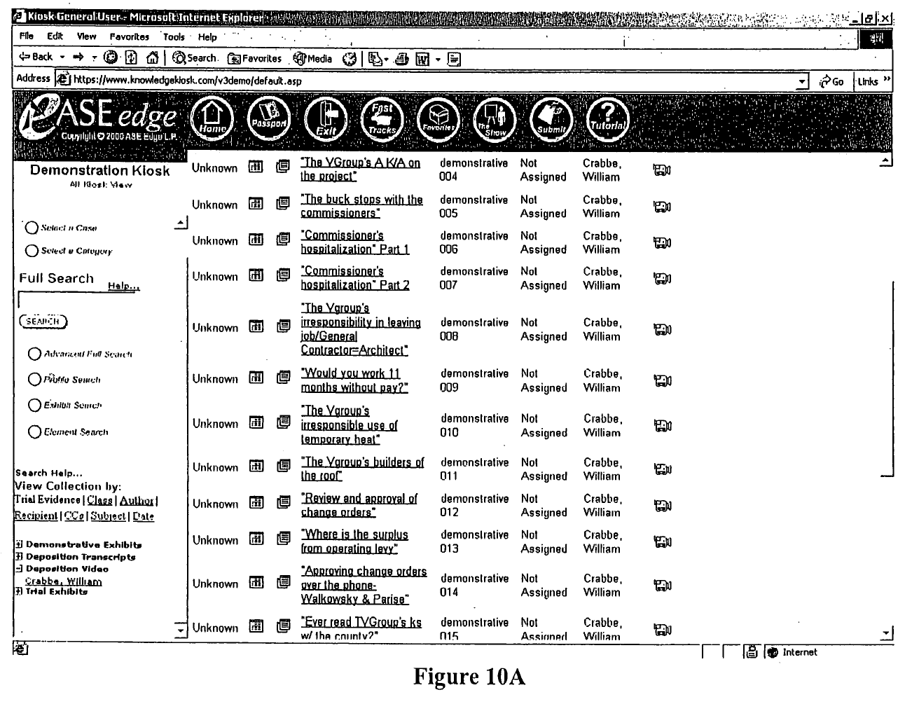

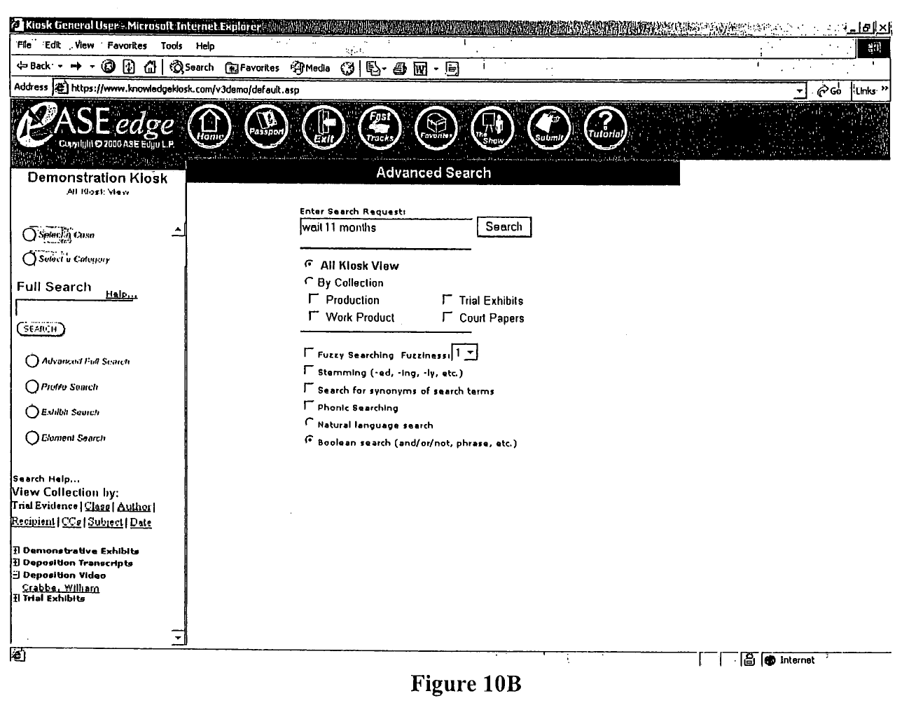

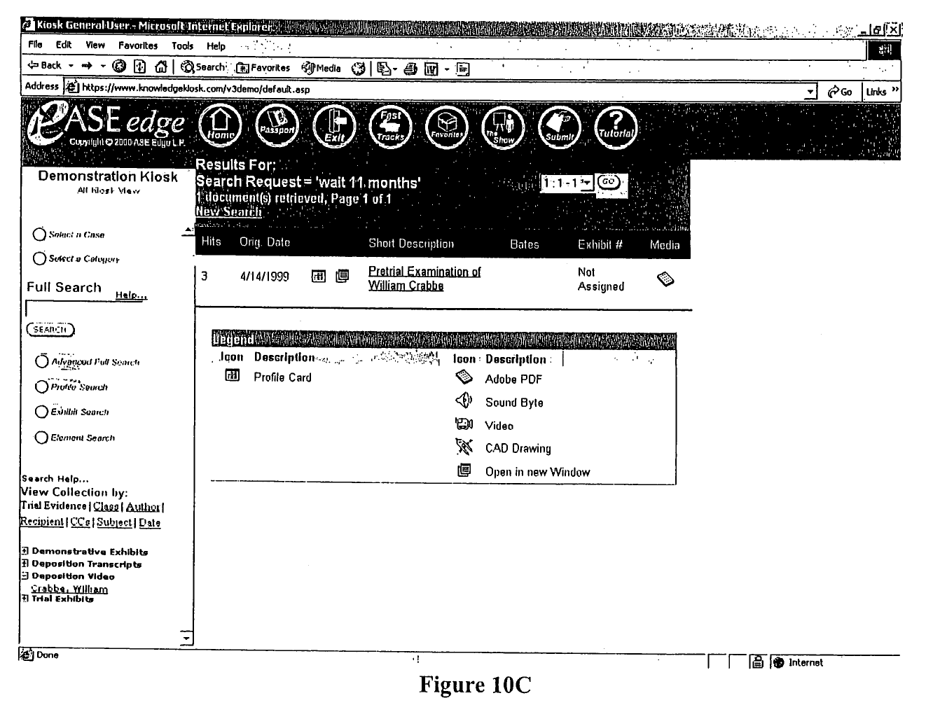

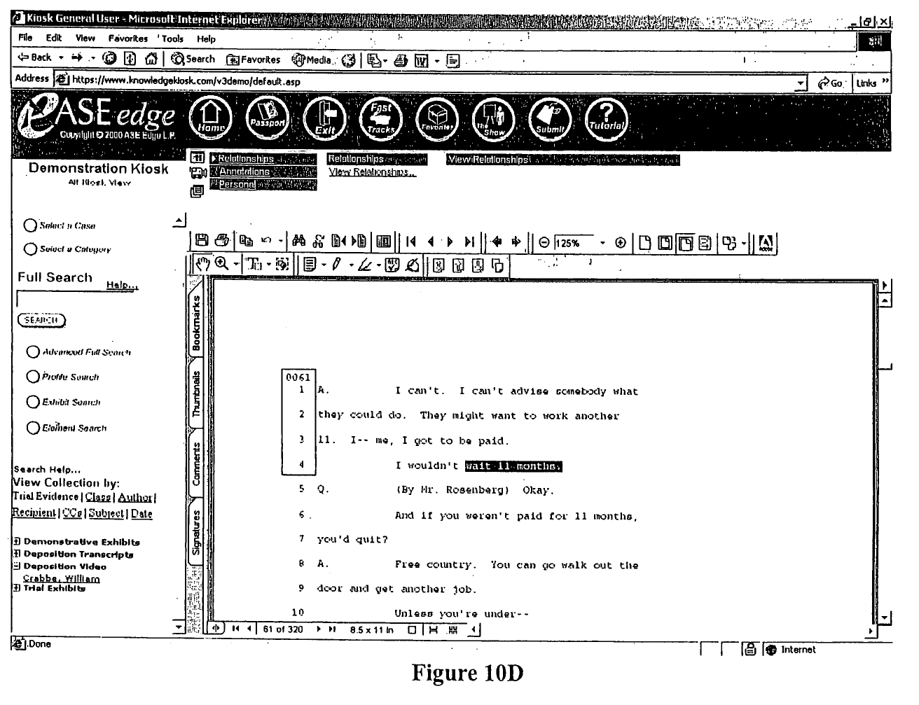

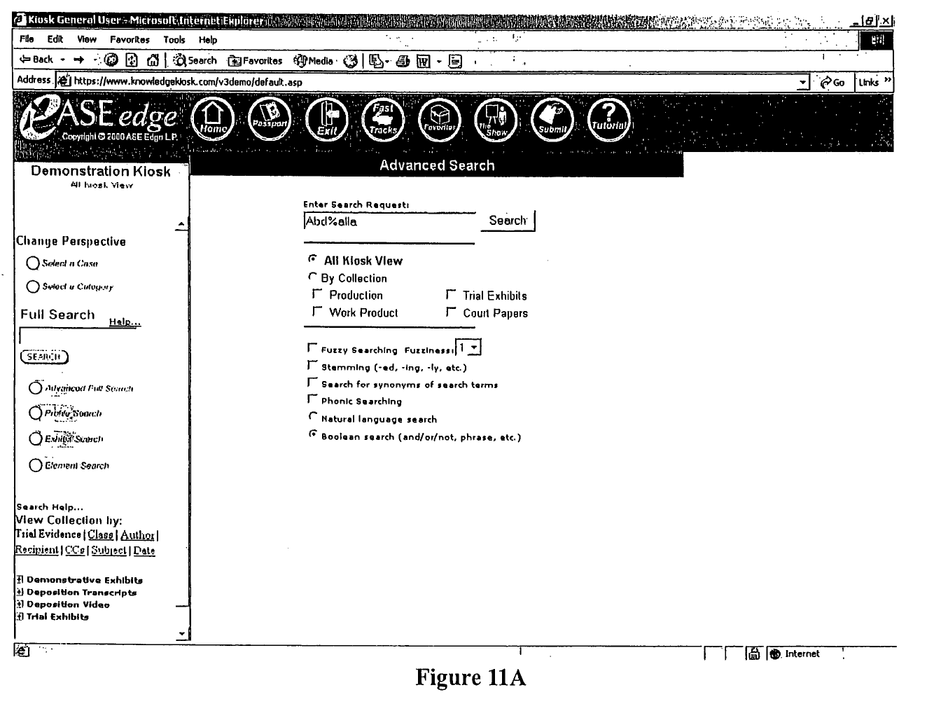

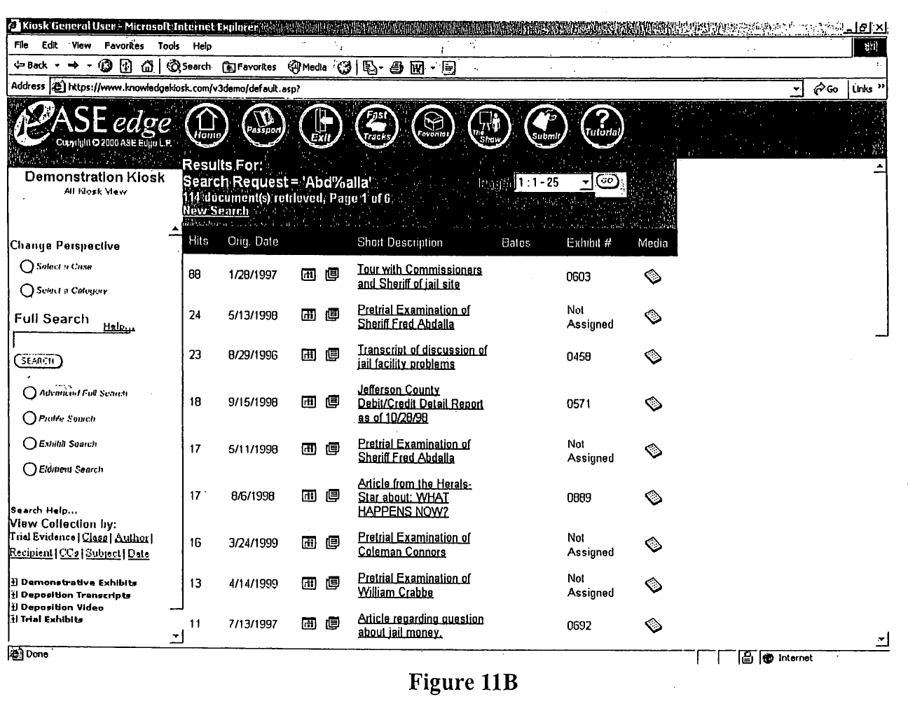

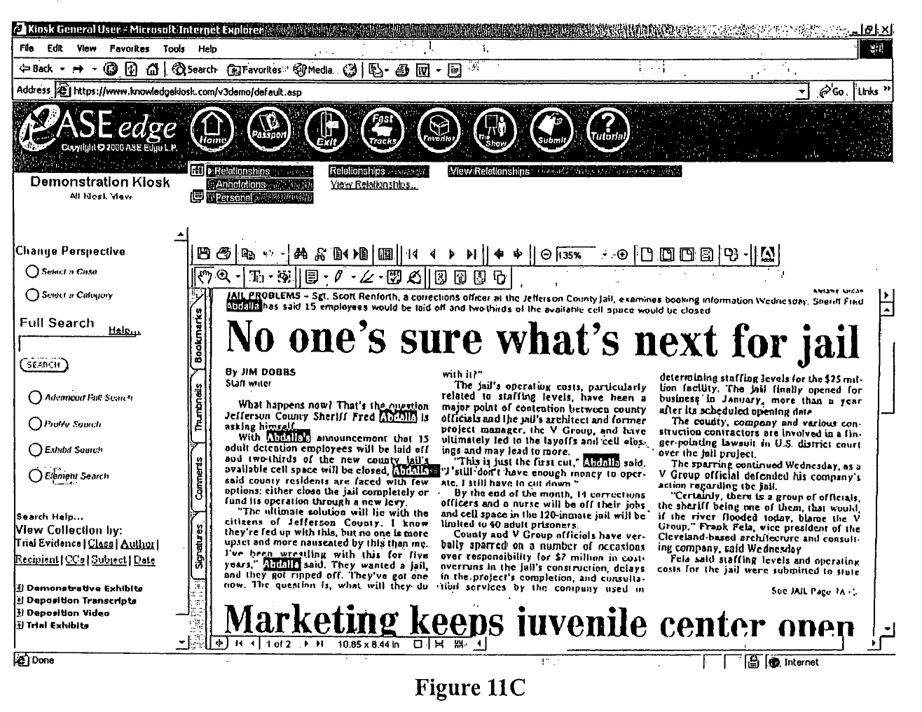

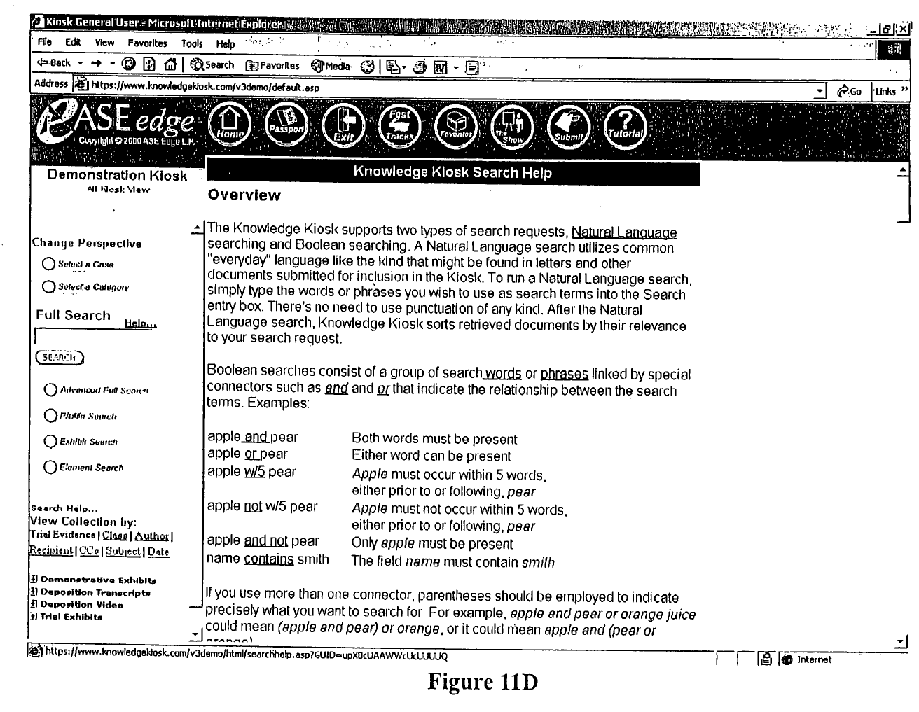

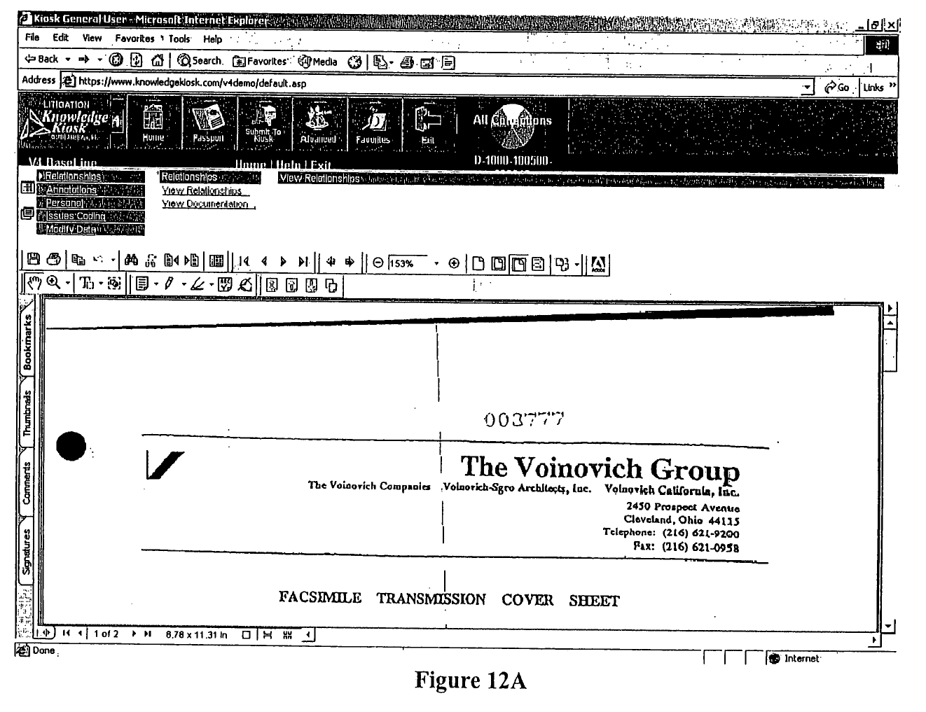

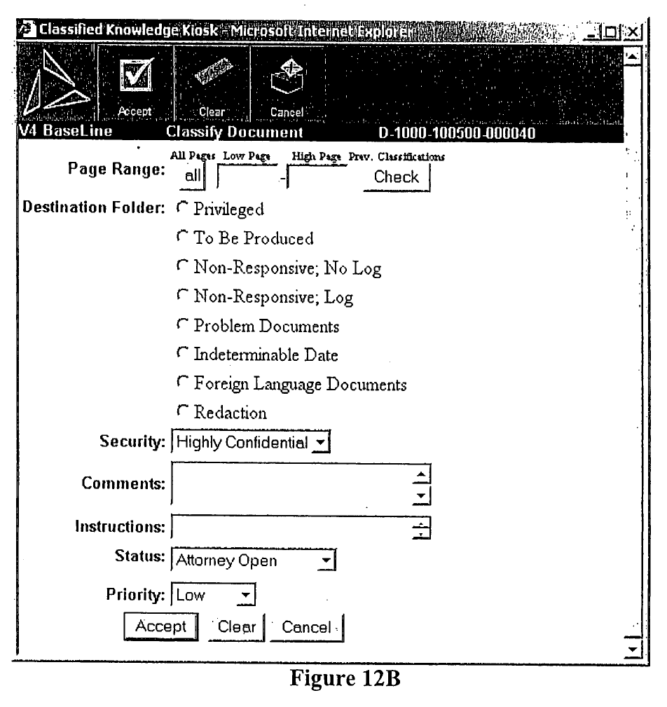

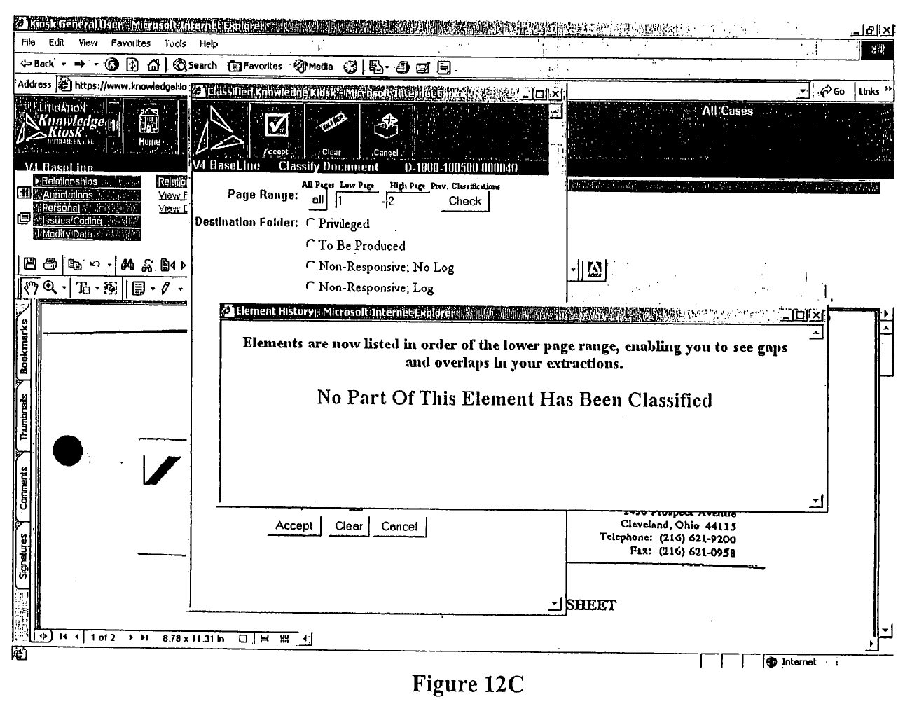

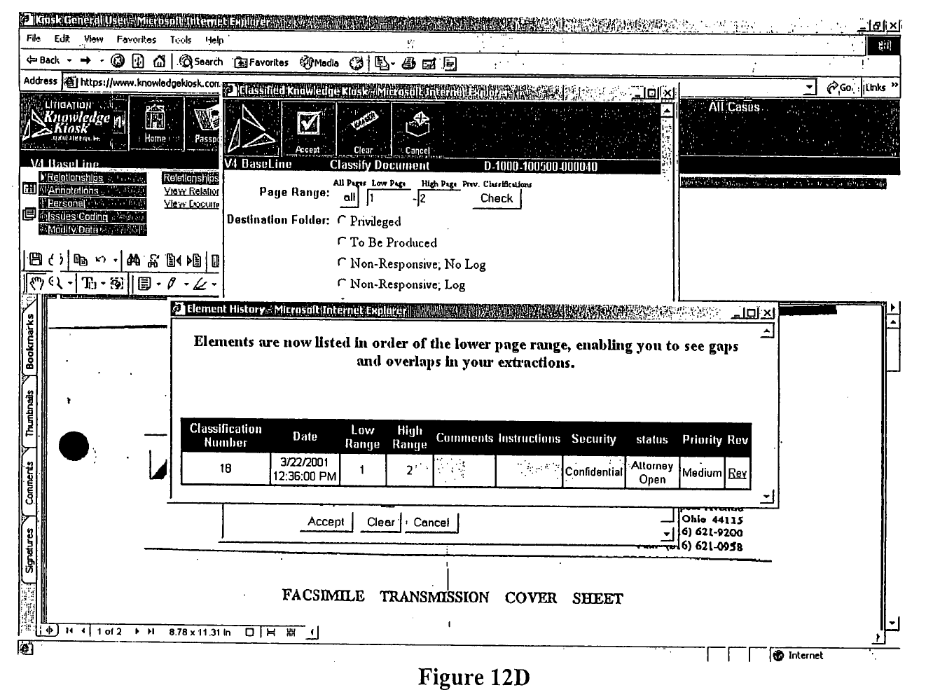

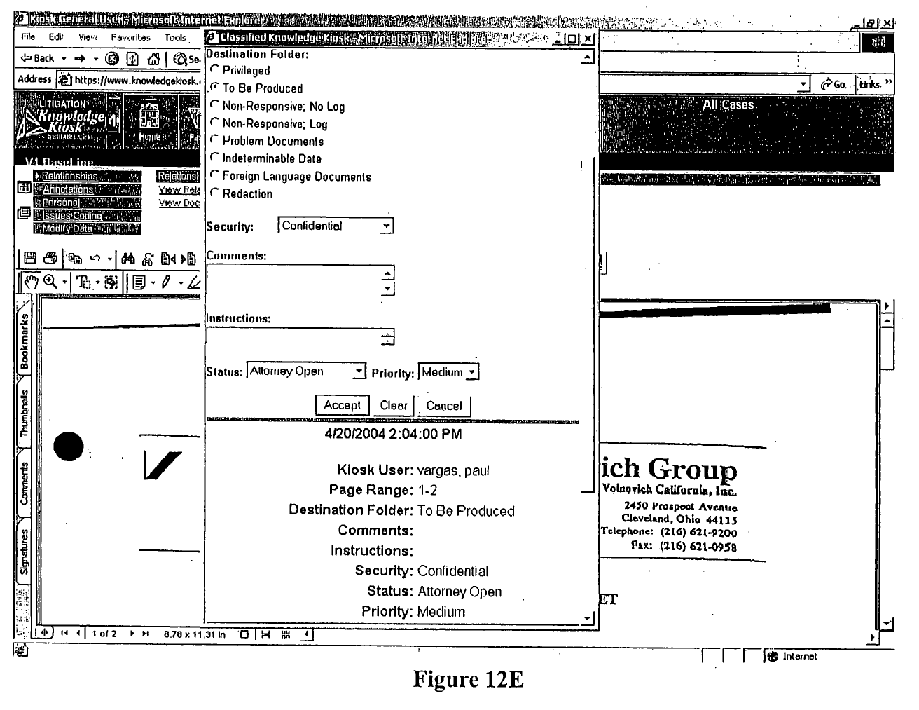

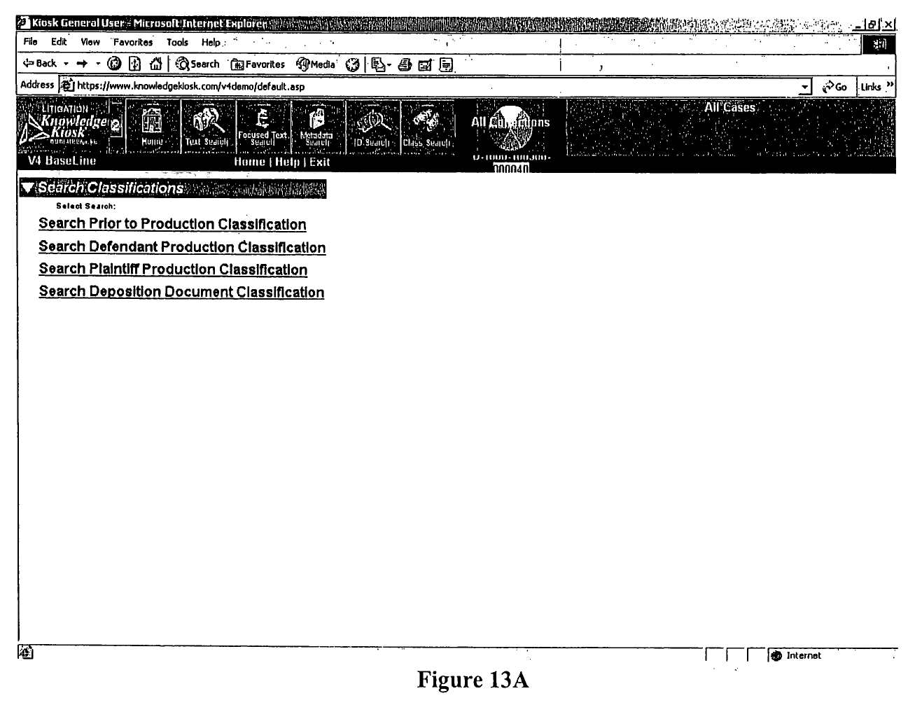

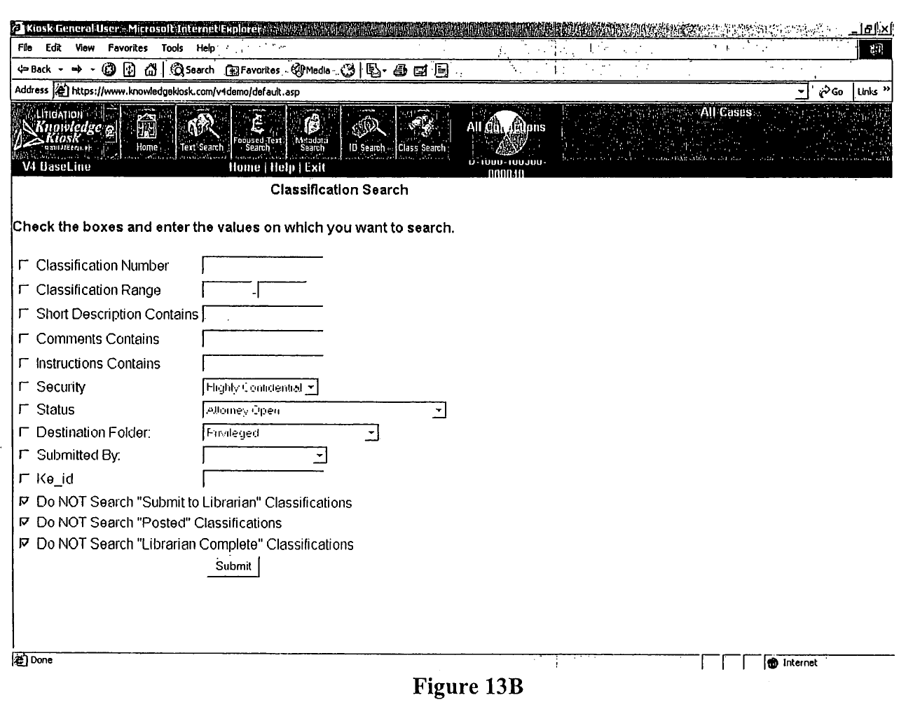

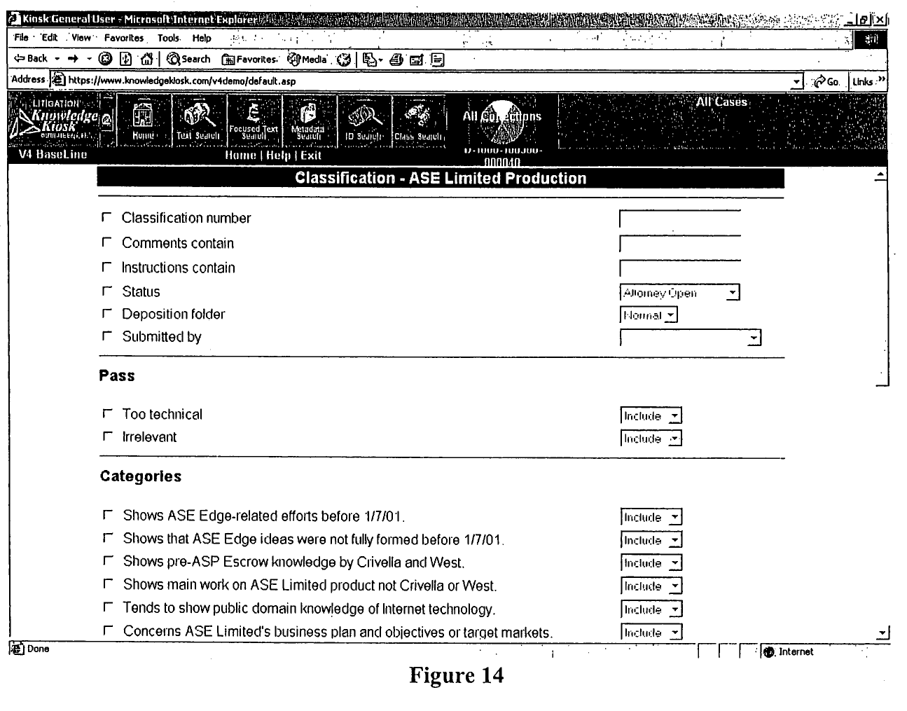

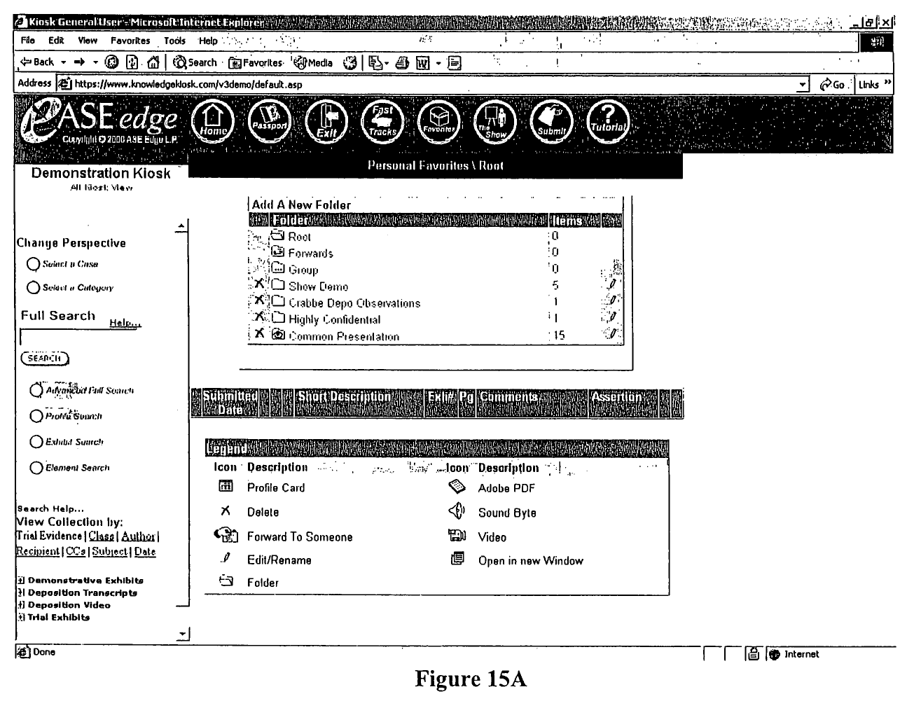

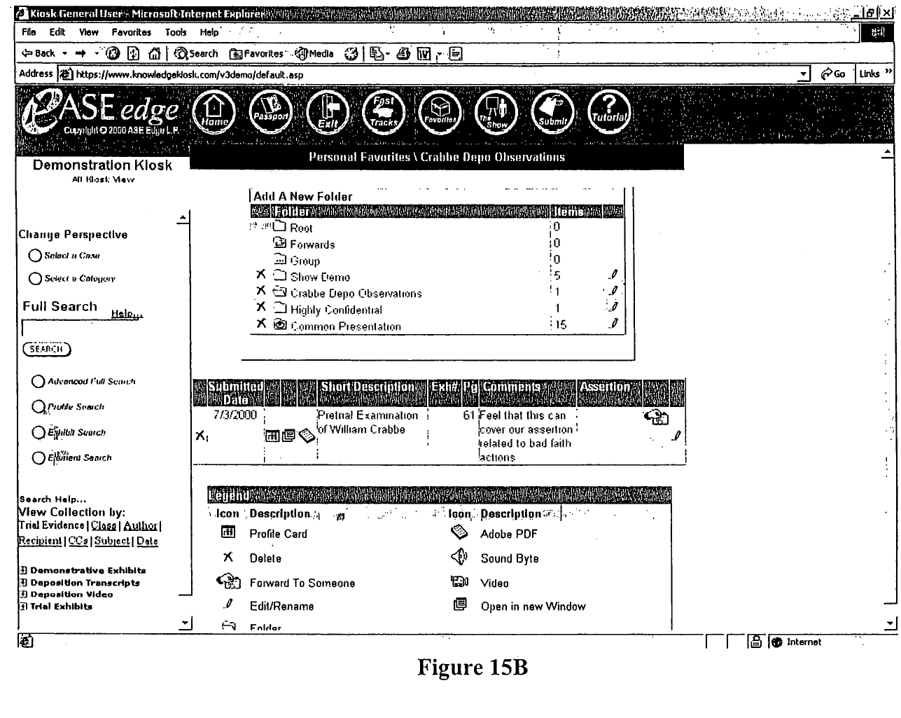

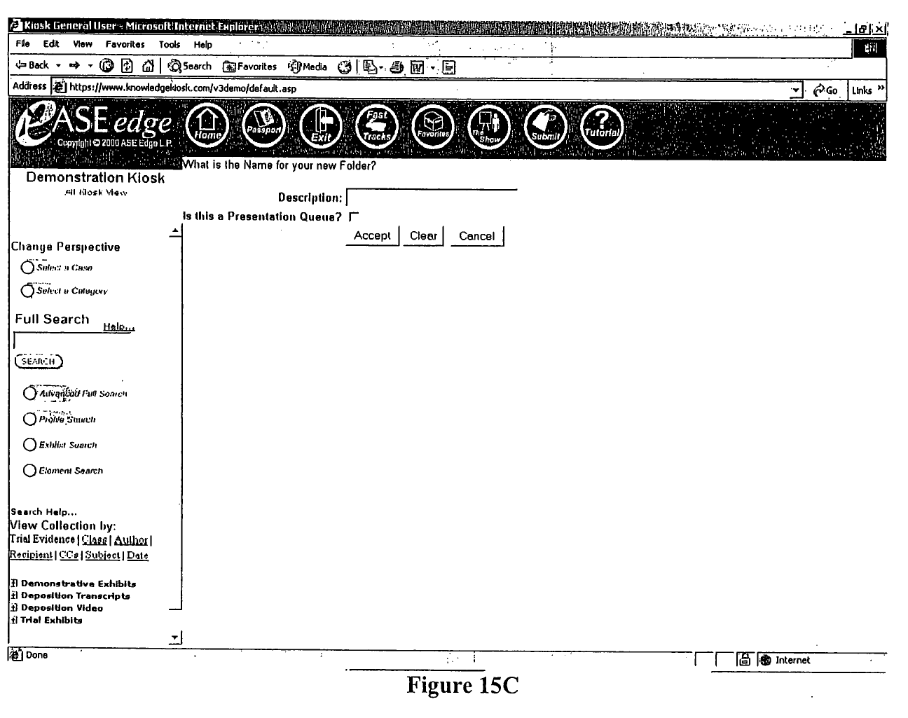

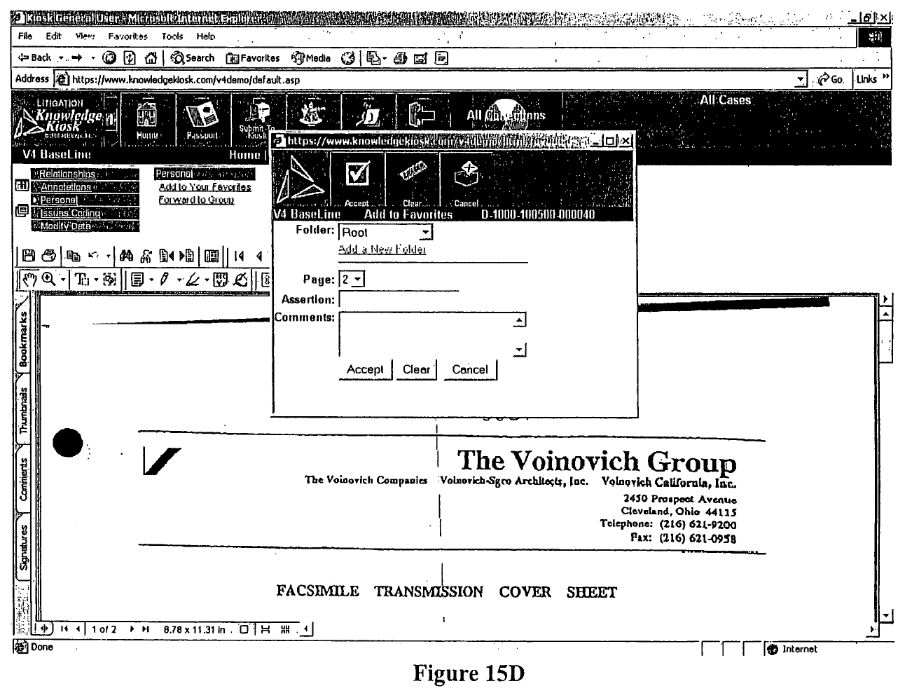

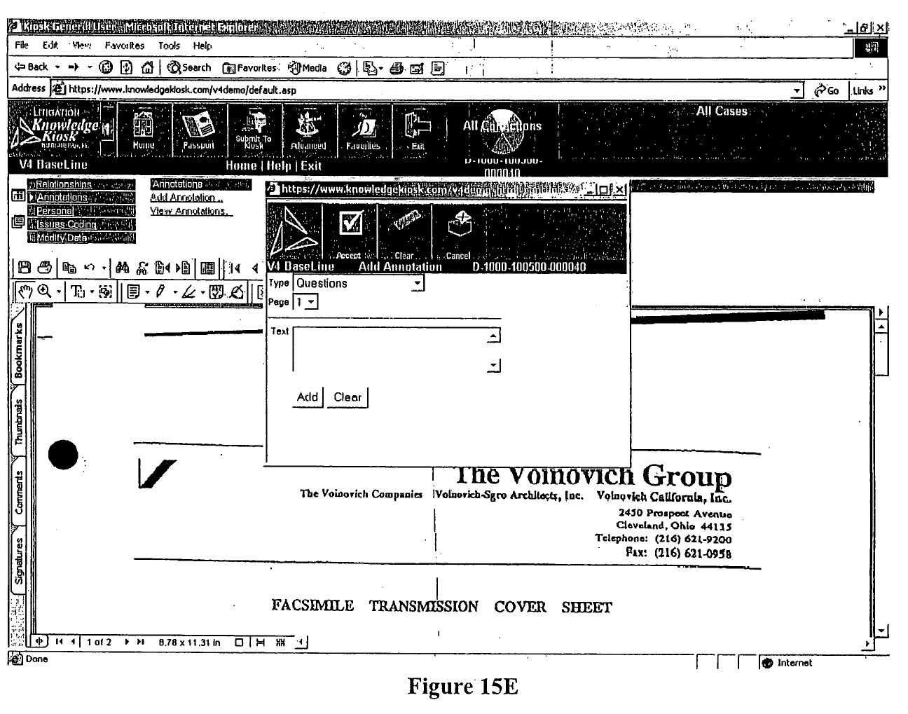

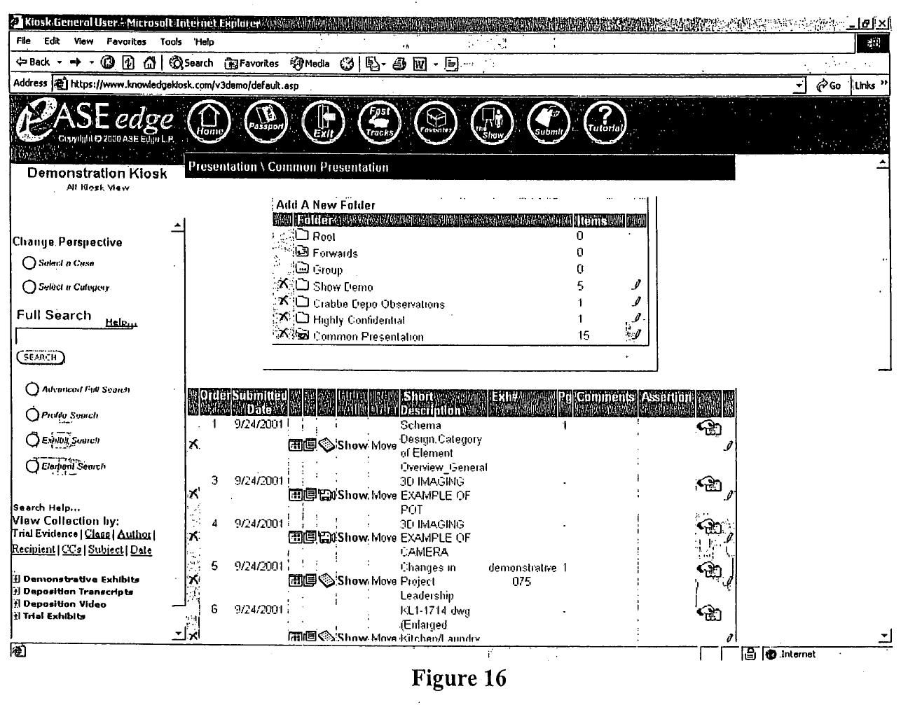

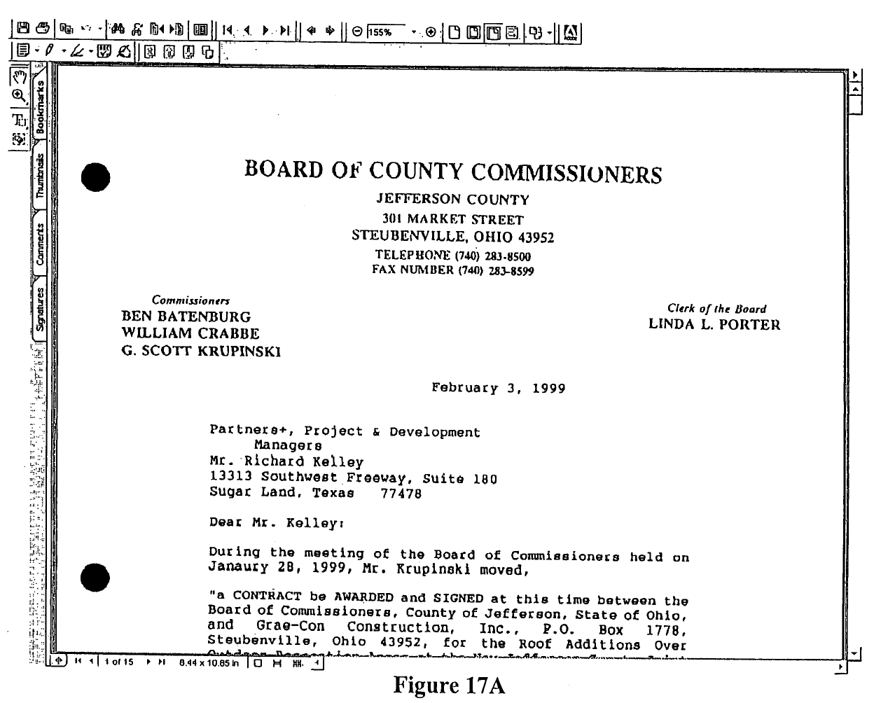

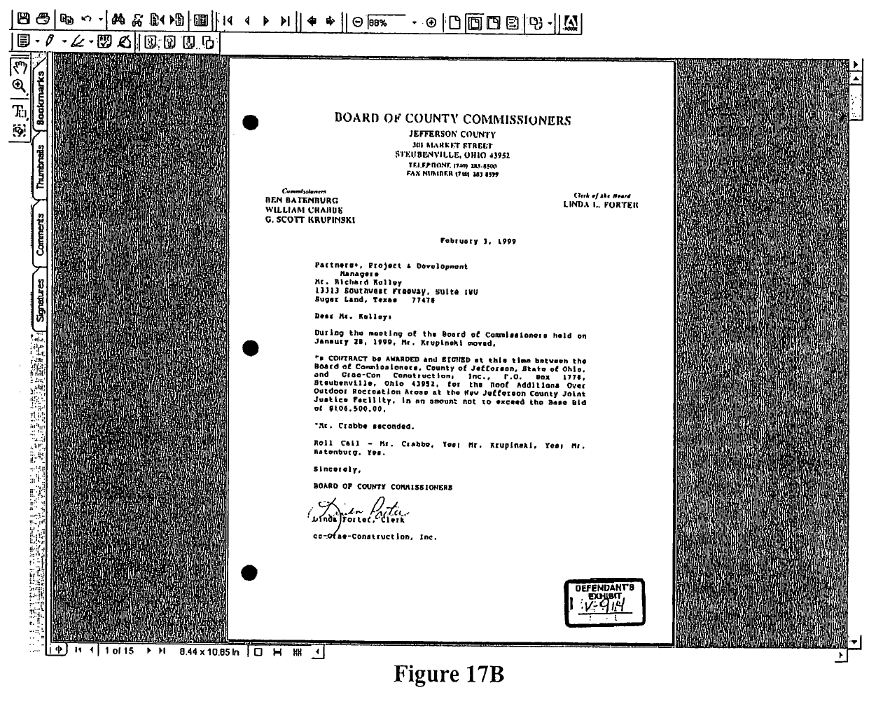

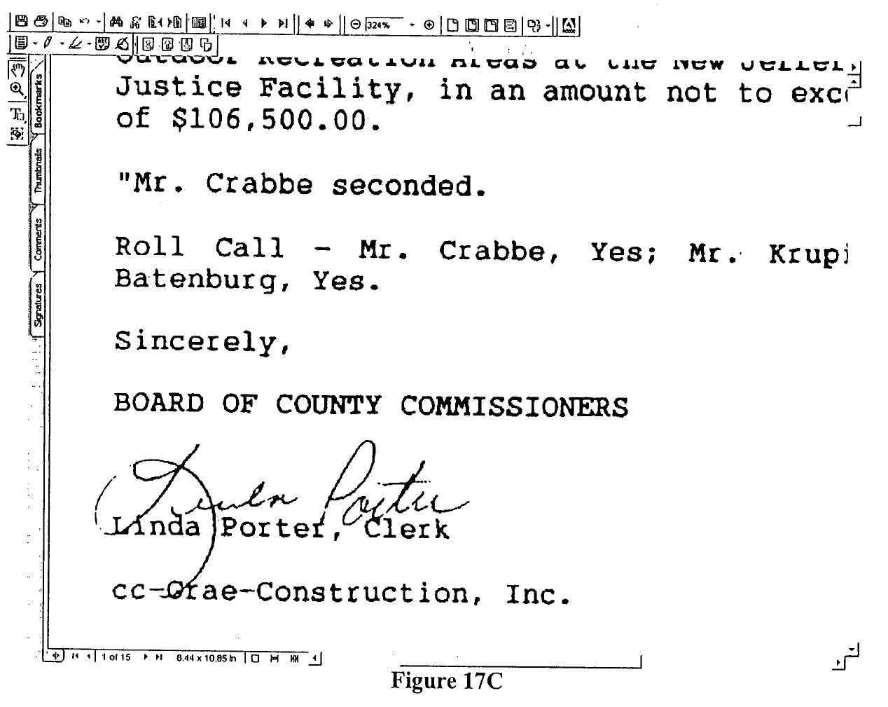

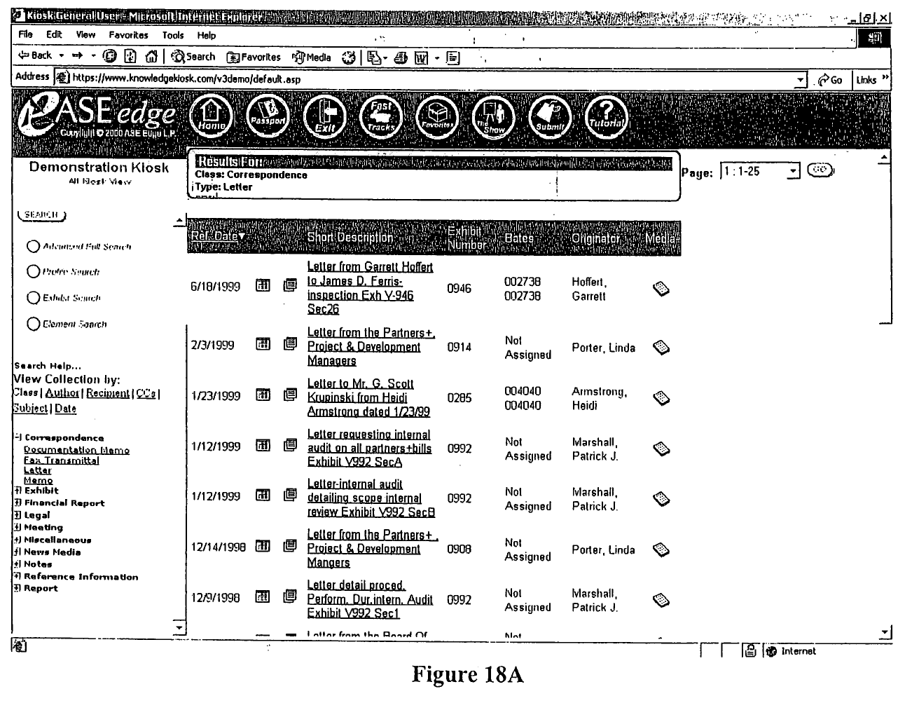

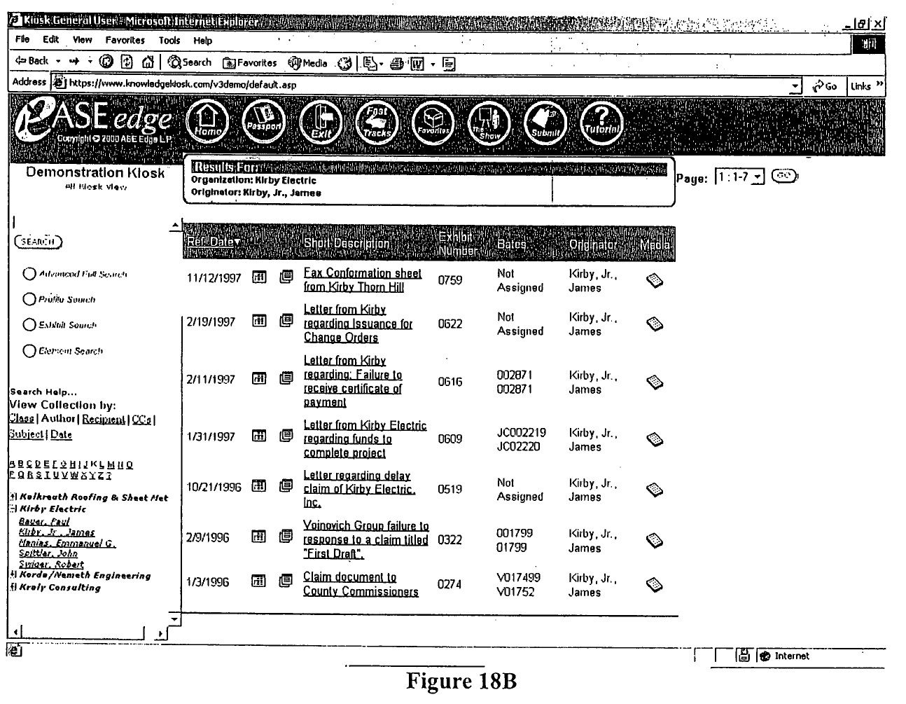

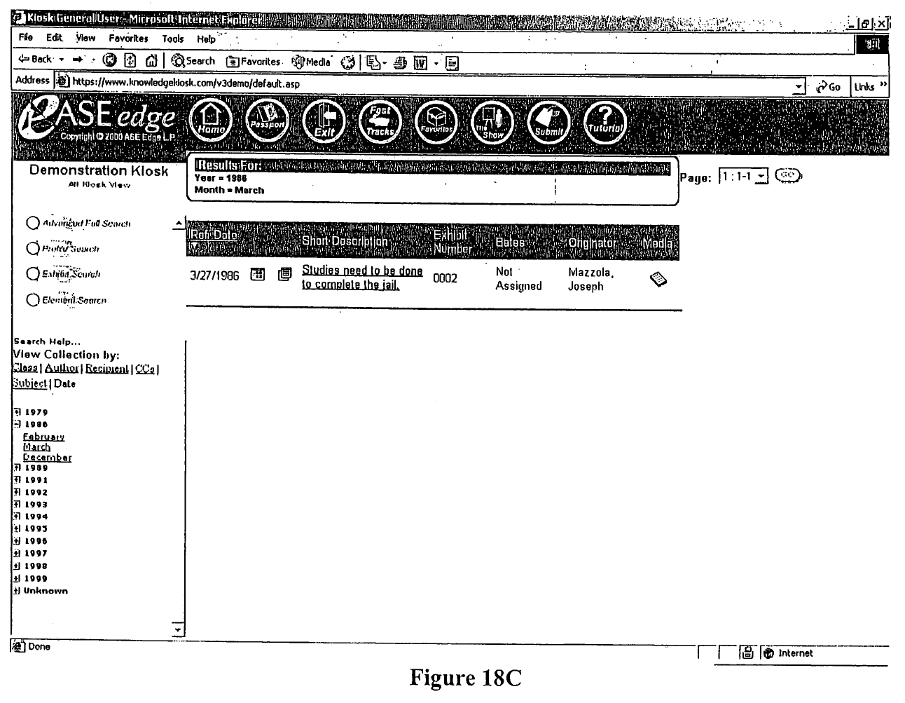

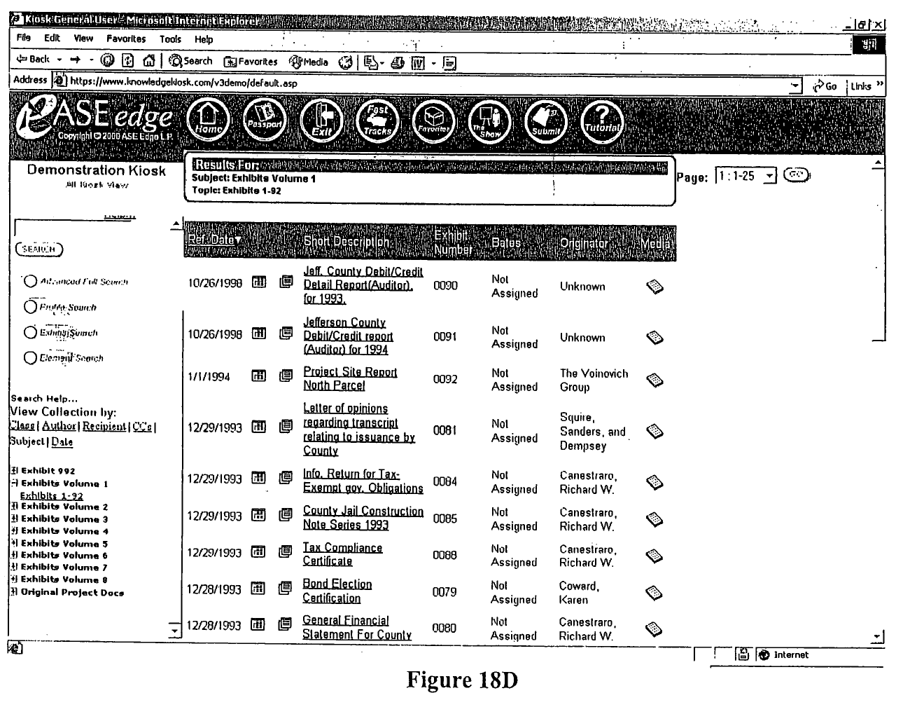

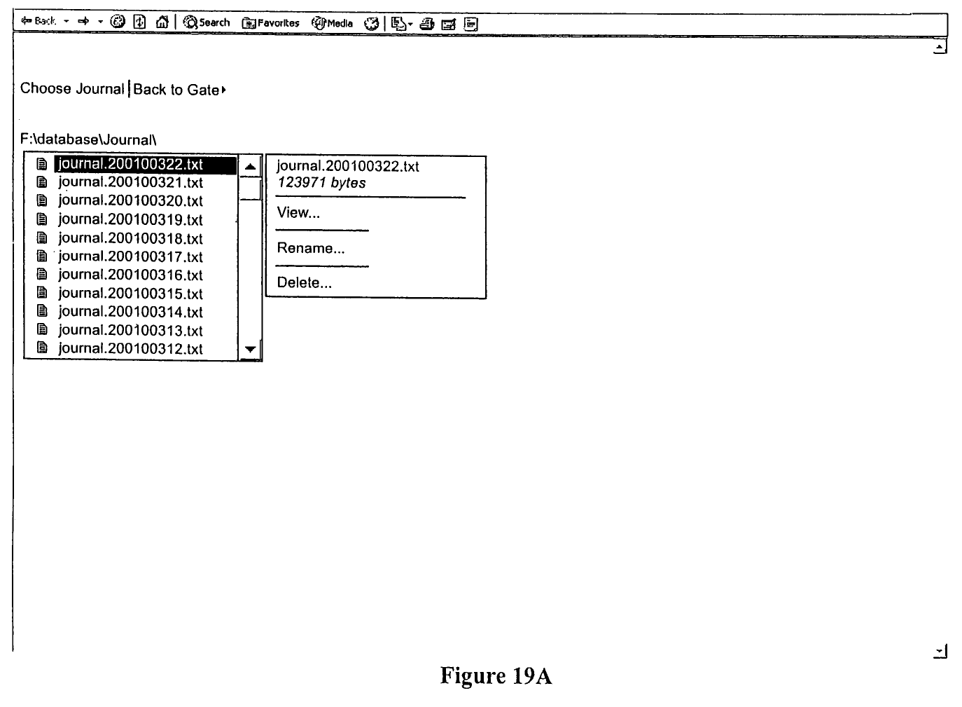

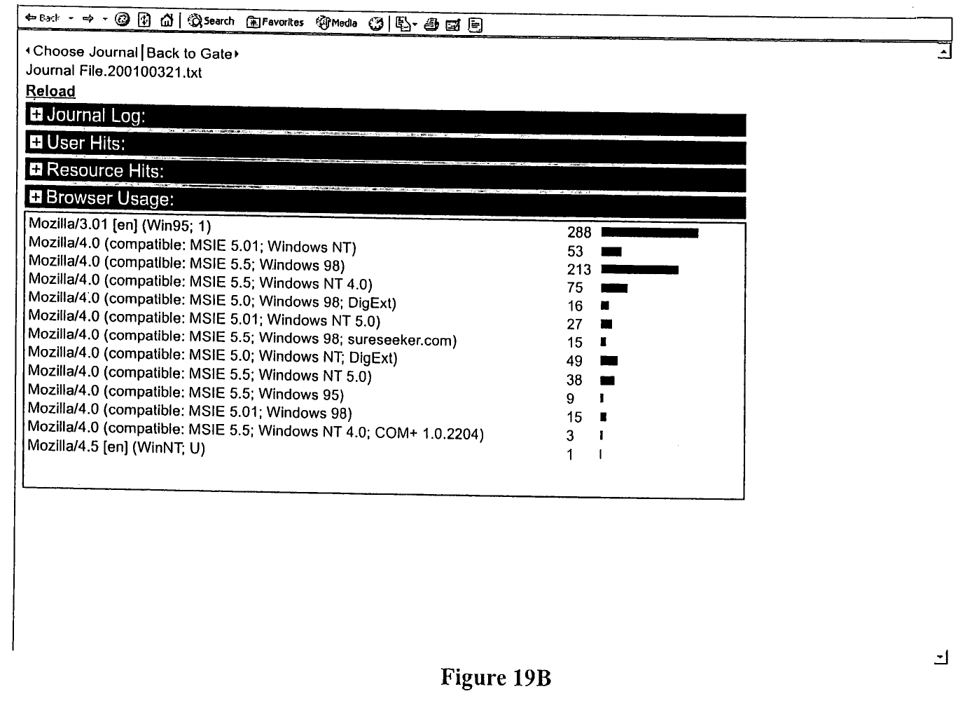

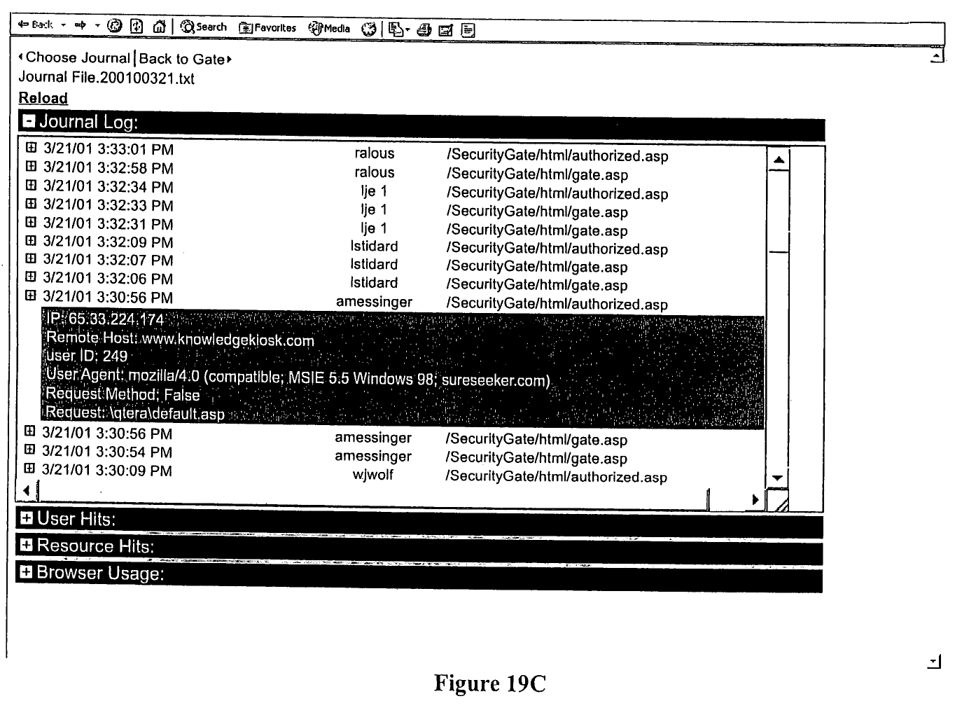

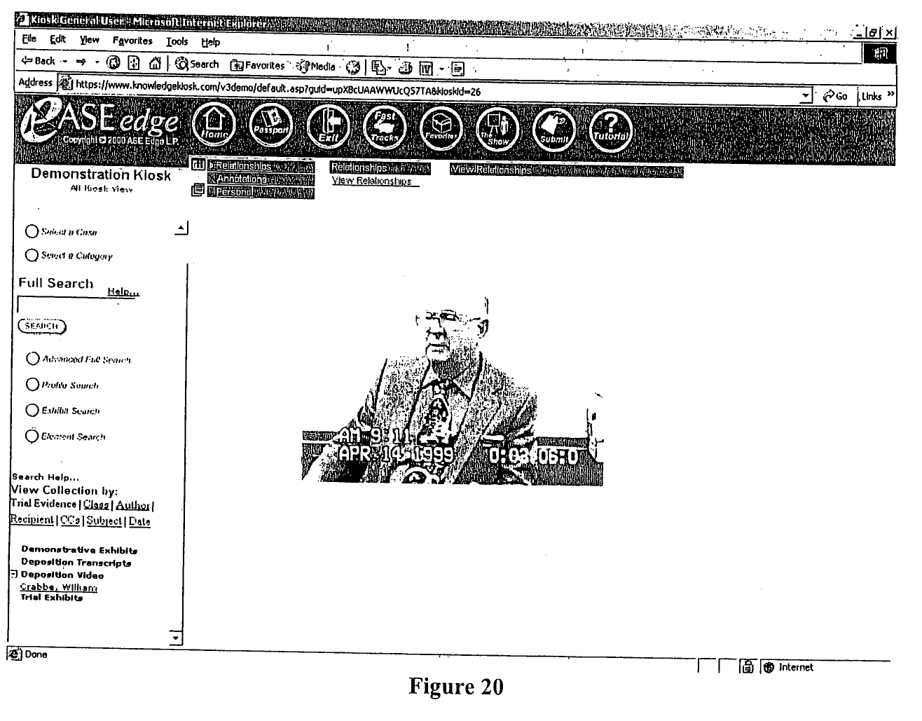

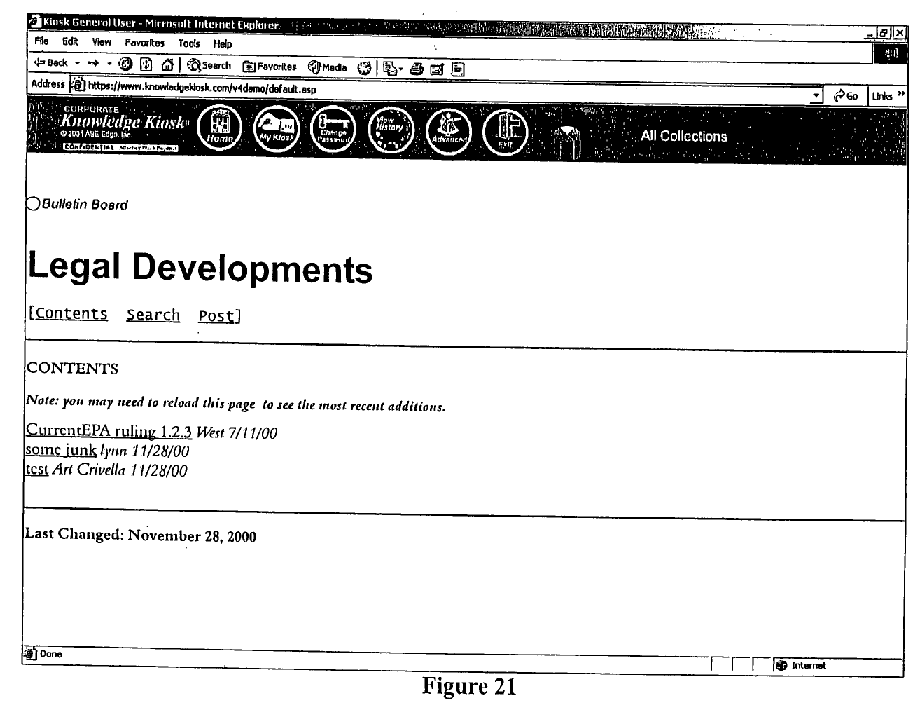

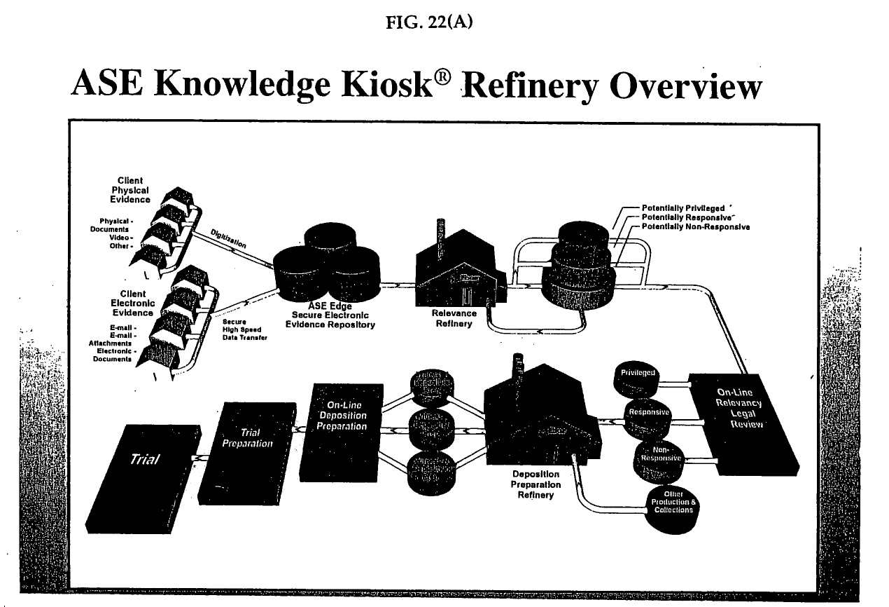

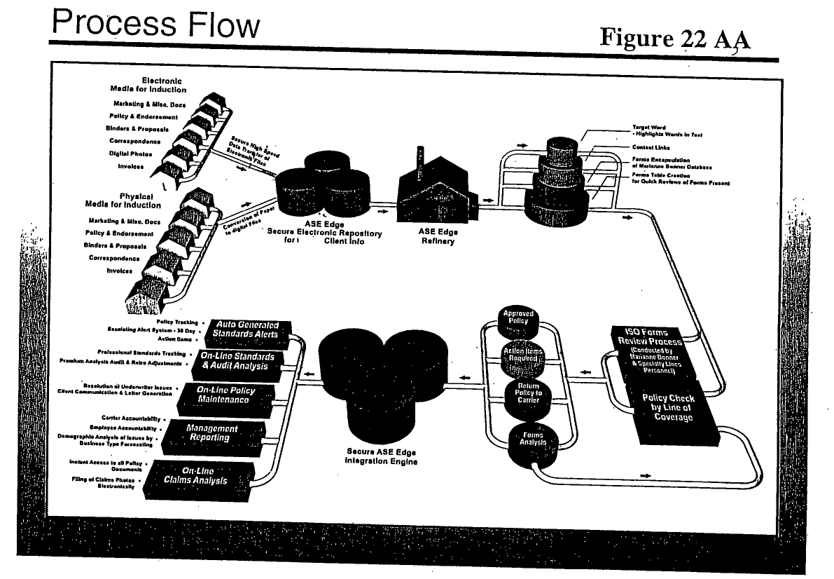

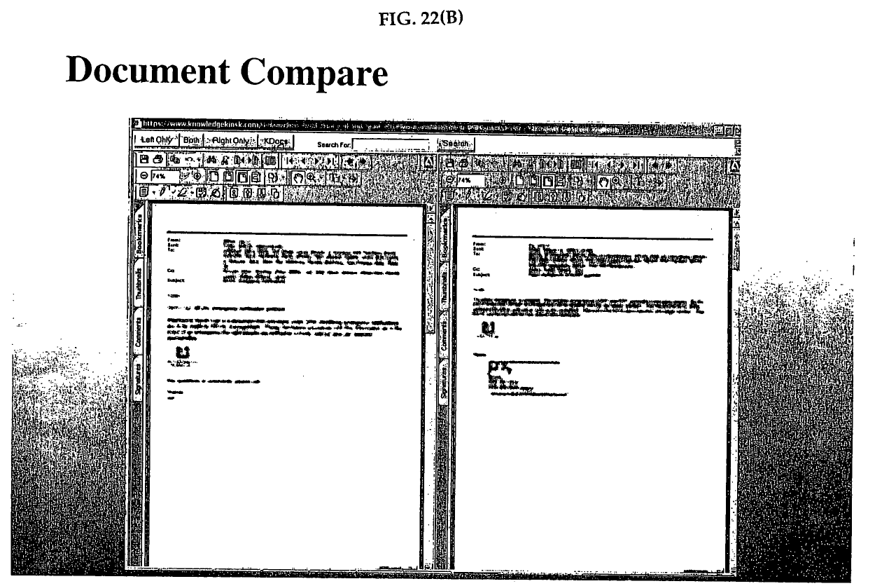

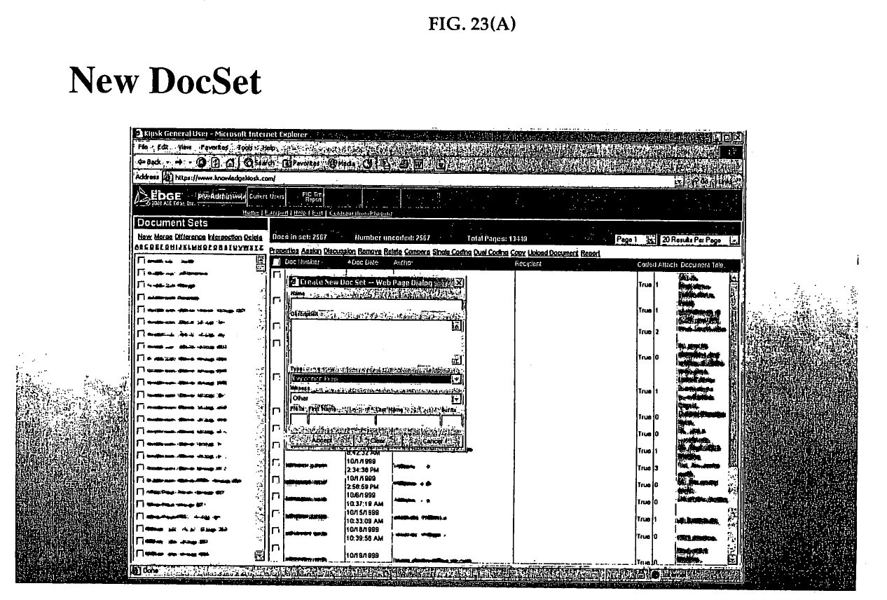

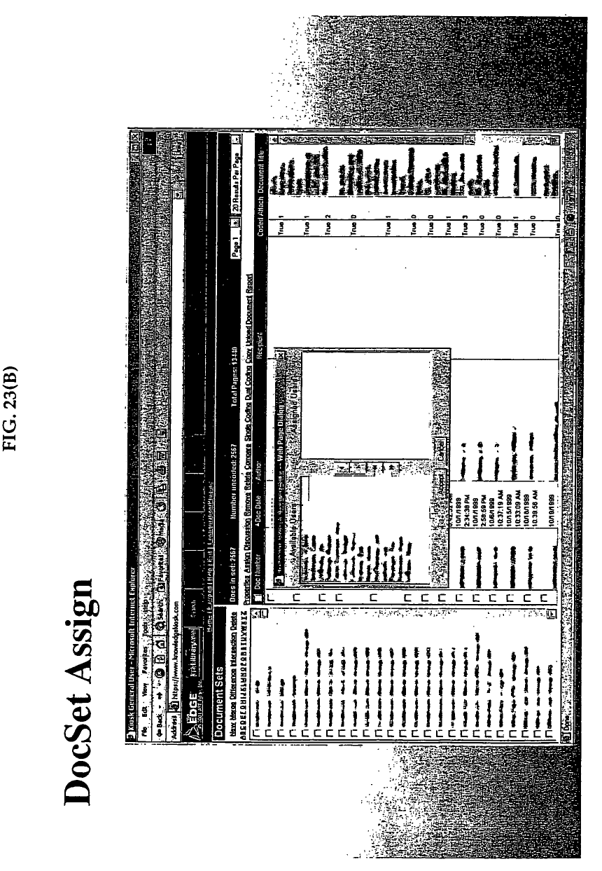

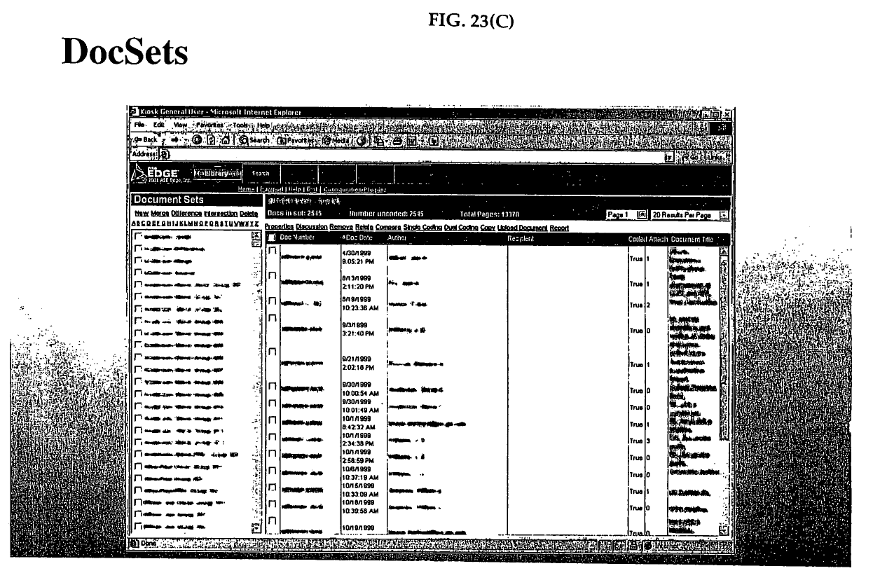

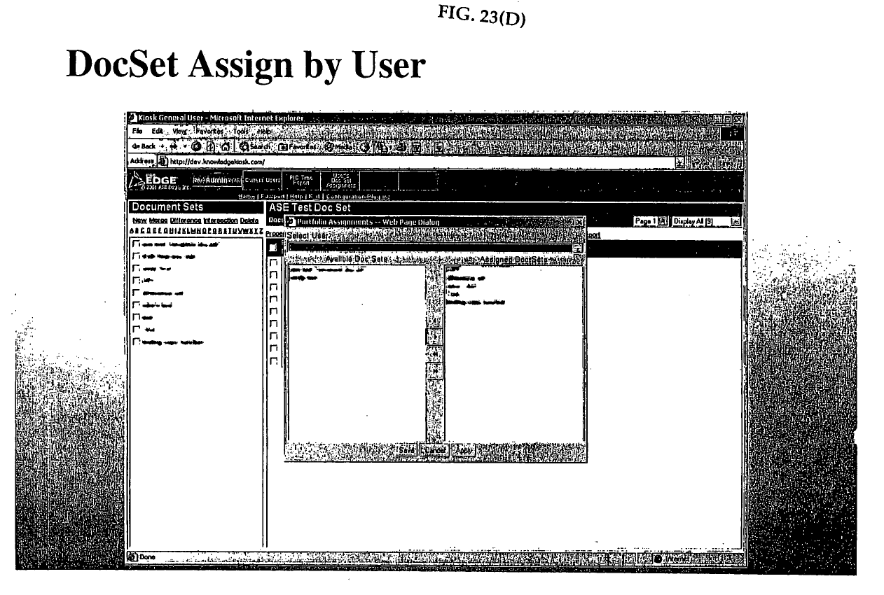

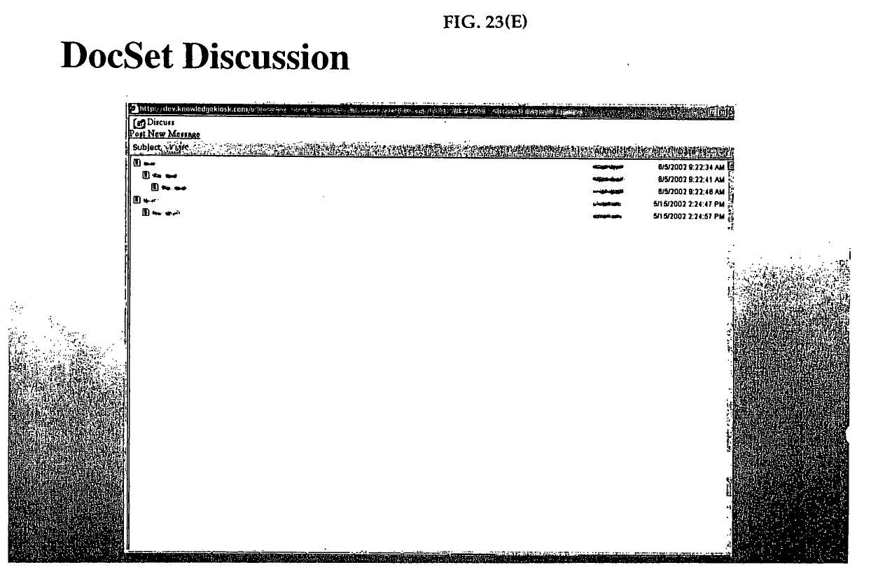

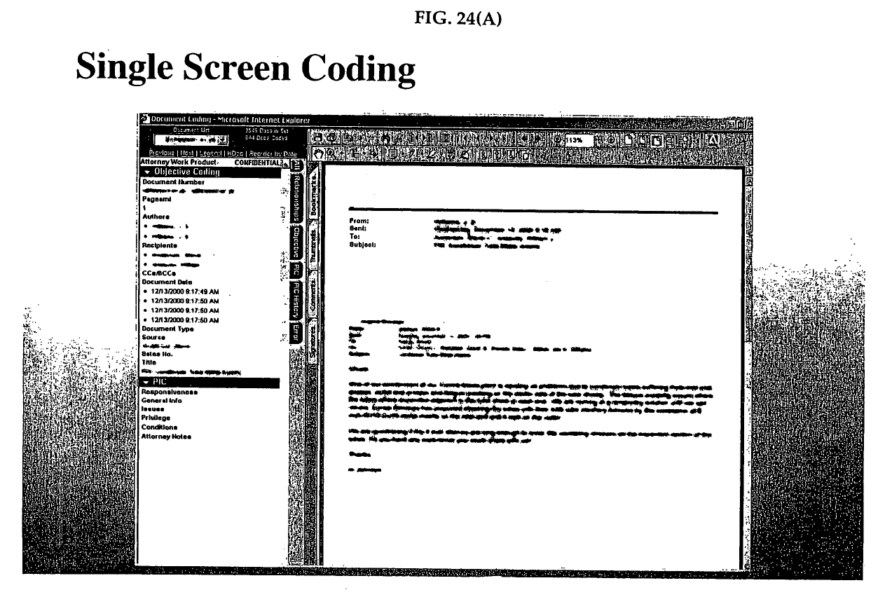

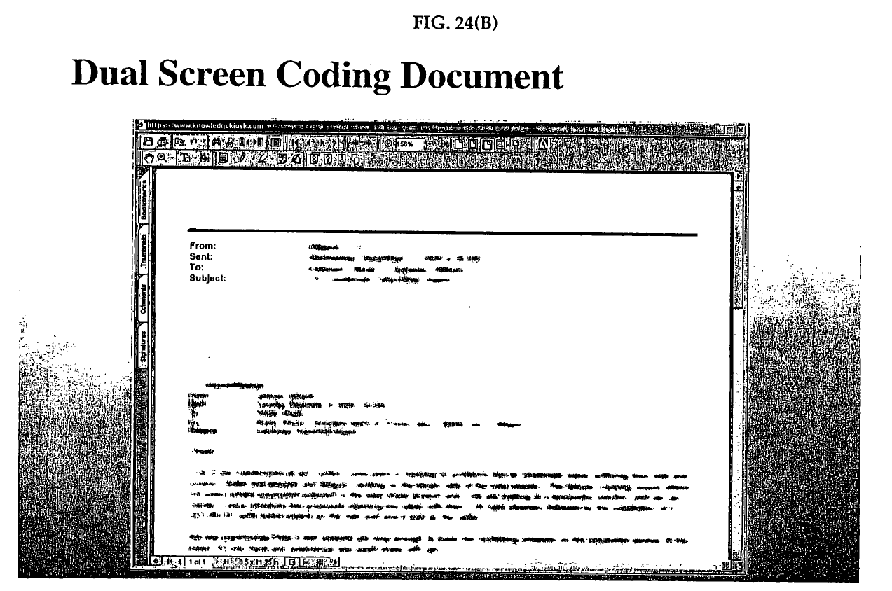

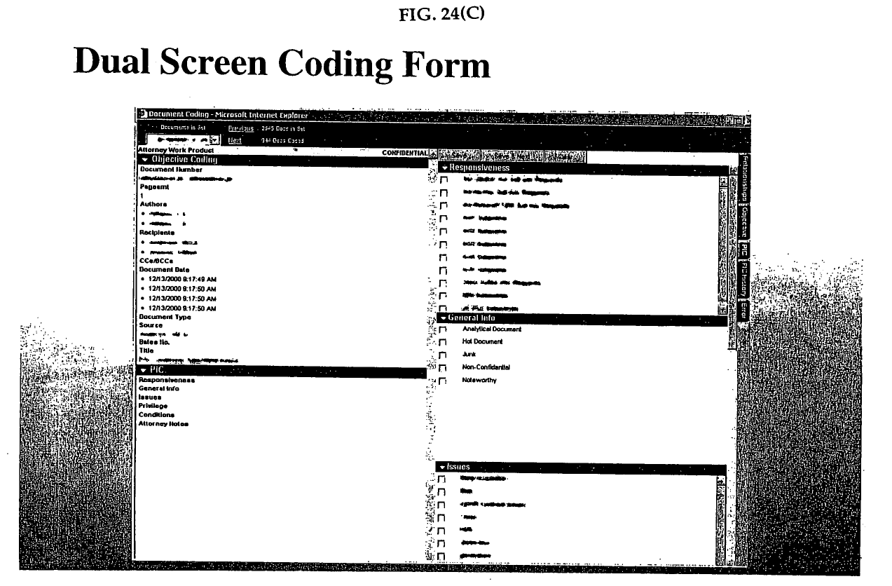

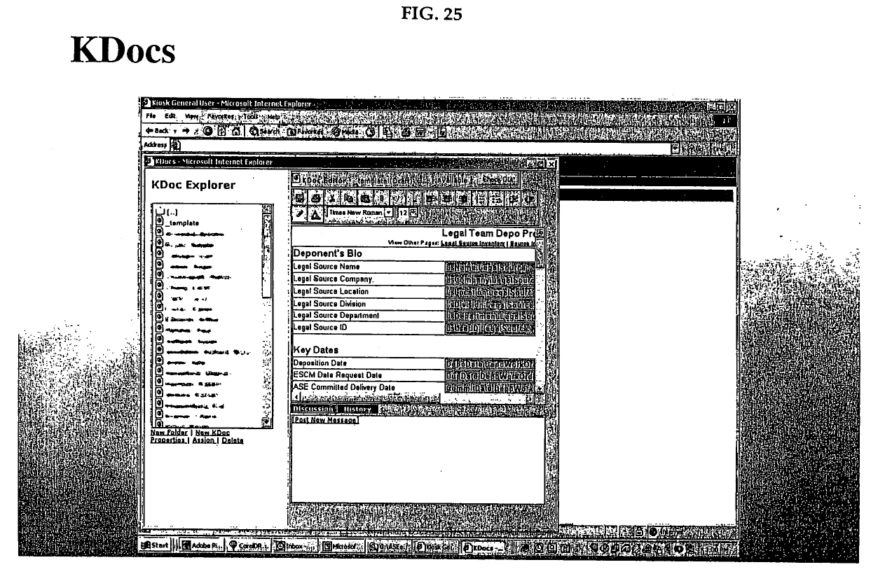

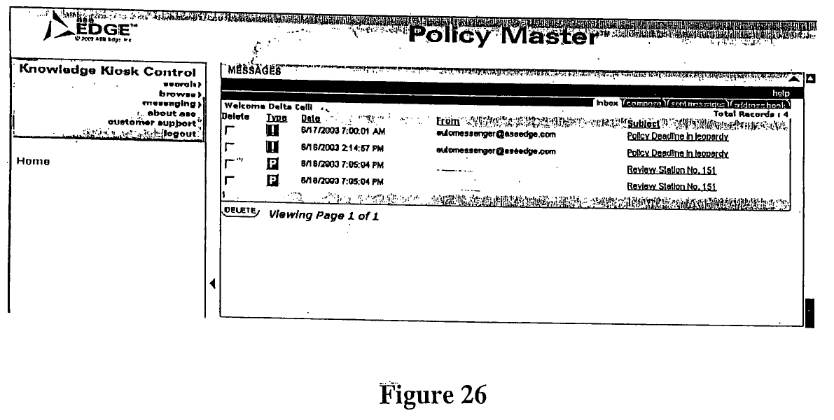

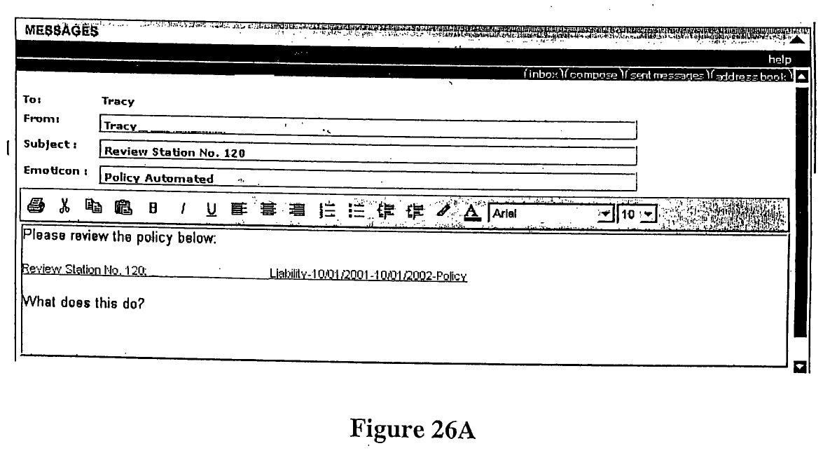

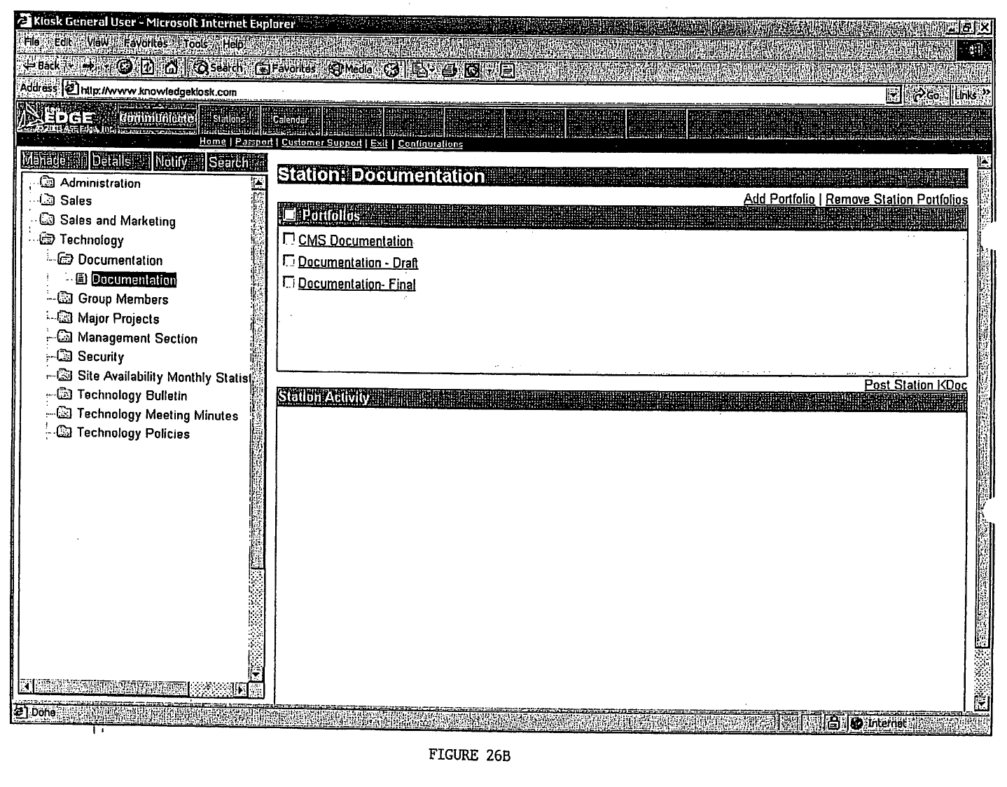

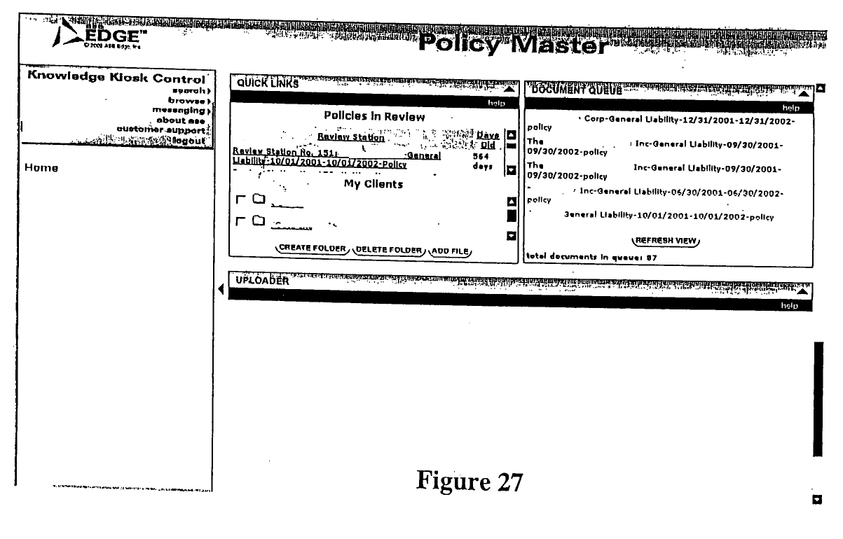

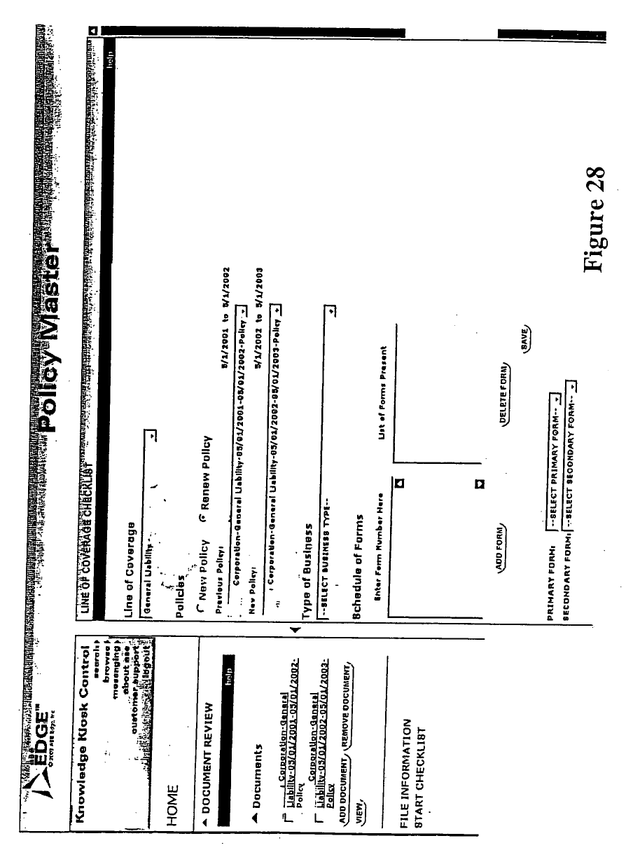

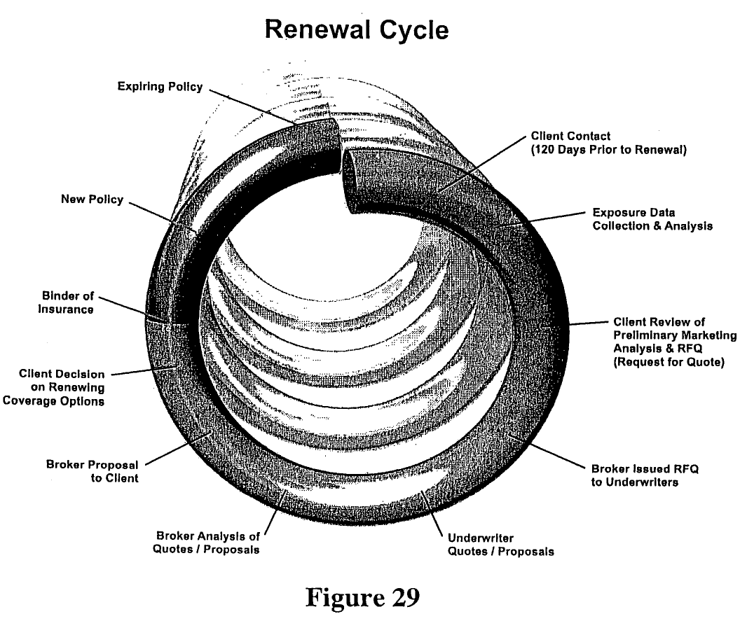

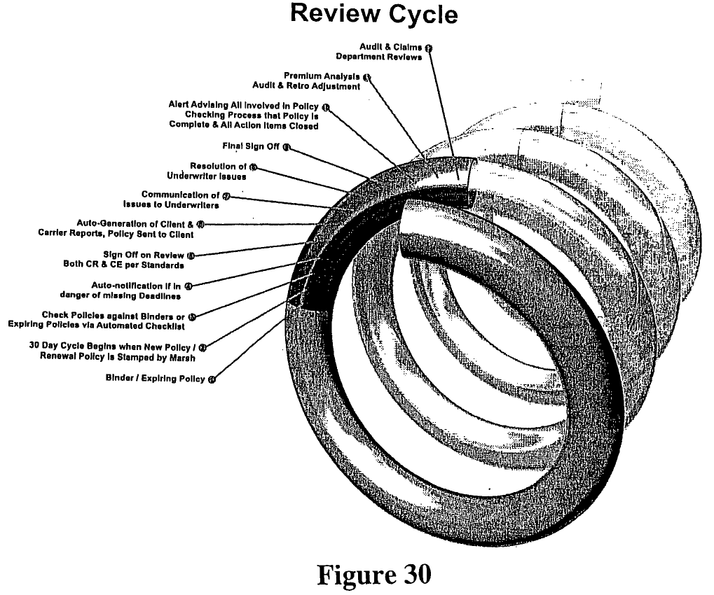

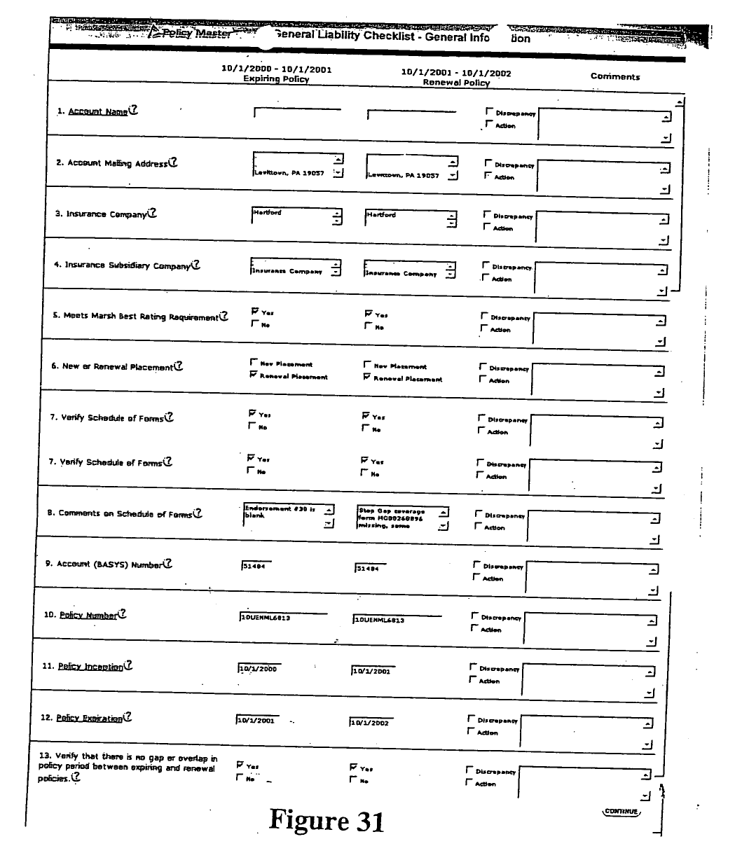

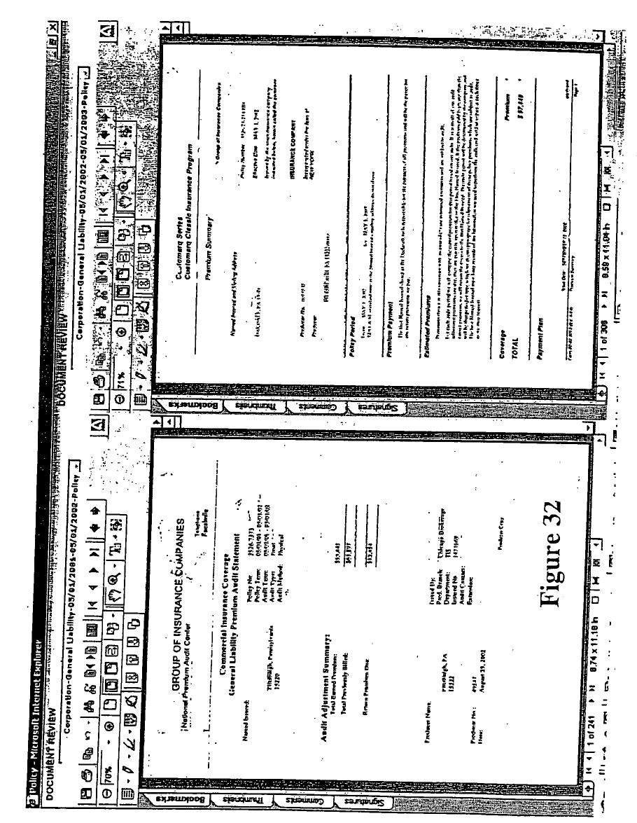

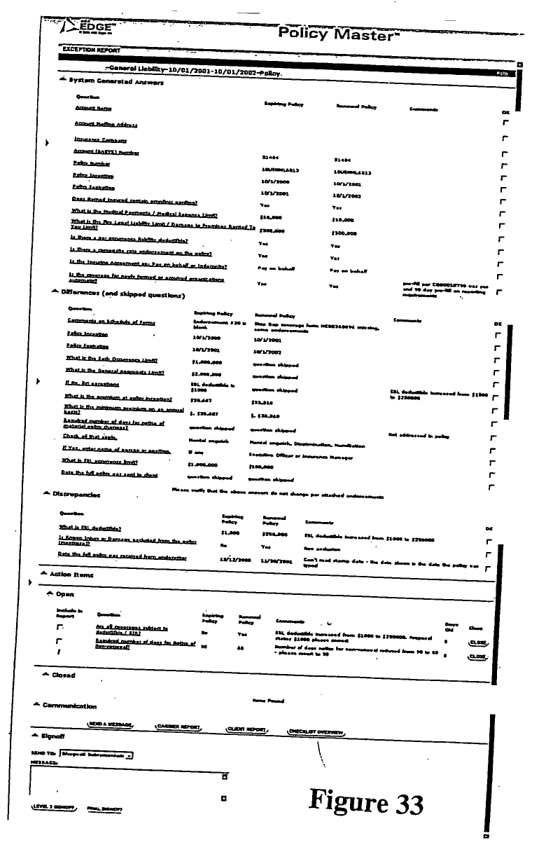

FIG. (20) shows a multimedia rendering of a particular Knowledge Element.

FIG. (21) shows an example of a “Bulletin Board” page for conducting multi-user interactive activities using the Knowledge Kiosk.

FIG. (22A) shows an example of the information intake and relevancy review process for a Knowledge Kiosk used for litigation.

FIG. (22AA) shows an example of the information intake and relevancy review process for a knowledge kiosk used in the insurance renewal and review process.

FIG. (22B) shows an example of a “Document Compare” function that arises from the “Relevance Refinery” concept.

FIGS. (23A) through (23E) show the creation, assignment and use of document sets (or “DocSets”) for various pre-defined groups of users.

FIGS. (24A) through (24C) show an expansion of the document coding concept to allow “Objective Coding” to be combined with user-customized personal (or “PIC”) coding.

FIG. (25) shows the creation of “KDocs” which allow the addition of new content associated with a preexisting Knowledge Element contained in a DocSet.

FIGS. (26) and (26A) show an example of a messaging work station for exchanging priority information and an automated response.

FIG. (26B) shows an example of another communication board for storing data or exchanging information.

FIG. (27) shows an example of a format for displaying documents currently under review.

FIG. (28) shows an example of a checklist of items relevant to a group of documents, such as insurance policies.

FIG. (29) illustrates an example of a renewal cycle in the insurance industry.

FIG. (30) provides examples of functional tools useful for policy review in the insurance industry.

FIG. (31) shows an example of an interactive data entry form relevant to a group of documents, such as inquiries made during the insurance renewal process.

FIG. (32) shows a document compare feature that allows the user to view two documents side-by-side.

FIG. (33) shows an exception report containing system generated responses.

### DESCRIPTION OF THE EMBODIMENTS

The present invention provides an interactive system for managing and manipulating information in the dimension of context processing of information to yield knowledge management. Four of the basic aspects of the system of the present invention are illustrated in FIG. (1) by a two-dimensional depiction of a three-dimensional “Knowledge Pyramid,” 10. The first aspect includes the “Research and Reference Library,” 11, which takes advantage of concepts utilized in library science for uniform categorization of the various types of information used in the knowledge management performed by the system. This characterization approach is designed to eliminate the redundancies normally associated with retrieval of data over the Internet. Another side of the “Knowledge Pyramid,” represents the “Work Process Application,” 12, which uses the science of linguistics in defining information acquisition, exchange and workflow to permit categorization of the Knowledge Elements using the library science concept. Combined, the application of library science and linguistics concepts allows use of the system to manage information in virtually any type of endeavor or business, including the litigation process for which the preferred embodiment of the present invention is adapted, and also including the insurance and medical industries and government, among others. The “Communications” side, 13, utilizes computer technology for presentation of one or a plurality of Knowledge Elements, to enable its representation in ways that enhance human understanding. The fourth side of the “Knowledge Pyramid” is “Work Management,” 14, which combines the multimedia aspect of the invention with the computer software application and database programming necessary to make the system work over the Internet to permit interactive, multidirectional multimedia digital data communications originated from anywhere in the world and made instantaneously available anywhere in the world to or from any number of different locations simultaneously, if desired. When used together, these four sides of the “Knowledge Pyramid” of FIG. (1) represent the combination of features that enable the system of the present invention to enable utilizing data to provide knowledge management. In a preferred embodiment, this knowledge management system operates over the Internet. Examples of data formats include, but are not limited to, adubile, visual, textual, and other multimedia formats. In a further preferred embodiment, this goal is achieved by way of context processing of information, for which an apparatus and method is disclosed herein. The data managed by use of the various aspects of the “Knowledge Pyramid” comprises a Knowledge Kiosk® system which serves as a repository for all of the information needed to accomplish a particular activity or carry out a particular process (such as running a business operation, reviewing insurance policies or engaging in litigation). The Knowledge Kiosk serves as the “back end” database of information that is being managed by the system in connection with the particular activity to which the information relates, and the “front end” website applications used with the system allow the processing of this data for access by remote users over the Internet in the multimedia form(s) in which the information is desired to be used. In a preferred embodiment of the invention, the “front end” of the system is accessible at a domain on the Internet and the “back end” of the system comprises of at least one relational database such as, but not limited to, an Oracle, ACCESS, or other relational database. Further, in yet another embodiment, the “front end” of the system has at least the following web-enabled platform: an HTTP- and XML-enabled web server (such as, but not limited, to an Apache server) plus a web-enabled database driver which provides a programmatically-enabled for communicating relational database information to and from the web server.

In another preferred embodiment of the invention, the “back end” database schema is custom-tailored to the customer's needs. In the present invention, the user populates the database by uploading to the Knowledge Kiosk® system one or a plurality of Knowledge Elements. Each Knowledge Element is assigned a GUID. Relational links are formed among each Knowledge Element by way of a graphic user interface (GUI) with enabling tools that are present on the stepping stone station of the system (discussed in more detail below). For example, a user may upload the following Knowledge Elements to the Knowledge Kiosk system: “A” and “B.” The user can associate these two Knowledge Elements by using the GUI of the stepping stone station and the enabling tool to link “A” and “B” in a data set. The database is then modified by the system such that the GUID associated with “A” and the GUID associated with “B” are associated with one another. This association between “A” and “B” is stored in the database under yet another unique GUID which references the GUIDs for “A” and “B.” In general, “A” and “B” can relate to one another with respect to being different Knowledge Elements of a “slice” of a pie, a “layer” of a pie, or a “crumb” of a pie. “Slice” relates to a particular category or subcategory of a plurality of Knowledge Elements. A “layer” relates to one or a plurality of common characteristics which are shared by categories and/or subcategories of Knowledge Elements. The depth of the “layer” relationship (i.e., category and/or subcategory) depends upon the “depth” at which the “layer” of the pie is cut (e.g., top half (category), bottom half (subcategory), entire depth (category and subcategory)). A “crumb” relates to Knowledge Elements which are not related by category and/or subcategory; rather, the “crumb” can be select Knowledge Element which is related to yet another select Knowledge Element (other than by category, subcategory, and common characteristics thereof).

By way of example, in one instance, “A” and “B” are Knowledge Elements which represent specific types of fruit, “A” being an orange and “B” being an apple. As a result, they are related with respect to the general category of fruit. “A” and “B” here are related by “slice.” In one embodiment, the user creates the “slice” classification of “A” and “B” by designating that both of these Knowledge Elements belong to the category of “fruit” such that these Elements can be retrieved subsequently. A GUID is used to define this classification. In another instance, “A” is a golden delicious apple and “B” is a red delicious apple. Here, “A” and “B” are related by “layer” in that both the golden delicious apple and the red delicious apple share the common characteristic of being part of the Delicious breed of apple. In one embodiment, the user creates the “layer” classification of “A” and “B” by designating that both of these Knowledge Elements belong to the category of “Delicious Breed of Apples.” A GUID is used to define this classification. And, as yet another example, “A” and “B” are Knowledge Elements which represent disjointed items of Knowledge Elements. In one instance, “A” is a German shepherd dog. In another instance, “B” is a golden retriever dog. No other classifications exist vis-à-vis these two Knowledge Elements (i.e., no “slice” and no “layer” classifications are existing). However, the user can create a “crumb” relationship between the two by associating “A” with “B” such that this “crumb” relationship is assigned a unique GUID. In yet another related embodiment, the user can define the “crumb” relationship, for example, as “My Pets.” In this vein, these Knowledge Element classifications can be retrieved at a subsequent time by the user.

In all of the foregoing embodiments and examples, knowledge is procured by way of adding a contextual dimension to customer information—specifically, by classifying the Knowledge Elements with specific classifications of slice, layer, and crumb. At minimum, the data can be classified by a “category” slice or crumb. The greater the number of ways in which the data is classified, the more context is built (and hence the contextual dimensionality of raw information increases such that a “knowledge polygon” is built). At maximum, the data can be classified by at least one or a plurality of a “category” slice and/or a “subcategory” slice, a layer, and a crumb. Further, the greater number of relationships by which a plurality of Knowledge Elements are related, the contextual dimensionality also increases with respect to the raw information in question—in this vein, the “contextual web” is built through these interrelationships of information (various angles, shapes, sizes of “contextual web”).

As another dimension and to add further context to the Knowledge Elements which the user has input and/or induced into the Knowledge Kiosk® system, in addition to and in cooperation with the “slice,” “layer,” and “crumb” aspects, the presently invented system can accept metadata to add an additional dimension of context to the customer information. To this end, the following terms are used for each dimension of classification (as an extension of the above described classifications): 1) subslice, 2) sublayer, and 3) subcrumb. The “sub” prefix is used because metadata is defined as information about information and therefore adds context (i.e., additional information) about what a certain item of information is about. With respect to these subdata elements, which are unique Knowledge Elements that are also associated with the Knowledge Kiosk® system and have their own unique GUIDs, the “knowledge polygon” is built further with the use of metadata.

By way of example (and incorporating by reference the above specific examples with respect to slice, layer, and crumb), an example of subslice data of “A” is the date on which an orange was received by the customer. Further, an example of sublayer data with respect to “A” and “B” is the source from which all of the fruit was received. Finally, an example of subcrumb data with respect to “A” and “B” is the name of the owner of the pets, “Bill.” In a further embodiment, a plurality of metadata items may be associated with one or a plurality of customer information to yield greater contextual depth to the customer information stored on the Knowledge Kiosk® system. Thus, the “knowledge polygon” is further the built with the greater number of metadata points that are associated with a particular Knowledge Element.

In sum, the user can create the web of context of information and help build the “knowledge polygon.” Sufficient database modifications are programmatically and thereby automatically performed when the user inputs and/or induces Knowledge Elements in the Knowledge Kiosk and/or makes or otherwise modifies a Knowledge Element classification. In this vein, context relationships are created and the “shape” of the knowledge is modified depending upon the relationships which the user creates with the information (i.e., the “universe” of Knowledge Elements which are presently stored on the Knowledge Kiosk system). Technology conventional to website design and use is utilized to establish the website and enable it with functionality for receiving, accessing, processing, storing, retrieving, manipulating, transmitting and utilizing the data made available to, from and on the website. Website functionalities are implemented using standard website design tools and operating software such as for example Microsoft® .NET™, Microsoft® VisualBasic®, Microsoft® Visual C++®, Microsoft® InterDev®, Microsoft® FrontPage®, Microsoft XML®, Adobe® SDK, DTSearch® SDK, Macromedia® Flash® 5, Autodesk® 3D StudioMax programs.

The system website is remotely accessed by a user from anywhere in the world with a user name and a password using commercially available hardware and having Internet access through an internet service provider or a computer network web server. The hardware can include a wired or wireless personal or handheld computer configured with a standard web browser such as Netscape® Navigator® or Microsoft® Internet Explorer® (utilizing standard plug-ins such as Adobe® Acrobat Reader® for pictorial and graphics presentations and RealPlayer® (produced by RealNetworks®, Inc.) for multimedia presentations). A user login page is provided to capture the user name and password, an example of which is shown in FIG. (2). Optionally, a second level authentication, such as random number verification can be implemented to provide different levels of access and capabilities specific to the user. Upon user authentication, the system software is accessed over the website to determine the user computer Internet Protocol (IP) address (which can be the user's normal local address or a remote address) to and from which further communications with the system will be directed. The system can also capture the time and date of the last communication made to or from the user and the history of that particular user's prior usage. Upon authentication, a secure sockets link (or SSL data communications link denoted by the designation “HTTPS”) is set up with the user's IP address using standard one hundred and twenty-eight (128) bit data communications encryption (although other standard encryption methods could be used).

The Knowledge Elements, which are stored on one or a plurality of Kiosk repository stations, are individually or collectively accessed by way of a user defined tool. For example, a user defined tool may search all of the Knowledge Elements that are stored in one or a plurality of repository stations. In this current implementation of the context management system, a search tool is programmatically configured to search the Knowledge Elements which are stored in one or a plurality of repository stations. In one embodiment, the search tool searches all of the repository stations that exist on the Kiosk system. In another embodiment, the search tool searches one repository station that exists on the Kiosk system. In yet another embodiment, the search tool searches a user defined selection of a plurality of repository stations that exist on the Kiosk system. In yet another related embodiment, the search tool searches a user defined single repository station that exists on the Kiosk system, whereby a plurality of repository stations are linked to the Kiosk system by way of the stepping stone station.

In a further embodiment, Kiosk Stations may be related to one another. (A Knowledge Kiosk system can comprise of one or a plurality of Kiosk stations.) The database records these Kiosk Station relationships. The data residing in each of the related Kiosk Stations can be identified and processed as needed by the system or as requested by the user by virtue of the GUID reference to the Knowledge Element. Moreover, data created on any of the related Kiosk Stations is referenced by a GUID which is associated with the Knowledge Element. The data may be customer data (i.e., input or inducted into the system) or metadata (i.e., information about the customer data, such as the date and time on which the Knowledge Element was input or inducted into the system).

In a related embodiment, the Kiosk Stations may be related to one another by way of a stepping stone station (discussed further below). The stepping stone station can cohesively tie in a general workstation (for inputting, inducting, and/or searching Knowledge Elements, among other functions) and a repository station (for storing Knowledge Elements) such that these stations can communicate information with one another. The links created by way of the stepping stone station are stored in the database. In another embodiment, there may be one or a plurality of each station type (i.e., stepping stone, general workstation, and repository station).

By way of example of stepping stone linkages, a plurality of general workstations provides one or a plurality of users the ability to input and/or induct Knowledge Elements into the Kiosk system and utilize the tools in each respective general workstation. As another example, a plurality of repository stations provides the user with the ability to access Knowledge Elements which are stored on all of the repository stations. Further, linking a plurality of stepping stone stations provides the user with a superhierarchy of Kiosk stations—because each stepping stone station establishes a Kiosk system, linking a plurality yields a plurality of Kiosk station networks.

As a working example, in FIG. (5) the database structure shown in the “pie chart” 20 is a representation of a typical litigation process in which information is gathered through discovery and presented for trial. A first section 21 of the “pie chart” of FIG. (5) shows all of the materials in the case exchanged between the parties in response to discovery orders. A second section 22 of the “pie chart” of FIG. (5) shows all of the court papers that have been filed and/or exchanged between the parties in the case. Another section 23 of the “pie chart” of FIG. (5) shows all of the materials that are produced by the attorneys or exchanged between the attorneys defined as attorney work product. Another section 24 of the “pie chart” of FIG. (5) shows all of the materials that have been accepted for use at trial, such as deposition transcripts and demonstrative and trial exhibits.

In another example, the database schema library structure is designed for use in the insurance industry. For example, the library contains all documents related to the insurance policy review and renewal policy. Such documents include policies and endorsements, binders and proposals, correspondence, digital photos, invoices, marketing materials, etc. The kiosk captures all of this information, which traditionally would have been scanned and loaded into the system, and scans the information through a digital scanning process. The format of the information to be captured varies including (but not limited to) document demographics and file information. Each Knowledge Element is input or inducted into the system for classification. Further, metadata about the input or inducted information may also be input or inducted into the system for classification. One example of metadata is the date and time on which a certain Knowledge Element was input or inducted into the system. After scanning, the information will be manipulated by the client to produce searchable and reportable data. In one embodiment, each Knowledge Element is assigned a GUID. Each Knowledge Element can then be identified and/or processed as required by the system and/or as requested by the user, as needed. This system, combined with the database schema library structure, provides users in the insurance industry with the ability to readily review all pertinent documents in the policy renewal cycle to reduce their error and omission costs, among other features and benefits.

Sections of the database schema “library” can be selected for various levels of restricted access such as attorney-client privileged information. For example, one level can permit access of certain items only to outside counsel of the opposing party and not to in-house counsel directly employed by the opposing party, while a second less restrictive level can permit access to all attorneys including in-house counsel but not other employees of the opposing party, while a third even less restrictive level can permit access by all parties to the litigation but not the public, while a final nonrestricted level can permit public access to the information accessible under that security level such as public documents that are filed with the court. In the insurance context, access can be limited according to the individual user's capabilities or purposes for using the system. For example, one level of access can permit access to a data entry level employee, a more restrictive second level can permit access to an employee responsible for completing a checklist or addressing action items generated during a policy review, and a third even more restrictive level can permit access only to managerial users, who may be accountable for the results. The level of access associated with a user dictates not only which documents will be viewable to the user but also what context they can be viewed in and whether the user will have the ability to add, change or modify information. Those individuals who are not permitted a certain level of access will not even be able to “view” the information in the restricted level so that it appears to such user that the information does not exist at all. In a further embodiment, a user can define sets of information to be searched by utilizing certain select portions of the “pie.” This can comprise of a “slice,” “layer,” and/or “crumb.” As defined above, a “slice” relates to categories or subcategories of information, a “layer” relates to commonly related sets of information in a category or subcategory. Further, a “crumb” relates to sets of information that do not have commonly related sets of information in a category or subcategory. The “crumb” feature allows users to define uniquely organized information and provides for flexibility when organizing data such that a search would subsequently retrieve the uniquely organized information. These powerful data organization schemas of Knowledge Elements in the database are facilitated by way of a GUID. With the GUID, the Knowledge Element is globally tagged such that it can be globally referenced in the database, allowing robust queries and these Knowledge Elements can be accessed by any component of the Knowledge Kiosk® system. The flexibility of the computer-implemented and enabled method and apparatus for data organization is only limited by the user's criteria and imagination. A slice, layer, or crumb may be collated into a data set; further, any combination of a plurality of these “pie” items may be combined to form a robust collection of Knowledge Elements.

Further, the data organization and retrieval of the organized data set may be further enhanced by way of the user definition of the Knowledge Element. In one embodiment, a Knowledge Element may comprise of a single document or other file. In another embodiment, further Knowledge Elements may be defined based upon a selected portion of the single document or other file. Once the user defines what the Knowledge Element is, this is tracked by the database by way of a GUID. Further, as described above, the user can form a data set which includes this newly defined Knowledge Element.

In another example, the “pie” or category is established to include all insurance policies having a certain commonality such as being based on a particular Insurance Services Office (ISO) form issued in a particular year. The system recognizes this layer of the pie or category as a relationship shared by the policies.

FIG. (6) shows an example database schema for implementing the present invention in a multi-tier litigation support context entitled “Overall Organization—Multi-Tier Litigation Knowledge Kiosk”. The database schema in FIG. (6) is essentially a “layered cake” extension of the “pie chart” schema shown in FIG. (5) to accommodate multi-party, multi-district litigation where more parties than a single plaintiff and defendant are involved and/or the litigation is being conducted in more than one court and/or more than one lawsuit is involved. The same principles apply as described above with respect to FIG. (5) in terms of “cutting” the cake “vertically” to access all documents of a given category no matter what case they relate to; “cutting” the cake “horizontally” to access all documents from a given case no matter what category they relate to; or “cutting” the cake both “vertically” and “horizontally” to access only those documents included in a particular category that relate to a given case and/or also have a certain characteristic in common. Further, the same principles apply also with respect to the “crumb” of the cake with respect to accessing the documents that are not related in the “vertical” or “horizontal” sense, when the user defines such a unique method of collating the documents together. In this litigation context, documents can be accessed even though they are not in the same category or relate to the same case—but, rather, in some other unique relationship which is user-defined. Similarly, the layered cake scheme applies with insurance data stored in a system kiosk. Vertical relationships are established among policies, for example, a relationship exists between policies issued in different years or in different regions of the country, but the policies may be based on the same underlying form.

In a further embodiment, the Knowledge Elements which are accessed can be items which are data other than documents. For example, the accessible items may comprise of certain select portions of the documents, as defined by the user. All of these Knowledge Elements are uniquely defined by a GUID in the database for subsequent access of that data.

In the same way that the system applies library science and linguistics concepts to data stored in the system to classify its Knowledge Elements [information??] and attributes (i.e., metadata), it also classifies altered data. Data may be altered by system users after its initial storage on the system. Users may, for example, revise the data, incorporate another document with it, include handwritten notes. Tools are provided to allow a user to scrub or remove handwritten notes or other markings from documents. Each new version of the data can be separately stored, classified and managed. Each new version of the data is assigned a unique GUID for global reference by the Kiosk system. (As used herein, “Kiosk” is synonymous with “Kiosk system.”

By way of an example, the same item of information may have been altered during the litigation process, requiring its inclusion or storage twice in the database in two different categories or subcategories even though it represents the same item. For example, a single document that has been presented by a party in discovery will require inclusion in the discovery document category, and will also require inclusion as a separate and distinct item in the deposition exhibit category if used in a deposition, and will require further inclusion as yet another separate and distinct item in a third category of altered deposition exhibits if interlineated with handwritten notes during the deposition. On the other hand, if the item of information has been referred to in different ways but has not been physically altered, the database can store it only once and subsequently refer to it by all of the different identifications which have been used for that item. For example with respect to the “cake layer” database of FIG. (6), the same document produced or deposition taken in two different cases of a multi-district litigation will require inclusion or storage only once in the database if it is has not been altered in either of the two cases, but a reference to each case will be required in identification of the document or deposition transcript so that it can be retrieved with respect to either case.

FIGS. (22A and 22(AA)) show examples of the information intake and relevancy review process for a Knowledge Kiosk in the litigation and insurance industries, however, the range of types or forms of information appropriate for the system is limitless. The information may constitute physical evidence, such as videos, photos, objects, or electronic files, such as emails, Powerpoint presentations or maps. The information is first digitized (if not already in electronic form) and then inducted into a secure electronic repository. The information is included in the Knowledge Kiosk of interest, such as a particular litigation matter or insurance broker review process. Automated agents then process the Knowledge Element (i.e., each piece of information) in a “Relevance Refinery” which automatically highlights information of interest in a particular Knowledge Element based upon criteria pre-defined by the user. The Knowledge Element then undergoes a manual “On-Line Relevancy Review” to refine the results produced by the Relevance Refinery, resulting in selection of only those Knowledge Elements fitting the user-defined criteria. These Knowledge Elements are then used in further activities undertaken by the user (in this example, deposition preparation or trial preparation). FIG. (22B) shows an example of a “Document Compare” function that arises from the “Relevance Refinery” concept. “Document Compare” analyzes selected text from different documents (or different versions of the same document) to highlight the differences between them or to highlight selected text. This allows quick and easy review of changes to document language to be made by the user.

System Use

In an example of an embodiment, the system provides a web page to serve as the launching point for accessing the various Knowledge Kiosks containing the data being managed by the system. The launching page, for example, is referred to as the “Passport” page and is illustrated at FIG. (3) for use in a litigation setting. As shown in FIG. (3), the “Passport” page lists the names (i.e., “V3 Sample Litigation” and “V4 Litigation”) of the particular Knowledge Kiosks to which the user has access (by recognition of usemame, password and security authentication). A particular Knowledge Kiosk can be selected in a standard manner such as by using a mouse to “click on” the portion of the screen containing the desired Knowledge Kiosk designation. The “Passport” page adapts to reflect the types of data contained and managed by the kiosk, permitting access to users based upon client specifications. The “Passport” page can also be accessed from other pages of the Kiosk. FIG. (3A) shows a calendar capabilities page built into the Kiosk in a preferred embodiment of the system. It shows a link to the “Passport” page and other areas of the Kiosk.

FIG. (3B) illustrates another view of the calendar integrated into the kiosk. The calendar is designed to keep track of deadlines or appointments input directly by a user or determined based upon automated review of data inducted into the system. Each deadline or appointment entry is assigned a unique GUID in the database so that the Kiosk can refer to that entry subsequently whenever it needs accessed, modified, or the like. Data containing pertinent dates may be quickly referenced and dates coordinated by using the capabilities displayed in FIG. (3B), for example.

FIG. (4) shows an example of the “Fast Tracks” page for the Knowledge Kiosk selected from the “Passport” page, which is preferably automatically loaded once the Knowledge Kiosk is selected. The “Fast Tracks” page preferably provides access to the most commonly-used and/or newest information in that particular Knowledge Kiosk, such that the most essential information included in the Knowledge Kiosk is made universally available to all users of the system with “one click” no matter what their experience or skill level in using the system. The “Fast Tracks” page serves as the launching point for accessing (through standard drop-down menus and/or graphic “click on” icons) the executable software code files that lead to use of the different features of the system which allow retrieval of data from the selected Knowledge Kiosk and manipulation of that data for presentation in the various form(s) in which the data is desired to be used. Selection of the various options on the “Fast Tracks” page leads to different standing queries for accessing the Knowledge Kiosk database to provide the type(s) of information sought under that option. The “All Kiosk View” portion of the “Fast Tracks” page will lead to a view of the entire “library” of files containing the information in the selected Knowledge Kiosk. Selection of the “Home” or the “Fast Tracks” button leads back to the “Fast Tracks” page as shown for example in FIG. (4). Selection of the “Passport” button leads back to the “Passport” page as shown for example in FIG. (3). Selection of the “Favorites” button leads to a page as shown for example in FIG. (15) where various user-defined folders can be set up to permit organization of the information most commonly used by that particular user. Selection of the “The Show” button provides access to an Internet broadcast of selected materials located in the Knowledge Kiosk as shown for example in FIG. (16). Selection of the “Submit” button leads to submission of an item of information to the Knowledge Kiosk as shown for example in FIG. (7). Selection of the “New Kiosk Elements” leads to a listing of all files created in the Knowledge Kiosk database in the prior week or in the current week or on that particular date, as provided by the menu item selections, while selection “New Court Papers” and “New Correspondence” buttons provides a similar listing for those categories of information. Selection of the “Case Coordination” button provides all documents shared between cooperating users of the system (such as codefendants in a lawsuit) while selection of the “Executive Summary Reports” button provides an executive summary of the detailed information in the data covered by the summary categories. Selection of one of the “Search” options leads to a search of the Knowledge Kiosk database of the type selected and described for example with reference to FIGS. (8) through (14) below, while selection of the “Exit” button leads to an exit from the system. Depending on the particular user or the particular application or use for the Knowledge Kiosk, the combination of features available on the “Fast Tracks” page may change.

Another view of the library of files and functionalities is shown, for example, in FIG. (3C). FIG. (3C) is an example of a page revealing predefined categories of information pertaining to a particular element. In this instance, it indicates case information and file status information related to a selected matter. Users can select the information from a list of topics, such as “general” or “cases.” “Cases” can include subtopics. Subtopics may further delineate that topic by its attributes or elements, including for example “by plaintiff,” “by state” or “by case name,” such as is shown along the left column. The “status” for a selected matter is revealed. In this example, it includes dates related to filing, transfer, dismissal, removal, remand, etc. which are shown along the right side of the page. As additional data is inducted into the system, the status is updated as appropriate.

As shown for example in FIGS. (15A) through (15E), the “Favorites” page allows various user-defined folders to be set up to permit organization of the information most commonly used by that particular user. As shown in FIGS. (15A) and (15B) the basic folders predefined for every user are the “Root” folder, the “Forward” folder and the “Group” folder. The “Root” folder is the base folder into which all items appearing on the “Favorites” page are initially placed in the absence of any other defined folders. The “Forward” folder allows the information it contains to be forwarded to any other user authorized to have access to the highest security level information contained within the folder, in accordance with the security level classification set up for that type of information as described with reference to FIGS. (5) and (6) above. The “Group” folder provides segregation of the information it contains to permit automatic access by all users within the defined group once the information is placed within the folder by any user in that group. The remaining folders can be custom designed by the user to hold the types of information the user desires to place within those folders.

FIGS. (23A) through (23E) show the creation, assignment and use of document sets (or “DocSets” for various pre-defined groups of users. Essentially, DocSets expand the “Group” folder concept to allow dividing an entire Knowledge Kiosk into groups (or DocSets) of Knowledge Elements that are to be shared among selected users. Each DocSet is associated with a plurality of GUIDs which are, in turn, correlated with each Knowledge Element which comprises the document set. Further, each DocSet can be assigned to a different group of users with different access rights for each user. In another embodiment, each DocSet can be assigned to a different group of users with the same access rights for each user. Furthermore, “Discussion Forums” can be created for allowing online collaboration amongst the users assigned to a particular DocSet. Each Knowledge Element assigned to a DocSet can be independently accessed by an assigned user directly from that DocSet without an additional search. The system retrieves Knowledge Element data based upon the GUID reference as contained in the database. Furthermore, different DocSets can be merged together to contain all Knowledge Elements in each merged DocSet or combined into a new DocSet containing all Knowledge Elements in common between the combined DocSets. FIG. (25) shows the creation of “KDocs” which allow the addition of new content associated with a preexisting Knowledge Element contained in a DocSet. Each KDoc is also assigned a unique GUID in the database. The KDoc allows content to be included such as notes containing comments on a Knowledge Element or instructions on its disposition. The content can be added by “cutting and pasting” information from any other Knowledge Element or from an external source. The database updates the content information associated with the newly updated Kdoc. Access rights to KDocs are defined in the same manner as described above for DocSets and a history of access to the KDoc is also maintained.

FIG. (16) shows an example of a user-defined “Presentation Queue” folder on the “Favorites” page which allows the user's retrieval of a Knowledge Element from a Knowledge Kiosk contained in the database for “broadcast” display to all other authorized users via “The Show” button described with reference to FIG. (4). FIG. (16) lists three Knowledge Elements representing three different pieces of evidence produced in litigation that have been digitized and categorized for inclusion in the database as described above. The first Knowledge Element is a physical exhibit, the second is an article in a newspaper, and the third is a video deposition along with the deposition transcript. By placing these Knowledge Element objects in a user-defined “Presentation Queue” folder located on that user's “Favorites” page, the system can be used to “broadcast” the content represented by the digitized Knowledge Element(s) to multiple users in multiple locations anywhere in the world, simultaneously and in real-time if desired, as long as the recipient has been authenticated to receive the content of that Knowledge Element as described above. The digital nature of the stored Knowledge Element allows its content to be combined with any one or more other Knowledge Elements to create a multimedia presentation displaying the combined content, either audibly, visually, textually, or in any combination thereof. To do this, for example, the “Passport” page of FIG. (3) is used to select the desired Knowledge Kiosk from which the Knowledge Element will be retrieved. For example, the Knowledge Element to be “broadcast” is retrieved by the sender through a search for “trial evidence” conducted from the “Fast Tracks” page for that Knowledge Kiosk as shown in FIG. (8A). The retrieved Knowledge Element is then placed in the sender's “Presentation Queue” folder as shown in FIG. (16) where its multimedia content can be “broadcast” to other authorized users by the sender's selection of “The Show” option from the screen of FIG. (16). Authorized recipients can then access the “broadcast” of that Knowledge Element by input of the sender's name upon selection of “The Show” button from the recipient's “Fast Track” page as shown in FIG. (4).

FIGS. (8A) through (8H) show examples of the various searches that can be conducted for retrieving a Knowledge Element from a particular Knowledge Kiosk. These searches are facilitated by way of GUID reference in the database with respect to the particular Knowledge Element. FIGS. (8A) and (8B) show a search conducted by the category or subcategory under which the Knowledge Element is classified in the Knowledge Kiosk database such as that shown in FIGS. (5) and/or (6). FIGS. (8C) and (8D) show a keyword search conducted by fields in the classification profile created for the Knowledge Element when it is entered into the database. FIG. (8E) shows a search conducted by an exhibit number associated with the Knowledge Element before it is classified and entered into the database, while FIG. (8F) shows a search conducted by the “knowledge element identification number” (“KEID”) which is attached to the Knowledge Element as it is entered into the database. Each KEID is also referenced with a unique GUID reference. The exhibit number for a particular Knowledge Element may be re-used whereas the KEID is never re-used—it is unique to each individual Knowledge Element entered into the database, even if that particular Knowledge Element represents a document with the same exhibit number that has been entered into the database more than once (for a reason such as that described above). Similarly, each Knowledge Element has a unique GUID.

In another example of the invention, information is retrievable by a more structured or organized search by predefined category selected by the user or system manager. In an example specific to the insurance industry, categories include one or more of the following: the office where the account was opened, the insured name, policy number, policy date, and line of coverage, to name a few. They are accessible at a “File Finder” page, an example of which is shown as FIG. 8I. The File Finder provides the user with a quick and efficient method for locating policies and related documents. Users can limit the number of results populated by narrowing their search to specific criteria such as client, line of coverage, document type, or the policy period they are trying to recover. Another way of providing a search access to data is through a “search elements” page. An example of a “search elements” page is shown at FIG. (8J). Again, the system front-end user-interface is designed depending upon the type of data stored in a kiosk and anticipated use of the data. Various designs may be implemented that will facilitate users' access and manipulation of data.

FIG. (9) shows an example of a “Knowledge Element Classification Profile” containing fields providing information describing and classifying the Knowledge Element. This information is entered into the “Knowledge Element Classification Profile” upon placement of the Knowledge Element within its Knowledge Kiosk. This metadata is stored in the database and associated with the GUID of the Knowledge Element. In another related embodiment, the metadata is associated with its own, unique GUID. It allows storage of that Knowledge Element within a database schema such as that shown in FIGS. (5) and/or (6) as well as retrieval of the Knowledge Element using all of the search techniques described herein. This information includes the metadata information as well as user-specific information classifying and describing that particular Knowledge Element. Another example, illustrated at FIG. 9a, shows all of the information gathered at upload that is related to an item of information. This station also allows the users to edit this information.

FIGS. (18A) through (18D) show examples of the results of various searches conducted on different types of information contained within the “knowledge element profile” of FIG. (9), such as document classification and type as shown for example in FIG. (18A), document originator as shown for example in FIG. (18B), document creation date as shown for example in FIG. (18C), and exhibit number as shown for example in FIG. (18D). FIGS. (19A) through (19C) show examples of the information contained in a “Knowledge Kiosk Journal” which provides different ways of tracking all user activity with respect to a given Knowledge Kiosk. Important to note is that the Knowledge Kiosk is being continuously and dynamically updated as new information is being entered, such that the same search conducted on the same criteria will yield the newly entered information as well as the pre-existing information fitting the search criteria, if the search is conducted after the new information has been entered.

FIGS. (8G) and (8H) show an example of a boolean search scheme where various operators (i.e., “AND”, “OR”, “NOT”, “W/5”, “W/25”) are used to define search criteria. FIGS. (11A) through (11D) show the results of an advanced boolean search conducted to locate a particular data string (in this example “Abd%alla”) within any Knowledge Element in the Knowledge Kiosk of interest. As shown in FIG. (11A) the search is conducted in “all kiosk view” which causes a search of all Knowledge Elements within the Knowledge Kiosk of interest. FIG. (11B) lists all Knowledge Elements within the Knowledge Kiosk that contain this searched data string, while FIG. (11C) shows the stored digital image (with the searched string highlighted) of a Knowledge Element that is selected from the list. As shown in FIG. (11A) and explained in FIG. (11D), such a search can be conducted to accommodate “fuzziness” within the digitized version of a given Knowledge Element so that the search will provide a level of forgiveness in retrieving results that do not exactly match the search request, due to potential errors in the request or inaccuracies caused in digitizing the knowledge element (in this case the “%” constitutes an error in the searched string “Abd%alla” that does not impact the retrieval of valid results which disregard the error).

FIGS. (12A) through (12E) show an example of a classification conducted on documents to be produced in litigation that have already been entered as Knowledge Elements (and assigned a KEID) (plus an assigned GUID, not shown) within a Knowledge Kiosk related to the litigation. FIG. (12A) shows the Knowledge Element digital image of a document to be produced in the litigation, while FIG. (12B) shows an example of the options available for classifying portions of the document in order to determine if (and how) it should be produced (i.e., “Privileged”, “To Be Produced”, “Foreign Language”, “Non-Responsive”, etc.). FIGS. (12C) and (12D) show a classification history for the document which enables the tracking of changes made to the classification (and to those specific portions of the document in which the classification has been changed) to allow a historical review of the work done on the document. Finally, FIG. (12E) shows the most current classification information for the document, including the status of its production in the litigation (i.e., “To Be Produced”), the security level under which it is to be treated (i.e., “Confidential”), the pages classified (i.e., “Pages 1-2” and the kiosk user creating the classification (i.e., “W.West”). This information is stored in the Knowledge Element profile for the document in order to enable later searching and retrieval of the document according to classification status using any of the search methods described herein. FIGS. (13A), (13B) and (14) show an example of searches that can be conducted on the classifications created by the user with the options shown for example in FIGS. (12A) through (12E). FIG. (7) shows an example of a submission form completed by the user for storage of an item of information (such as a document to be produced in litigation) within a selected Knowledge Kiosk. FIGS. (24A) through (24C) show an expansion of the document coding concept to allow the metadata information (or “Objective Coding”) described above with reference to the “Knowledge Element Classification Profile” of FIG. (9) to be combined with user-customized personal (or “PIC”) coding as described above with respect to FIGS. (12A) through (12E). As shown in FIG. (24A) this coding information can be combined onto one screen with the coded Knowledge Element, or the coding information and Knowledge Element can be split onto separate screens as shown in FIGS. (24B) and (24C).

FIGS. (17A) through (17C) show a Knowledge Element retrieved using the “Knowledge Element Viewer” which allows a conventional software module (or “plug-in”) for manipulating combined textual/graphical files (such as Adobe Acrobat) to be used to extract relevant data from the Knowledge Element, which is associated with a unique GUID, for use in the multimedia presentations described with reference to FIGS. (10) and (20). FIGS. (10A) through (10D) show an example of an advanced search designed to retrieve a multimedia rendering of a statement of particular interest made in a videotaped deposition. FIG. (10A) shows a search conducted by Knowledge Element category/classification (“trial evidence”/“deposition video” which reveals all Knowledge Elements containing video of the selected deponent (“William Crabbe”) that is to be used as trial evidence. The Knowledge Kiosk associates each of these Knowledge Elements with unique GUIDs. From these results, a further search is conducted in FIG. (10B) to retrieve those portions of the deposition video and associated transcript where the deponent made the specific statement of interest (i.e., “ . . . wait 11 months . . . ”), the results of which are shown in FIG. (10C). Upon “click on” selection of the search results in FIG. (10C), a portion of the deposition transcript text containing the statement of interest is revealed as shown in FIG. (10D), where the viewer is led directly to the page and line number(s) where the statement of interest is highlighted. The textual portion of the deposition transcript containing the highlighted statement of interest shown in FIG. (10D) can be combined with the videotaped presentation of the statement shown in FIG. (20) to form a multimedia Knowledge Element (distinct from both the Knowledge Element containing the textual statement and the separate Knowledge Element containing the videotaped statement). This allows the combination of different Knowledge Elements together to provide a three-dimensional (3-D) multimedia presentation; comprising for example a videotaped deposition, the textual rendering of that deposition, and potentially a physical exhibit (such as a document authored by the deponent) that was introduced in the deposition and was being discussed in the portion of the transcript that is of interest.

The classification searches conducted for example in FIGS. (13A), 13(B) and (14) can be used in combination with a “Bulletin Board” page as shown for example in FIG. (21) to permit real-time multi-user interaction to dynamically select and change the use of different Knowledge Elements for multimedia presentations like those shown in FIG. (20) based on changing circumstances caused by the live testimony presented during trial. The powerful impact of viewing the videotape and text of the deposition statement (in combination with each other and with the piece of physical evidence being discussed) is compounded by the ability to make such a multimedia presentation available on-demand by authorized users anywhere in the world, such as for example in conducting a real-time impeachment of the deponent using the multimedia presentation while the deponent is on the witness stand testifying at trial.

In another example, the system provides a messaging workstation as shown in FIGS. (26) and (26A). The messaging workstation allows both users and the system to exchange priority information. There are system-generated alerts, which escalate messages to users and management, for example, stating policy review standards are in danger of failing to meet required deadlines. The auto notifications are sent to both the Kiosk's internal messaging system and the user's desktop email. Users may create messages allowing other users, such as members of a litigation or insurance policy review team, to share and communicate important information easily within the Kiosk.

In less urgent situations, a “communicate” station can be used to store and exchange topical information, such as may be related to administration, sales, sales and marketing, documentation, etc. A web page for topical information related to documentation is shown in FIG. (26B) for example. This is an especially useful tool for sharing information that changes depending upon outside factors. It can act as a bulletin. Communicate is also an overview access point for storing topical data, such as documents responsive in discovery during litigation.

In another example in the insurance industry, a “quick links” feature, shown in FIG. (27) on a general workstation, contains links to the users “Policies in Review” and easy access to their “Client” files. The Policy Review station displays hyperlinks to all policies that the user currently has under its review. Each policy comprises a Knowledge Element. The Policy Review station itself is linked to other Kiosk stations (that have similarly situated subject matter—e.g., insurance policy review) by way of a stepping stone station. The information which is displayed includes policies that have been forwarded for review by lower level policy checkers, policies retrieved by the individual from the Document Queue, and Policy Review stations that users have created, but have not yet completed. The information retrieved by the Policy Review Station through the stepping stone station is retrieved from at least one repository station. Policies will disappear from this Policy Review station after the user has completed their signoff on the exception report. Currently, professional standards dictate that a policy must be reviewed within 30 days of receipt (policy stamp date) therefore a “Days Old” indicator is present to inform the user how long the review has been outstanding. This can be adjusted as standards adjust. A user's personal filing system in the Kiosk is represented in quick links as “my clients” station. Users may create file folders, search for documents and add documents to a folder, combine Folders or intersect or differentiate folders. Folders, for example, an “interest folder” agent creates a file folder that contains the common documents found when comparing two or more folder a “difference folder” agent creates a folder that contains the uncommon documents found when comparing two or more folders.

This preliminary checklist screen allows users to define the line of coverage checklist that they need to begin their review process. In an example, a “line of coverage checklist” is illustrated as shown in FIG. (28). The users (or the system depending on what documents are in the list) will define whether the policy they are reviewing is a new policy or a renewing policy. The system contains an automated comparison agent that is designed to track changes in policies. The comparison agent tracks the policy and subsequent endorsements or other related data, such as former policies, photos, etc. All data associated therewith is categorized by the system, as described previously, to be “appended” to the original. It is also categorized by its elements or attributes, such as policy holder, policy type (or ISO Form), effective period, policy reviewer, etc. The comparison agent allows users to compare very similar forms that may have a few key differences that could lead to errors and omissions. The comparison agent assists agents or brokers by automating some of the tasks typically undertaken during the policy renewal and review processes, for example. An illustration of an example of a renewal cycle is shown in FIG. 29. Some of the tasks eased by automated features of the system are shown, for example, in FIG. 30.

For instance, if the policy is a renewal and a checklist has been completed for the prior year, all of last year's answers will pre-fill in the checklist for quick comparison. Choosing a type of business will allow the database to create a demographic profile on coverage characteristics that are pertinent to individual types of business. The schedule of forms entry area is an important tool for capturing which forms relate to particular types of coverage. This will allow the checklist pre-fill process to become more robust over time. As an example, a user can choose a form as a primary form, it initiates filling in answers to the checklist questions that relate to its coverage detail. When the user chooses a secondary form, the system will answer the questions related to its coverage detail. If the primary and secondary form provide conflicting answers to a coverage question the secondary coverage forms answer will be used to fill in the checklist. When endorsements are entered at a later time than at initial policy receipt the user should click the maintenance button to continue.

An interactive checklist is also provided. This checklist is an interactive data entry form that, for example, allows users to complete the necessary coverage questions to determine if the policy is correct as shown in FIG. (31). Questions that are pre-filled in are designated in red, or by other varying font, have been filled in by the system and reflect the answers that were provided by entry of the coverage forms on the line of coverage screen. The checklist uses logic to alert users that certain questions are irrelevant based on previously answered questions. It also provides, through question mark icons for example, a clarification of each of the questions asked. The “I” Information Icon provides a brief description of how the primary coverage form deals with the coverage question in the form. Auto-mentoring tools provide users with less specific knowledge of the forms contained in the policy documents with a means of understanding the coverage issues without leaving the system. The system also provides users with quick access to the policy pages that pertain to the individual coverage questions through the context links provided by the language refinery. When clicked, underlined questions highlight specific answers within the policy document view. A document viewing screen provides a full set of Acrobat document manipulation tools as well as a few proprietary tools. A “Context Link” function shows users where answers can be found that relate to their specific coverage questions. Each specific coverage question has a unique, assigned GUID and is related to at least one answer also having a unique, assigned GUID. It allows the user to view two or more documents side-by-side as illustrated in FIG. 32. For example, the user can view two insurance policies issued in the same year to similarly situated insureds, or a current policy and a proposed policy. The comparison agent identifies differences between the two policies using a “compare” function. The differences are displayed in highlighting or other marking to reveal differences in text. Alternatively, the agent could generate a report identifying the differences, or a short cut tool for locating differences that provides a text synopsis of the page numbers on which the distinctions occur. A user can jump to the identified pages without scrolling entire documents. This is especially useful for locating differences in lengthy documents, for example.

As users review insurance policies, a checklist of questions and answers relevant to the internal review process is generated. Some questions, such as account name, address, insurance company, etc., are answerable by the system intelligence using the library and linguistics concepts. Thus as policies and related data are inducted into the system and refined, system tools are utilized to automatically respond to a standard set of questions. This minimizes or eliminates the need for manual review and response for all policies. In an example, the tool assists a reviewer to compare an expiring policy with a renewal policy and create an exception report, as shown for example in FIG. 33. The “exception report” station provides the user with an analysis of the information that was answered in the checklist. Section one titled “system generated answers” shows every place where the system automatically prefilled the checklist, through either information provided by the user during the upload process or through the prefills provided by the system based on the entry of the forms in the line of coverage screen. Section two shows users the specific differences that are present between last year's policy and this year's policy. In year two the last year's policy information will all be red as it will prefill from this year's list. These differences will alert knowledge based users that critical policy issues may not have been addressed correctly in the issued policy. The “discrepancies” section that follows shows where previous users have identified questions or left comments for the higher level reviewer to review and take action on if required.

The “action items” section that follows provides users with a tracking and standardized correspondence mechanism that allows them to communicate policy issues with both clients and carriers in an automated system. The user decides which issues that have been identified and need to be included in the correspondence to either the client or the carrier by checking the boxes under the “Include in Report” subsection. By clicking the “carrier report” button or the “client report” button (shown in the screen shots) users can manipulate the autogenerated letters or reports to reflect the information they wish to send.

The “checklist overview” button contained at the bottom of the station allows users to see a static review of all the client policy information related to the policy. This view is very valuable to the third level reviewer who needs to sign off on the station before it is considered complete. It provides a window into the entire process where they can review all information in one place. The exception report allows users to send the policy review station on to other users for review with all the information contained in the original users station. The link to the station will appear in the next level reviewers kiosk email as well as their desk-top email account. When they click the link the station will be transferred into their policies in review station for tracking. This sign-off procedure also provides a tracking mechanism so that issues defined and executed at one level are tracked to their conclusion, providing alert mechanisms to users and their managers if action items or policy reviews are at risk of being delivered late. For issues left unanswered, a monitoring feature tracks the number of days the issue remains open. A reminder email can be automatically sent to the user after a select amount of time has passed. A standard client report can be generated and associated with policies.

In another embodiment, this system allows users to customize and save their own Kiosk stations by way of configuring one or more stations using templates. The templates include a general workstation template, a stepping stone station template, and a repository station template. The Policy Review station, above, is one example which is an application of the general review station template. With the Policy Review station, the user can search Knowledge Elements relating to insurance policy review, as further described above. In the Policy Review Station, each insurance policy document is a Knowledge Element which is identified by way of a GUID in the database. Further, additional tools can be configured, including, but not limited to, a calendar function (described above), discussions, document and data management, and managing station properties. The system includes suitable programming (i.e., specifically, application wrappers) for operation with user selected tools. In other words, the application wrappers have software layers which act as a two-way interface with respect to the system and the tools themselves, thereby providing intercommunication of data between the two entities. The tools provide functionality to the context review station and enable knowledge manageable and/or context processing. In another example, for a litigation management system, a user can search Knowledge Elements relating to information such, but not limited to, name, date of birth, alleged injuries, attorney of record, employment information, spouse information, nature of the claim, and the like. Examples of typical Knowledge Elements include, but are not limited to, case pleadings, correspondence, party medical records, documents produced pursuant to discovery requests, and the like. In an additional embodiment, the user has an additional tool for making contextual relationships between the Knowledge Elements and retrieving these contextual relationships at a later point in time. Examples of contextual relationships include, but are not limited to, the aggregate amount of all claims against defendants in a certain jurisdiction, causes of action the plaintiffs represented by a certain attorney are bringing, what cases have been pending for the most amount of time, and the like.

With respect to the general workstation template, the workstation can be configured by an administrator. This workstation is defined depending upon the type of data that will be stored in the Kiosk system and, specifically, what type of data the general workstation will access. It is further defined based upon the tools implemented. For example, a Policy Review station is created as a result of an application of the general workstation template.

When the user applies the general workstation template to create a general workstation, the user is able to perform information management and information processing tasks. The general workstation provides the interface for user interaction with the Knowledge Kiosk® system. The user can input, induct, access and/or manipulate one or more Knowledge Elements as needed. Further, a user, with sufficient user privileges, can input or induct Knowledge Elements into the Knowledge Kiosk® system. When at least one or a plurality of Knowledge Elements are input or inducted into the Knowledge Kiosk® system, the repository saves the Knowledge Element information and the database residing thereon creates a separate record for each Knowledge Element, whereby each record has a uniquely assigned GUID. Further, a user, with sufficient user privileges, can create data sets of Knowledge Elements for later retrieval. The sets of data may comprise of a data set of related Knowledge Elements (e.g., a document set) or it may comprise of a data set of unrelated Knowledge Elements (which do not consist of similar subject matter). Likewise, the database keeps track of the GUIDs which correspond to the plurality of Knowledge Elements.

A more specific example of a particular kind of general workstation template is the linguistic analysis station. It allows users to perform the following activities by providing the following tools: 1) station corpus analysis (i.e., linguistic analysis of a body of documents), 2) station concordance analysis (i.e., a statistically significant analysis of most frequent words used as an aid in determining context), 3) building/managing linguistic systems expert profiles (i.e., developing the contextual rules for the linguistic systems expert to process the corpus of documents), and 4) linguistic systems expert execution (i.e., actual linguistic analysis of the corpus of documents).

With regard to the linguistic analysis station, the station corpus analysis allows the user to search through a plurality of documents using the linguistic analysis station. This plurality of documents is termed a “corpus.” In an embodiment, the user may search for at least one or a plurality of Knowledge Elements. One Knowledge Element may comprise of, as an example, a document. Another Knowledge Element may comprise of, as an example, a select portion of a document. The corpus analysis feature enables the user to search through one or a plurality of documents for select information as contained within the Knowledge Elements. In another related embodiment, the user defines the corpus of documents which are to be searched. In still another embodiment, the user may search a portion of or the entire corpus with the aid of classified labels which divide the corpus in at least two or more logical portions.

With respect to the station concordance analysis, the user can conduct a concordance analysis of words which are present within the corpus. After the analysis has been performed on the corpus of documents, the user is presented with a listing of one or a plurality of words that appear in the documents. From there, the user can be aided in his or her determination of the context of these documents by referencing the words which occur in the highest frequency as well as the text segment in which the words are used. In one embodiment, the user can sort the word frequency list. In another embodiment, the user can select one or a plurality of words that are present in the word frequency list and view the text segment in which the word(s) have been used within the document. In this vein, the user can achieve a contextual analysis of the corpus of documents. In still another related embodiment, the user defines the corpus of documents which are to be searched. In yet another embodiment, the user may search a portion of or the entire corpus with the aid of classified labels which divide the corpus in at least two or more logical portions.

For the stepping stone station template, the application of this template yields a stepping stone station which connects this station to a general workstation (discussed above) and a repository station (discussed below). In another embodiment, a plurality of general workstations, stepping stone, and/or repository stations may be connected by way of the stepping stone station. The sole function of the stepping stone station is to organize the Kiosk stations that form the Kiosk system. As an example, one can define a stepping stone station using the template for a Policy Review Kiosk system. In the simplest hierarchical form, the stepping stone station can connect a repository station (discussed below) and a general workstation (discussed above), thereby facilitating the contextual processing. In a more complex hierarchical form, the stepping stone station can connect a plurality of repository, general workstation, or other stepping stone stations to form interlinked Kiosk system networks. In essence, the application of the stepping stone template yields a Knowledge Kiosk® system with a plurality of interconnected Knowledge Kiosk® stations. At minimum, the Knowledge Kiosk® system has at least one general workstation, at least one stepping stone station, and at least one repository station.

For a repository station template, the application of this template yields a repository station with a database which stores a virtual library of Knowledge Elements. The Knowledge Elements may take the form of documents and other items of data, such as, but not limited to multimedia files. When the user applies the repository station template, s/he creates the repository station along with the Knowledge Elements and database structure (i.e., data organization) with respect to the Knowledge Elements.

While the invention has been described in connection with what are presently considered to be the preferred embodiments, it is to be understood the invention is not to be limited to the disclosed embodiments, but on the contrary is intended to cover various modifications and equivalent arrangements included within the spirit and scope of the appended claims.

This invention has been described with reference to the aforementioned embodiments. Obvious modifications and alterations will occur to others upon reading and understanding the preceding detailed description. It is intended that the invention be construed as including all such modifications and alterations.

1. A system for utilizing data to provide knowledge management which comprises the following computer-implemented or enabled steps:
(a) defining information acquisition, exchange, and workflow to help enable categorization of one or a plurality of Knowledge Elements to yield linguistics information,
(b) categorizing said one or said plurality of Knowledge Elements for categorization of said Elements with the aid of said linguistics information by at least one of the following ways: slice, layer, or crumb; and
(c) storing said one or said plurality of Knowledge Elements in a database according to a database schema which implements said categorization, including at least one relationship within said database for identifying at least one Knowledge Element with a globally unique identifier (GUID); and
(d) utilizing, by at least one user, at least one computer-implemented or enabled device, wherein said device is Internet-enabled.

2. The system of claim 1 wherein said Knowledge Element may comprise at least one of the following:
(a) an item of digitized information; and/or
(b) at least one item of metadata.

3. The system of claim 1 wherein a slice is either a particular category or subcate gory of a plurality of Knowledge Elements.

4. The system of claim 3 wherein a layer is either one or a plurality of common characteristics which relate to at least one of said category or at least one of said subcategory.

5. The system of claim 1 wherein a crumb is a Knowledge Element.6. The system of claim 1 wherein two different crumbs do not have a common characteristic which relate to at least one of said category or at least one of said subcategory.

6. The system of claim 1 wherein at least one context relationship type which consists of at least two Knowledge Elements may be user defined by at least one of following ways: by slice, layer, or crumb and wherein each of said context relationship comprises of the following:
(a) a first data set comprising of a plurality of Knowledge Elements which are similarly situated,
(b) a second data set comprising of a plurality of Knowledge Elements which are not similarly situated, and
(c) a third data set comprising of a plurality of Knowledge Elements which may or may not be similarly situated and which span across a plurality of Kiosk Stations,

7. The system of claim 1 further comprising an apparatus of a context management system with the following station types:
(a) at least one general workstation for accessing and/or modifying said Knowledge Elements,
(b) at least one stepping stone station for linking at least one general workstation and at least one repository station, and
(c) at least one repository station for storing at least one Knowledge Element and the GUID in the database.

8. The system of claim 7 further comprising the following station type templates for user created Kiosk stations:
(a) at least one general workstation template which enables the user to create at least one general workstation,
(b) at least one stepping stone station template which enables the user to create at least one stepping stone station, and
(c) at least one repository station template which enables the user to create at least one repository station.

9. The system of claim 8 further comprising station type templates which also comprise the following:
(a) at least one user defined tool for knowledge management and/or context processing of said Knowledge Elements.

10. The system of claim 1 wherein said database is a relational database.

11. The system of claim 8 wherein said general workstation is selected from the group consisting of a policy review station, a litigation management system, and a linguistic analysis station.
